(19) United States
(12) Patent Application Publication
(10) Pub. No.: US 2025/0159696 A1
(43) Pub. Date: May 15, 2025

(54) METHOD AND APPARATUS FOR RECEIVING DOWNLINK CONTROL INFORMATION IN WIRELESS COMMUNICATION SYSTEM

(71) Applicant: SAMSUNG ELECTRONICS CO., LTD., Suwon-si, Gyeonggi-do (KR)

(72) Inventors: Hyemin CHOE, Suwon-si (KR); Kyungjun CHOI, Suwon-si (KR); Seongmok LIM, Suwon-si (KR); Youngrok JANG, Suwon-si (KR); Hyoungju JI, Suwon-si (KR)

(21) Appl. No.: 18/940,595

(22) Filed: Nov. 7, 2024

(30) Foreign Application Priority Data
Nov. 10, 2023 (KR) 10-2023-0155488

(51) Int. Cl. H04W 72/232

(52) U.S. Cl. CPC H04W 72/232

(57) ABSTRACT

The disclosure relates to a 5G or 6G communication system for supporting a higher data transmission rate. The disclosure relates to operations of a UE and a base station in a communication system. More specifically, the disclosure relates to a method and an apparatus for enabling a UE to transmit and receive data through multiple cells by using one piece of downlink control information.

### CROSS-REFERENCE TO RELATED APPLICATION

This application is based on and claims priority under 35 U.S.C. § 119 to Korean Patent Application No. 10-2023-0155488, filed on Nov. 10, 2023, in the Korean Intellectual Property Office, the disclosure of which is herein incorporated by reference in its entirety.

### BACKGROUND

### 1. Field

The disclosure relates to operations of a UE and a base station in a communication system. More specifically, the disclosure relates to a method and an apparatus for enabling a UE to transmit and receive data through multiple cells by using one piece of downlink control information.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to smoothly provide these services.

### SUMMARY

The disclosure may provide an apparatus and a method capable of effectively providing a service in a mobile communication (or wireless communication) system.

A mobile communication (or wireless communication) system according to an embodiment of the disclosure may propose a method for determining whether two or more transport blocks are transmitted, and a method and an apparatus for determining a scheduled cell. A mobile communication (or wireless communication) system according to an embodiment of the disclosure may propose a method for indicating, through DCI, whether multiple transport blocks are transmitted or received, and a method for indicating a cell scheduled by DCI which schedules multiple cells.

A disclosed embodiment may provide an apparatus and a method capable of effectively providing a service in a mobile communication system.

Advantageous effects obtainable from the disclosure may not be limited to the above-mentioned effects, and other effects which are not mentioned may be clearly understood from the following descriptions by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of a bandwidth part configuration in a wireless communication system according to an embodiment of the disclosure;

FIG. 4 illustrates an example of control resource set configuration of a downlink control channel in a wireless communication system;

FIG. 5 illustrates a structure of a downlink control channel in a wireless communication system according to an embodiment of the disclosure;

FIG. 6 illustrates a method in which a base station and a UE transmit/receive data in consideration of a downlink data channel and a rate matching resource in a wireless communication system according to an embodiment of the disclosure;

FIG. 7 illustrates an example of frequency domain resource allocation with regard to a PDSCH or PUSCH in a wireless communication system according to an embodiment of the disclosure;

FIG. 8 illustrates an example of time domain resource allocation with regard to a PDSCH in a wireless communication system according to an embodiment of the disclosure;

FIG. 9 illustrates an example of time domain resource allocation according to a subcarrier spacing with regard to a data channel and a control channel in a wireless communication system according to an embodiment of the disclosure;

FIG. 10 illustrates radio protocol structures of a base station and a UE in single cell, carrier aggregation, and dual connectivity situations according to an embodiment of the disclosure;

FIG. 11 illustrates an example in which MC-DCI according to an embodiment of the disclosure includes multiple FDRA fields;

FIG. 12 illustrates an example in which actually co-scheduled cells are determined based on multiple FDRA fields included in MC-DCI according to an embodiment of the disclosure;

FIG. 13A and FIG. 13B illustrate an example in which a UE according to an embodiment of the disclosure performs DCI field length adjustment according to an indicated bandwidth in case that bandwidth switching is indicated thereto;

FIG. 14A and FIG. 14B illustrate an example in which a UE according to an embodiment of the disclosure performs DCI field length adjustment according to an indicated bandwidth in case that bandwidth switching is indicated thereto;

FIG. 15 illustrates a flow of operations in which a UE according to an embodiment of the disclosure determines an enabled transport block according to the number of bits of an RV block configured therefor;

FIG. 16 illustrates a flow of operations in which a UE according to an embodiment of the disclosure determines an enabled transport block according to the number of bits of an RV block configured therefor;

FIG. 17A and FIG. 17B illustrate an example in which, in case that BWP switching is indicated, DCI field length adjustment is performed according to the indicated BWP, according to an embodiment of the disclosure;

FIG. 18 illustrates a flow of operations for determining actually co-scheduled cells, based on multiple FDRA fields included in MC-DCI according to an embodiment of the disclosure;

FIG. 19 illustrates a structure of a UE in a wireless communication system according to an embodiment of the disclosure; and

FIG. 20 illustrates a structure of a base station in a wireless communication system according to an embodiment of the disclosure.

### DETAILED DESCRIPTION

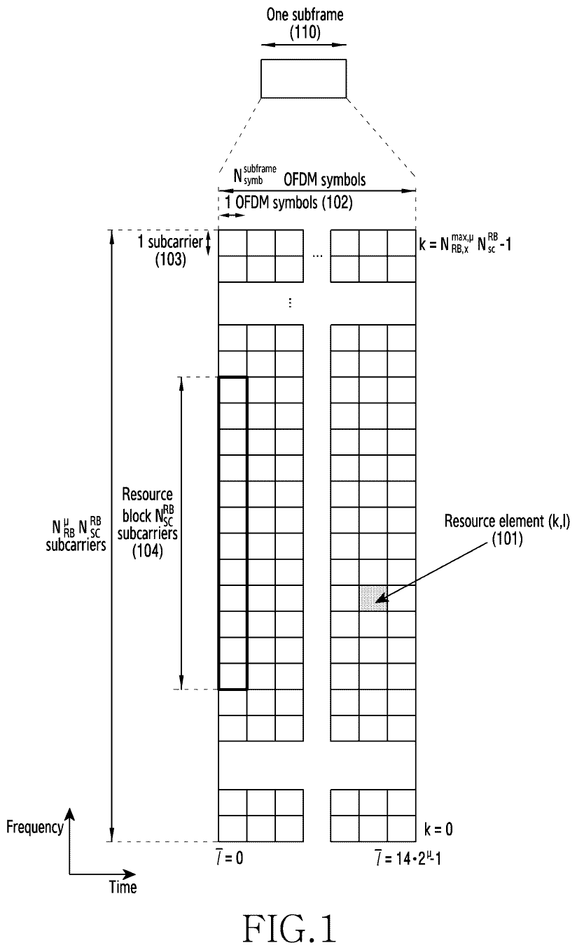

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operation principle of the disclosure will be described in detail in conjunction with the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” may refer to a radio link via which a base station transmits a signal to a terminal, and an “uplink (UL)” may refer to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink may refer to a radio link via which a user equipment (UE) or a mobile station (MS) transmits data or control signals to a base station (BS) or eNode B, and the downlink may refer to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a higher data rate than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, various transmission/reception technologies including a further enhanced multi-input multi-output (MIMO) transmission technique may be required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

### [NR Time-Frequency Resources]

Hereinafter, a frame structure of a 5G system will be described in more detail with reference to the accompanying drawings.

FIG. 1 illustrates a basic structure of a time-frequency domain in a wireless communication system according to an embodiment of the disclosure.

Referring to FIG. 1, a basic structure of a time-frequency domain, which is a radio resource domain used to transmit data or control channels in a 5G system is illustrated.

In FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104.

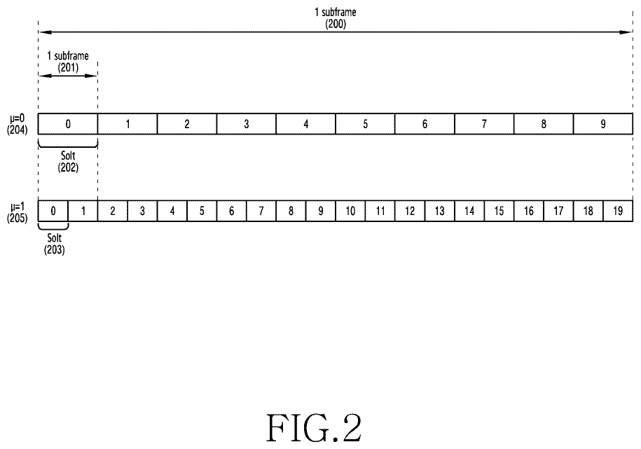

FIG. 2 illustrates a structure of a frame, a subframe, and a slot in a wireless communication system according to an embodiment of the disclosure.

Referring to FIG. 2, an example of a structure of a frame 200, a subframe 201, and a slot 202 is illustrated. One frame 200 may be defined as 10 ms. One subframe 201 may be defined as 1 ms, and thus one frame 200 may include a total of ten subframes 201. One slot 202 or 203 may be defined as 14 OFDM symbols (i.e., the number N_{symb}^{slot} of symbols for one slot=14). One subframe 201 may include one or multiple slots 202 and 203, and the number of slots 202 and 203 per one subframe 201 may vary depending on configuration values p for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number Nₛₗₒₜ^{sunframe,μ} of slots per one subframe may change according to a configuration value μ for a subcarrier spacing, and the number Nₛₗₒₜ^{frame,μ} of slots per one frame may change accordingly. Nₛₗₒₜ^{frame,μ} and Nₛₗₒₜ^{frame,μ} may be defined according to each subcarrier spacing configuration μ as in Table 1 below.

TABLE 1

| μ | N_{symb}^{slot} | Nₛₗₒₜ^{frame, μ} | Nₛₗₒₜ^{sunframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, a bandwidth part (BWP) configuration in a 5G communication system will be described in detail with reference to the accompanying drawings.

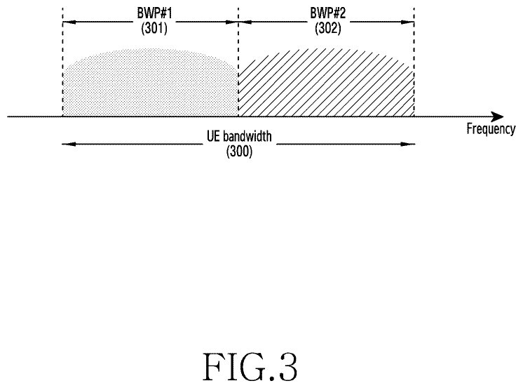

FIG. 3 illustrates an example of a bandwidth part configuration in a wireless communication system according to an embodiment of the disclosure.

More particularly, FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given in Table 2 below. Obviously, the examples given below are not limiting.

TABLE 2
BWP ::= SEQUENCE {

| | |
|---|---|
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

Of course, the bandwidth part configuration is not limited to the above example, and in addition to the configuration information in Table 2, various parameters related to the bandwidth part may be configured for the UE. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control resource region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

According to various embodiments of the disclosure, the bandwidth part-related configuration supported by 5G may be used for various purposes.

According to an embodiment, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

According to an embodiment, in connection with the bandwidth part configuring method, UEs, before RRC-connected, may receive configuration information regarding the initial bandwidth part (initial BWP) through an MIB in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined given in Table 3 below, for example. Obviously, the example given below is not limiting.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}Depends on UE capability.
Note 2: If the BWP switch involves changing of SCS, the BWP switch delay is determined by the larger one between the SCS before BWP switch and the SCS after BWP switch.

The requirements for the bandwidth part change delay time may support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit and/or receive a data channel scheduled by the corresponding DCI in the newly changed bandwidth part. If the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K-1).

### [SS/PBCH Block]

Next, synchronization signal (SS)/PBCH blocks in 5G will be described.

An SS/PBCH block may refer to a physical layer channel block including a primary synchronization signal (PSS), a secondary synchronization signal (SSS), and a PBCH. Details thereof may be as follows.
PSS: A signal which becomes a reference signal for downlink time/frequency synchronization, and may provide partial information of a cell ID.
SSS: A reference for downlink time/frequency synchronization, and may provide the remaining cell ID information not provided by the PSS. Additionally, the SSS may serve as a reference signal for PBCH demodulation of a PBCH.
PBCH: may provide an MIB which is mandatory system information necessary for the UE to transmit/receive data channels and control channels. The mandatory system information may include search space-related control information indicating a control channel's radio resource mapping information, scheduling control information regarding a separate data channel for transmitting system information, and the like.
SS/PBCH block: may include a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (which may correspond to a control resource set having a control resource set index of 0). The UE may monitor control resource set #0 by assuming that the demodulation reference signal (DMRS) transmitted in the selected SS/PBCH block and control resource set #0 are quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) may be transferred from a base station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through or on a physical downlink control channel (PDCCH). A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example. Obviously, the example given below is not limiting.

TABLE 4

| | |
|---|---|
| - | Identifier for DCI formats - [1] bit |
| - | Frequency domain resource assignment -[┌log₂( |
| | N_{RB}^{UL,BWP}(N_{RB}^{UL,BWP} + 1)/2)┐] bits |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | Transmit power control (TPC) command for scheduled PUSCH- [2] bits |
| - | Uplink/supplementary uplink indicator (UL/SUL indicator) - 0 or 1 bit |

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example. Obviously, the example given below is not limiting.

```
TABLE 5
  - Carrier indicator - 0 or 3 bits
  - UL/SUL indicator - 0 or 1 bit
  - Identifier for DCI formats - [1] bits
  - Bandwidth part indicator - 0, 1 or 2 bits
  - Frequency domain resource assignment
      • For resource allocation type 0, ┌N_{RB}^{UL,BWP}/P┐ bits
      • For resource allocation type 1, ┌log₂( N_{RB}^{UL,BWP}(N_{RB}^{UL,BWP} + 1)/2)┐ bits
  - Time domain resource assignment - 1, 2, 3, or 4 bits
  - Virtual resource block-to-physical resource block (VRB-to-PRB) mapping - 0 or 1
bit, only for resource allocation type 1.
      • 0 bit if only resource allocation type 0 is configured;
      • 1 bit otherwise.
  - Frequency hopping flag - 0 or 1 bit, only for resource allocation type 1.
      • 0 bit if only resource allocation type 0 is configured;
      • 1 bit otherwise.
  - Modulation and coding scheme - 5 bits
  - New data indicator - 1 bit
  - Redundancy version - 2 bits
  - HARQ process number - 4 bits
  - 1st downlink assignment index- 1 or 2 bits
      • 1 bit for semi-static HARQ-ACK codebook;
      • 2 bits for dynamic HARQ-ACK codebook with single HARQ-ACK
        codebook.
  - 2nd downlink assignment index - 0 or 2 bits
      • 2 bits for dynamic HARQ-ACK codebook with two HARQ-ACK sub-
        codebooks;
      • 0 bit otherwise.
  - TPC command for scheduled PUSCH - 2 bits
    $‐ SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
      $\cdot ⌈ {log}_{2} ( {\sum }_{k = 1}^{{L}_{max}} ( \begin{matrix}{N}_{SRS} \\ k\end{matrix} ) ) ⌉ bits for non - codebook based PUSCH transmission ;$
      • ┌log₂(N_{SRS})┐ bits for codebook based PUSCH transmission.
  - Precoding information and number of layers-up to 6 bits
  - Antenna ports - up to 5 bits
  - SRS request - 2 bits
  - CSI request - 0, 1, 2, 3, 4, 5, or 6 bits
  - Code block group (CBG) transmission information - 0, 2, 4, 6, or 8 bits
  - Phase tracking reference signal (PTRS)-demodulation reference signal (DMRS)
association - 0 or 2 bits.
  - beta_offset indicator - 0 or 2 bits
  - DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example. Obviously, the example given below is not limiting.

TABLE 6

| | |
|---|---|
| - | Identifier for DCI formats - [1] bit |
| - | Frequency domain resource assignment |
| | -[┌log₂(N_{RB}^{DL,BWP}(N_{RB}^{DL,BWP} + 1)/2)┐] bits |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | Physical uplink control channel (PUCCH) resource indicator- 3 bits |
| - | PDSCH-to-HARQ feedback timing indicator- [3] bits |

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example.

TABLE 7

| - | Carrier indicator - 0 or 3 bits | |
|---|---|---|
| - | Identifier for DCI formats - [1] bits | |
| - | Bandwidth part indicator - 0, 1 or 2 bits | |
| - | Frequency domain resource assignment | |
| | For resource allocation type 0, N, DL,BWP | |
| | • | For resource allocation type 0, ┌N_{RB}^{DL,BWP} /P┐ bits |
| | • | For resource allocation type 1, ┌log₂(N_{RB}^{DL,BWP}(N_{RB}^{DL,BWP} + |
| | | 1)/2)┐ bits |
| - | Time domain resource assignment -1, 2, 3, or 4 bits | |
| - | VRB-to-PRB mapping - 0 or 1 bit, only for resource allocation type 1. | |
| | • | 0 bit if only resource allocation type 0 is configured; |
| | • | 1 bit otherwise. |

| | |
|---|---|
| - | PRB bundling size indicator - 0 or 1 bit |
| - | Rate matching indicator - 0, 1, or 2 bits |
| - | ZP CSI-RS trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication- 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### [PDCCH: CORESET, REG, CCE, and Search Space]

Hereinafter, a downlink control channel in a 5G communication system will be described in more detail with reference to the accompanying drawings.

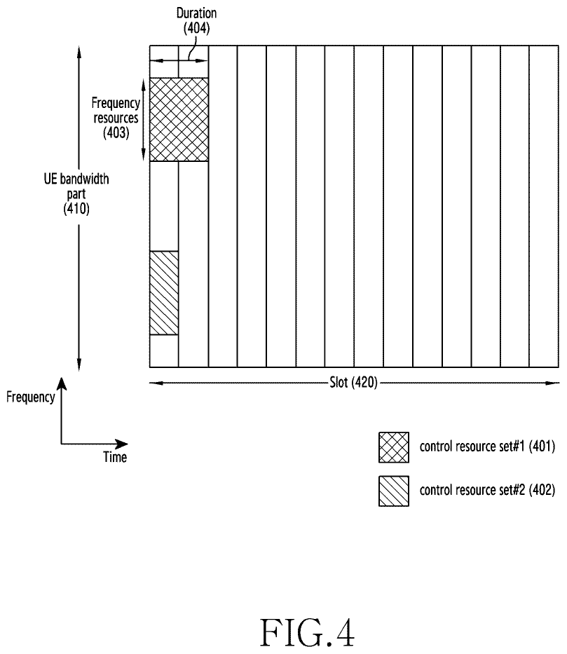

FIG. 4 illustrates an example of a control resource set (CORESET) used to transmit a downlink control channel in a 5G wireless communication system. More particularly, FIG. 4 illustrates an example in which a UE bandwidth part 410 is configured along the frequency axis, and two control resource sets (control resource set #1 420 and control resource set #2 401) are configured within one slot 402 along the time axis. The control resource sets 401 and 402 may be configured in a specific frequency resource 410 within the entire UE bandwidth part 403 along the frequency axis. The control resource sets 401 and 402 may be each configured as one or multiple OFDM symbols along the time domain, and the number of the OFDM symbols may be defined as a control resource set duration 404. Referring to the example illustrated in FIG. 4, control resource set #1 401 is configured to have a control resource set duration corresponding to two symbols, and control resource set #2 402 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE may mean that information such as a control resource set identity, the control resource set's frequency location, and the control resource set's symbol duration is provided. For example, the control resource set may include the following pieces of information: given in Table 8 below. Obviously, the example given below is not limiting.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(control resource set identity))

| | |
|---|---|
| frequencyDomainResources | BIT STRING (SIZE (45)), |

(frequency domain resource assignment information)

| | |
|---|---|
| duration | INTEGER (1..maxCoReSetDuration), |

(time domain resource assignment information)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG- |

bundle, allContiguousRBs},

| | |
|---|---|
| interleaverSize | ENUMERATED {n2, n3, n6} |

```
      (interleaver size)
      shiftIndex
      INTEGER(0..maxNrofPhysicalResourceBlocks-1)
      OPTIONAL
      (interleaver shift)
    },
```

| | |
|---|---|
| nonInterleaved | NULL |

},

| | |
|---|---|
| tci-StatesPDCCH | SEQUENCE(SIZE (1..maxNrofTCI- |
| StatesPDCCH)) OF TCI-StateId | OPTIONAL, |

(QCL configuration information)

| | |
|---|---|
| tci-PresentInDCI | ENUMERATED {enabled} |
| OPTIONAL, | -- Need S |

}

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding control resource set. Obviously, the example given above is not limiting.

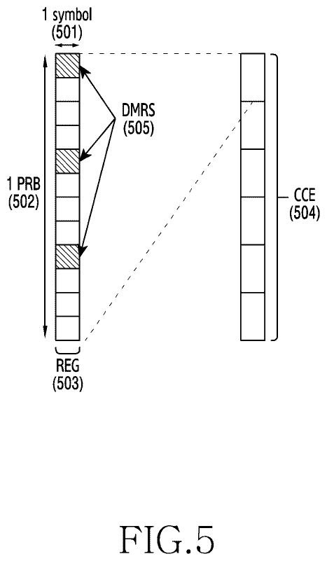

FIG. 5 illustrates a structure of a downlink control channel in a wireless communication system according to an embodiment of the disclosure.

Referring to FIG. 5, an example of abasic unit of time and frequency resources constituting a downlink control channel available in 5G is illustrated. According to FIG. 5, the basic unit of time and frequency resources constituting a control channel may be referred to as a resource element group (REG) 503, and the REG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation in 5G is a control channel element 504 as illustrated in FIG. 5, one CCE 504 may include multiple REGs 503. To describe the REG % n illustrated in FIG. 5, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5, that is, the REG 503, may include both REs to which DCI is mapped, and an area to which a reference signal (DMRS 505) for decoding the same is mapped. Referring to FIG. 5, three DRMSs 503 may be transmitted inside one REG 505. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the control resource set may include the following pieces of information: given in Table 9 below. Obviously, the example given below is not limiting.

TABLE 9

| | |
|---|---|
| SearchSpace ::= | SEQUENCE { |

```
  -- Identity of the search space. SearchSpaceId = 0 identifies the SearchSpace configured
    via PBCH (MIB) or ServingCellConfigCommon.
```

| | |
|---|---|
| search SpaceId | SearchSpaceId, |

(search space identity)

| | |
|---|---|
| controlResourceSetId | ControlResourceSetId, |

(control resource set identity)

| | |
|---|---|
| monitoringSlotPeriodicity AndOffset | CHOICE { |

(monitoring slot level periodicity)

| | |
|---|---|
| sl1 | NULL, |
| sl2 | INTEGER (0..1), |
| sl4 | INTEGER (0..3), |

| | |
|---|---|
| sl5 | INTEGER (0..4), |

| | |
|---|---|
| sl8 | INTEGER (0..7), |

| | |
|---|---|
| sl10 | INTEGER (0..9), |
| sl16 | INTEGER (0..15), |
| sl20 | INTEGER (0..19) |

}

OPTIONAL,

| | |
|---|---|
| duration(monitoring duration) | INTEGER (2..2559) |

| | |
|---|---|
| monitoringSymbolsWithinSlot | BIT STRING (SIZE (14)) |

OPTIONAL,

(monitoirng symbols within slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, |

n6, n8},

| | |
|---|---|
| aggregationLevel2 | ENUMERATED {n0, n1, n2, n3, n4, n5, |

n6, n8},

| | |
|---|---|
| aggregationLevel4 | ENUMERATED {n0, n1, n2, n3, n4, n5, |

n6, n8},

| | |
|---|---|
| aggregationLevel8 | ENUMERATED {n0, n1, n2, n3, n4, n5, |

n6, n8},

| | |
|---|---|
| aggregationLevel16 | ENUMERATED {n0, n1, n2, n3, n4, n5, |

```
    n6, n8}
  },
```

| | |
|---|---|
| searchSpaceType | CHOICE { |

```
  (search space type)
    -- Configures this search space as common search space (CSS) and DCI formats to
    monitor.
```

| | |
|---|---|
| common | SEQUENCE { |

```
    (common search space)
    }
```

| | |
|---|---|
| ue-Specific | SEQUENCE { |

```
    (UE-specific search space)
      -- Indicates whether the UE monitors in this USS for DCI formats 0-0 and 1-0 or
    for formats 0-1 and 1-1.
```

| | |
|---|---|
| formats | ENUMERATED {formats0-0-And-1-0, |

```
    formats0-1-And-1-1},
      ...
}
```

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the example given below is not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Obviously, the example given below is not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below.

Cell RNTI (C-RNTI): used to schedule a UE-specific PDSCH

Temporary cell RNTI (TC-RNTI): used to schedule a UE-specific PDSCH

Configured scheduling RNTI (CS-RNTI): used to schedule a semi-statically configured UE-specific PDSCH

Random access RNTI (RA-RNTI): used to schedule a PDSCH in a random access step

Paging RNTI (P-RNTI): used to schedule a PDSCH in which paging is transmitted

System information RNTI (SI-RNTI): used to schedule a PDSCH in which system information is transmitted

Interruption RNTI(INT-RNTI): used to indicate whether a PDSCH is punctured

Transmit power control for PUSCH RNTI (TPC-PUSCH-RNTI): used to indicate a power control command regarding a PUSCH

Transmit power control for PUCCH RNTI (TPC-PUCCH-RNTI) for indicating power control command for PUCCH

Transmit power control for SRS RNTI (TPC-SRS-RNTI): used to indicate a power control command regarding an SRS

The DCI formats enumerated above may follow the definitions given in Table 10 below, for example.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In 5G, the search space at aggregation level L in connection with CORESET p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{C C E , p}}{L \cdot {M}_{s , max}^{( L )}} ⌋ + {n}_{CI} ) mod ⌊ \frac{{N}_{C C E , p}}{L} ⌋ + i \qquad [ Equation l ]$$

L: aggregation level
n_{cI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{cI}}=0, . . . , M_{s,max}^{(L)}−1: PDCCH candidate index at aggregation level L
i=0, . . . , L−1
Y_{p,n}_{_{s,f}}^{μ}=(Aₚ·Y_{p,n}_{_{s,f}}^{μ}−1) mod D, Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

The Y value may correspond to 0 in the case of a common search space. The Y_{p,n}_{_{s,f}}^{μ} value may correspond to a value changed by the UE's identity (C-RNTI or ID configured for the UE by the base station) and the time index in the case of a UE-specific search space.

In 5G, multiple search space sets may be configured by different parameters (for example, parameters in Table 9), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

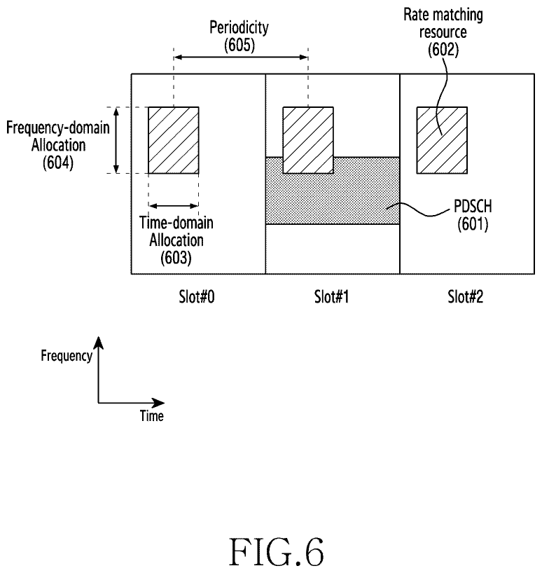

FIG. 6 illustrates a method in which a base station and a UE transmit/receive data in consideration of a downlink data channel and a rate matching resource in a wireless communication system according to an embodiment of the disclosure.

Referring to FIG. 6, FIG. 6 illustrates a downlink data channel (PDSCH) 601 and a rate matching resource 602. The base station may configure one or multiple rate matching resources 602 for the UE through upper layer signaling (for example, RRC signaling). Rate matching resource 602 configuration information may include time-domain resource allocation information 603, frequency-domain resource allocation information 604, and periodicity information 605. A bitmap corresponding to the frequency-domain resource allocation information 604 will hereinafter be referred to as “first bitmap”, a bitmap corresponding to the time-domain resource allocation information 603 will be referred to as “second bitmap”, and a bitmap corresponding to the periodicity information 605 will be referred to as “third bitmap”. If all or some of time and frequency resources of the scheduled PDSCH 601 overlap a configured rate matching resource 602, the base station may rate-match and transmit the PDSCH 602 in a rate matching resource 601 part, and the UE may perform reception and decoding after assuming that the PDSCH 602 has been rate-matched in a rate matching resource 601 part.

The base station may dynamically notify the UE, through DCI, of whether the PDSCH will be rate-matched in the configured rate matching resource part through an additional configuration (for example, corresponding to “rate matching indicator” inside DCI format described above). Specifically, the base station may select some from the configured rate matching resources and group them into a rate matching resource group, and may indicate, to the UE, whether the PDSCH is rate-matched with regard to each rate matching resource group through DCI by using a bitmap type. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, in a case where rate matching is to be conducted, the base station may indicate this case by “1”, and in a case where rate matching is not to be conducted, the base station may indicate this case by “0”.

5G supports granularity of “RB symbol level” and “RE level” as a method for configuring the above-described rate matching resources for a UE. More specifically, the following configuration method may be followed.

### RB Symbol Level

The UE may have a maximum of four RateMatchPatterns configured per each bandwidth part through upper layer signaling, and one RateMatchPattern may include the following contents. Obviously, the example given below is not limiting.
may include, in connection with a reserved resource inside a bandwidth part, a resource having time and frequency resource domains of the corresponding reserved resource configured as a combination of an RB-level bitmap and a symbol-level bitmap in the frequency domain. The reserved resource may span one or two slots. A time domain pattern (periodicityAndPattern) may be additionally configured wherein time and frequency domains including respective RB-level and symbol-level bitmap pairs are repeated.
may include a resource area corresponding to a time domain pattern configured by time and frequency domain resource areas configured by a CORESET inside a bandwidth part and a search space configuration in which corresponding resource areas are repeated.

### RE Level

The UE may have the following contents configured through upper layer signaling. Obviously, the example given below is not limiting.
configuration information (lte-CRS-ToMatchAround) regarding a RE corresponding to a LTE CRS (Cell-specific Reference Signal or common reference signal) pattern, which may include LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, subframe configuration information (mbsfn-SubframConfigList) corresponding to a multicast-broadcast single-frequency network (MBSFN), and the like. The UE may determine the position of the CRS inside the NR slot corresponding to the LTE subframe, based on the above-mentioned pieces of information.
may include configuration information regarding a resource set corresponding to one or multiple zero power (ZP) CSI-RSs inside a bandwidth part.

### [PDSCH/PUSCH: Regarding Frequency Resource Assignment]

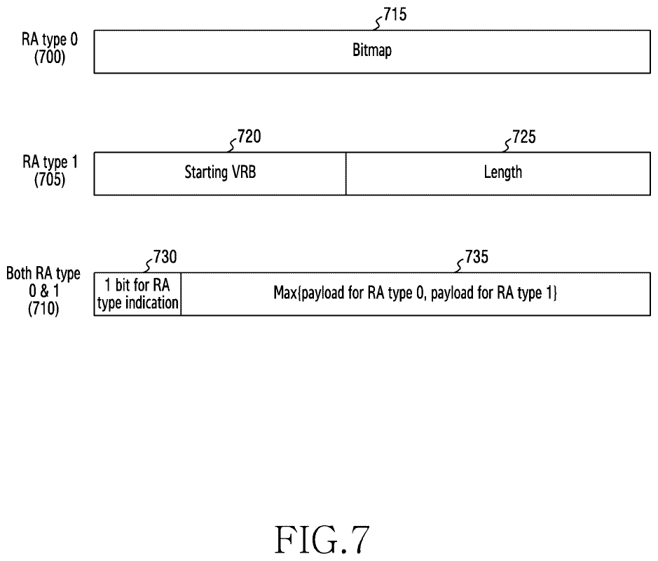

FIG. 7 illustrates an example of frequency-axis resource assignment of a physical downlink shared channel (PDSCH) or physical uplink shared channel (PUSCH) in a wireless communication system according to an embodiment of the disclosure.

More particularly, FIG. 7 illustrates three types of frequency-axis resource assignment methods, including type-0 700, type-1 705, and dynamic switch 710, which can be configured through an upper layer in an NR wireless communication system.

Referring to FIG. 7, in case that a UE is configured to use only type-0 resource assignment through upper layer signaling (700), partial downlink control information (DCI) which assigns a PDSCH/PUSCH to the UE may include a bitmap including N_{RBG} bits. N_{RBG} refers to the number of resource block groups (RGBs) determined by upper layer parameter rbg-Size and a BWP size assigned by a BWP indicator, as in [Table 11] below, and data may be transmitted in an RGB labeled as 1 by the bitmap

TABLE 11

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

The BWP size may refer to the number of RBs included in a BWP. More specifically, in case that type-0 resource assignment is indicated, the length of a frequency domain resource assignment (FDRA) field of DCI received by the UE may be equal to the number of RGBs (N_{RBG}), and N_{RBG}=[(N_{BWP}^{size}+(N_{BWp}^{start} mod P))/P]. The first RGB may include as many RBs as RBG₀^{size}=P−N_{BWP}^{size}, mod P. In addition, if (N_{BWP}^{start}+N_{BWP}^{size})mod P>0, the last RGB may include as many RBs as RBGₗₐₛₜ^{size}=(N_{BWP}^{start}+N_{BWP}^{size})mod P. Otherwise, the last RGB may include as many RBs as RBGₗₐₛₜ^{size}=P. The remaining RGBs may include as many RBs as P. P is the number of nominal RGBs determined according to Table 11.

### Resource Assignment Type 2

RB assignment information may be provided from the base station to the UE as M interlace index sets.
Interlace index m∈{0,1, . . . , M−1} may be configured by common RBs {m, M+m, 2 M+m, 3 M+m, . . . ), and M may be defined as in Table 12:

TABLE 12

| μ | M |
|---|---|
| 0 | 10 |
| 1 | 5 |

The relationship between interlace m and RB n_{IRB,m}^{μ}∈{0,1, . . . } which is in BWP i and common RB nc_{CRB}^{μ} may be defined as follows:

$${n}_{C R B}^{μ} = M {n}_{IRB , m}^{μ} + {N}_{B WP , i}^{start , μ} + ( ( m - {N}_{B WP , i}^{start , μ} ) mod M )$$

where N_{BWP,i}^{start,μ} is the common resource block where bandwidth part starts relative to common resource block 0. u is subcarrier spacing index
assuming that the subcarrier spacing is 15 kHz(u=0), RG assignment information regarding an interlace set including m₀+l indices may be provided from the base station to the UE. In addition, the resource assignment field may be configured by a resource indication value (RIV). If the RIV is 0≤RIV<M(M+1)/2,l=0,1, . . . L−1, the same may be configured by the number L (L≥1) of interlaces continuous with starting interlace m₀, and the value thereof may be as follows:

```
  if (L − 1) ≤ └M/2┘ then
RIV = M(L − 1) + m₀
  else
RIV = M(M − L + 1) + (M − 1 −m₀)
```

Assuming that the RIV is RIV≥M(M+1)/2, the RIV may be configured by starting interlace index m0 and 1 values as in Table 13. Obviously, the following example is not limitative.

TABLE 13

| RIV − M(M + 1)/2 | m₀ | l |
|---|---|---|
| 0 | 0 | {0, 5} |
| 1 | 0 | {0, 1, 5, 6} |
| 2 | 1 | {0, 5} |
| 3 | 1 | {0, 1, 2, 3, 5, 6, 7, 8} |
| 4 | 2 | {0, 5} |
| 5 | 2 | {0, 1, 2, 5, 6, 7} |
| 6 | 3 | {0, 5} |
| 7 | 4 | {0, 5} |

Assuming that the subcarrier spacing is 30 kHz (u=1), RG assignment information may be provided from the base station to the UE as a bitmap indicating interlaces assigned to the UE. The bitmap size is M, and one bit of the bitmap may correspond to each interlace. The order of the interlace bitmap may be mapped from interlace index 0 to M−1 (from MSB to LSB).

In addition, with regard to 15 kHz and 30 kHz, the LSB of the FDRA field

$$Y = ⌈ log 2 \frac{{N}_{R B - s e t}^{B W P} ( {N}_{R B - s e t}^{B W P} + 1 )}{2} ⌉$$

may refer to a continuous RB set scheduled by DCI format 0_1. The Y bit may be configured by a resource indication value (RIV_{RBset}). With regard to 0≤RIV_{RBset}<N_{RB-set}^{BWP}(N_{RB-set}^{BWP}+1)/2, l=0,1, . . . L_{RBset}−1, the RIV_{RBset} value may be determined by the number (L_{RBset}(L_{RBset}≥1)) of RB sets continuous with the starting RB set (RBset_{START}). The RIV_{RBset} value may be defined as follows:

```
if (L_{RBset} − 1) ≤ └N_{RB-set}^{BWP}/2┘ then
  RIV_{RBset} = N_{RB-set}^{BWP}(L_{RBset} − 1) + RBset_{START}
else
    RIV_{RBset} = N_{RB-set}^{BWP}(N_{RB-set}^{BWP} − L_{RBset} + 1) +
    N_{RB-set}^{BWP} − 1 − RBset_{START})
```

N_{RB-set}^{BWP} may refer to the number of RB sets included in the BWP, and may be determined by the number of guard gaps (or bands) in the carrier configured by upper layer signaling (or preconfigured).

In case that a UE is configured to use only type-1 resource assignment through upper layer signaling (705), DCI which assigns a PDSCH/PUSCH to the UE may include FDRA information including as many bits as [log₂(N_{RB}^{BWP}*(N_{RB}^{BWP}+1)/2]. N_{RB}^{BWP} refers to the number of RBs included in the BWP The base station may use the same to configure a starting VRB 720 and the length 725 of the frequency-axis resource assigned continuously therefrom.

In case that a UE is configured to use both type-0 resource assignment and type-1 resource assignment through upper layer signaling (710), partial DCI which assigns a PDSCH/PUSCH to the UE may include frequency-axis resource assignment information configured by bits of the largest value 735 among the payload 715 for configuring type-0 resource assignment and the payload 720 and 725 for configuring type-1 resource assignment. Conditions for this may be described again later. One bit may be added to the foremost portion (MSB) of the frequency-axis resource assignment information in the DCI, and the bit, if the value of which is “0”, may indicate that type-0 resource assignment is to be used and, if the value of which is “1”, may indicate that type-1 resource assignment is to be used.

### [PDSCH/PUSCH: Regarding Time Resource Allocation]

Hereinafter, a time domain resource allocation method regarding a data channel in a next-generation mobile communication system (5G or NR system) will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL−Allocations=16 entries may be configured for the PDSCH, and a table including a maximum of maxNrofUL−Allocations=16 entries may be configured for the PUSCH. In an embodiment, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 14 or Table 15 below may be transmitted from the base station to the UE. Obviously, the example given above is not limiting.

TABLE 14
PDSCH-TimeDomainResourceAllocationList information element

| | |
|---|---|
| PDSCH-TimeDomainResourceAllocationList := | SEQUENCE (SIZE(1..maxNrofDL- |

Allocations)) OF
PDSCH-TimeDomainResourceAllocation

| | |
|---|---|
| PDSCH-TimeDomainResourceAllocation ::= | SEQUENCE { |

| | |
|---|---|
| k0 | INTEGER(0..32) |

```
  OPTIONAL, -- Need S
      (PDCCH-to-PDSCH timing, slot unit)
```

| | |
|---|---|
| mappingType | ENUMERATED {typeA, typeB}, |

(PDSCH mapping type)

| | |
|---|---|
| startSymbolAndLength | INTEGER (0..127) |

```
    (start symbol and length of PDSCH)
  }
```

TABLE 15
PUSCH-TimeDomainResourceAllocationList information element

| | |
|---|---|
| PUSCH-TimeDomainResourceAllocationList ::= | SEQUENCE (SIZE(1..maxNrofDL- |

Allocations)) OF
PUSCH-TimeDomainResourceAllocation

| | |
|---|---|
| PUSCH-TimeDomainResourceAllocation ::= | SEQUENCE { |

| | |
|---|---|
| k2 | INTEGER(0..32) OPTIONAL, -- Need |

S
(PDCCH-to-PUSCH timing, slot unit)

| | |
|---|---|
| mappingType | ENUMERATED {typeA, typeB}, |

(PUSCH mapping type)

| | |
|---|---|
| startSymbolAndLength | INTEGER (0..127) |

(start symbol and length of PUSCH)
}

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

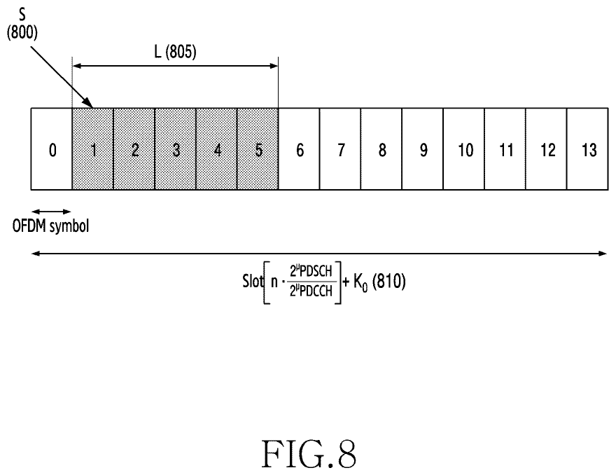

FIG. 8 illustrates an example of time domain resource allocation with regard to a PDSCH in a wireless communication system according to an embodiment of the disclosure.

Referring to FIG. 8, the UE may indicate the time domain location of a PDSCH resource according to the subcarrier spacing (SCS) (μ_{PDSCH}, μ_{PDCCH}) of a data channel and a control channel configured by using an upper layer, the scheduling offset (K0) value, and the OFDM symbol start location 800 and length 805 within one slot dynamically indicated through DCI.

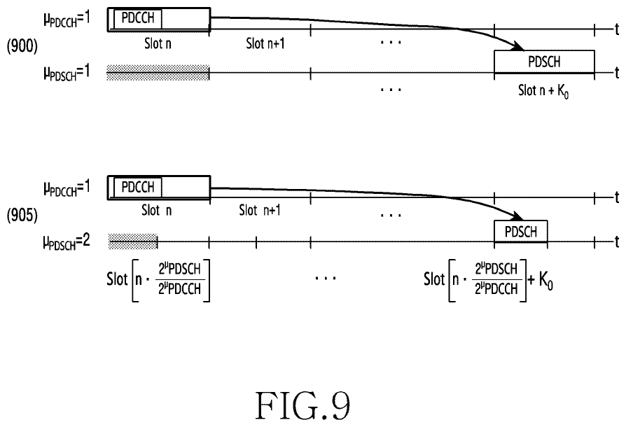

FIG. 9 illustrates an example of time domain resource allocation according to a subcarrier spacing with regard to a data channel and a control channel in a wireless communication system according to an embodiment of the disclosure.

Referring to FIG. 9, if the data channel and the control channel have the same subcarrier spacing (900, μ_{PDSCH}=μ_{PDCCH}), the slot number for data and that for control are identical, and the base station and the UE may accordingly generate a scheduling offset in conformity with a predetermined slot offset K0. On the other hand, if the data channel and the control channel have different subcarrier spacings (905, μ_{PDSCH}≠μ_{PDCCH}), the slot number for data and that for control are different, and the base station and the UE may accordingly generate a scheduling offset in conformity with a predetermined slot offset K0 with reference to the subcarrier spacing of the PDCCH.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 16 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 16 through upper signaling. If PUSCH transmission is operated by a configured grant, parameters applied to the PUSCH transmission are applied through configuredGrantConfig (upper signaling) in Table 16 except for dataScramblingdentityPUSCH, txConfig, codebookSubset, maxRank, and scaling of UCI-OnPUSCH, which are provided by pusch-Config (upper signaling) in Table 17. If provided with transformPrecoder inside configuredGrantConfig (upper signaling) in Table 16, the UE applies tp-pi2BPSK inside pusch-Config in Table 17 to PUSCH transmission operated by a configured grant. Obviously, the example given above is not limiting.

TABLE 16

| | |
|---|---|
| ConfiguredGrantConfig ::= | SEQUENCE { |

| | |
|---|---|
| frequencyHopping | ENUMERATED {intraSlot, interSlot} |

OPTIONAL, -- Need S,

| | |
|---|---|
| cg-DMRS-Configuration | DMRS-UplinkConfig, |

| | |
|---|---|
| mcs-Table | ENUMERATED {qam256, qam64LowSE} |

OPTIONAL, -- Need S

| | |
|---|---|
| mcs-Table TransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resource Allocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |

| | |
|---|---|
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |

| | |
|---|---|
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14, sym2560x14,

sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequency HoppingOffset | INTEGER (1.. |
| maxNrofPhysicalResourceBlocks-1) | OPTIONAL, -- Need R |
| pathlossReferenceIndex | INTEGER (0..maxNrofPUSCH- |

PathlossReferenceRSs-1),
...

| | |
|---|---|
| } | OPTIONAL, |

-- Need R
...
}

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 15, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE may perform beam configuration for PUSCH transmission by using pucch-spatialRelationInfoD corresponding to a UE-specific PUCCH resource corresponding to the minimum ID inside an activated uplink BWP inside a serving cell, and the PUSCH transmission may be based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config

TABLE 17

| | |
|---|---|
| PUSCH-Config ::= | SEQUENCE { |

| | |
|---|---|
| data ScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks-1)
OPTIONAL, -- Need M

| | |
|---|---|
| resourceAllocation | ENUMERATED { resourceAllocationType0, |

resourceAllocation Type1, dynamicSwitch},

| | |
|---|---|
| pusch-TimeDomainAllocationList | SetupRelease { PUSCH- |

| | |
|---|---|
| TimeDomainResourceAllocationList } | OPTIONAL, -- Need M |

| | |
|---|---|
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-Table TransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fully AndPartialAndNonCoherent, |

partial AndNonCoherent,nonCoherent}
OPTIONAL, -- Cond codebookBased

| | | |
|---|---|---|
| maxRank | INTEGER (1..4) | OPTIONAL, |

-- Cond codebookBased

| | | |
|---|---|---|
| rbg-Size | ENUMERATED { config2} | OPTIONAL, |

-- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, codebook-based PUSCH transmission will be described. The codebook-based PUSCH transmission may be dynamically scheduled through DCI format 0_0 or 0_1, and may be semi-statically operated by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI may be used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the base station. If the UE reported “partialAndNonCoherent” as UE capability, the UE may not expect that the value of codebookSubset (upper signaling) will be configured as “fullyAndPartialAndNonCoherent”. In addition, if the UE reported “nonCoherent” as UE capability, UE may not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE may expect that the value of nrofSRS-Ports inside SRS-Resource (upper signaling) is identical for all SRS resources.

The UE may transmit, to the base station, one or multiple SRS resources included in the SRS resource set wherein the value of usage is configured as “codebook” according to upper signaling, and the base station may select one from the SRS resources transmitted by the UE and indicate the UE to be able to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be semi-statically operated by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE may not expect that information regarding the precoder for SRS transmission will be updated.

If the configured value of resourceType inside SRS-ResourceSet (upper signaling) is “aperiodic”, the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS may be positioned in the slot used to transmit the PDCCH including the SRS request field. In this case, TCI states configured for the scheduled subcarrier may not be configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE may not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook”, and the base station may select one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the base station may be the number of transmission layers of the PUSCH, and the UE may transmit the PUSCH by applying the precoder applied to SRS resource transmission to each layer.

### [Regarding CA/DCI]

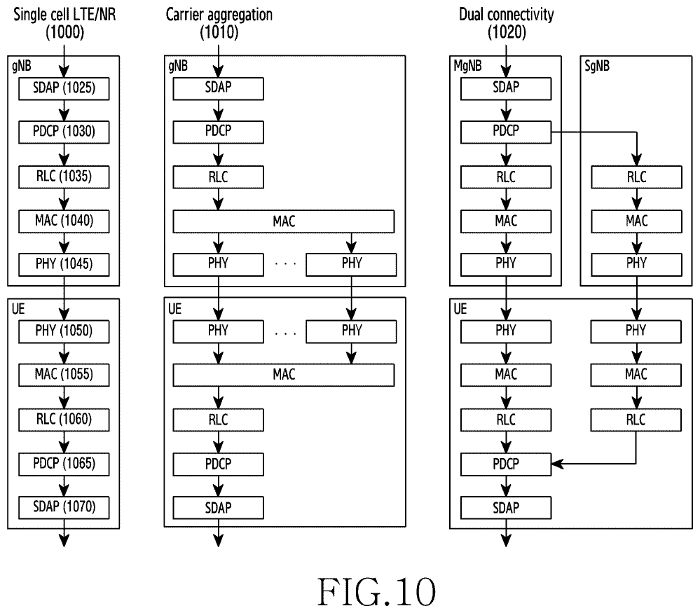

FIG. 10 illustrates radio protocol structures of a base station and a UE in single cell, carrier aggregation, and dual connectivity situations according to an embodiment of the disclosure.

Referring to FIG. 10, the radio protocol of a next-generation mobile communication system includes an NR service data adaptation protocol (SDAP) 1025 or 1070, an NR packet data convergence protocol (PDCP) 1030 or 1065, an NR radio link control (RLC) 1035 or 1060, and an NR medium access control (MAC) 1040 or 1055, on each of UE and NR base station sides. Obviously, the above example is not limiting, and the radio protocol may include a larger or smaller number of layers.

The main functions of the NR SDAP 1025 or 1070 may include some of functions below. Obviously, the example given below is not limiting.
Transfer of user plane data
Mapping between a QoS flow and a DRB for both DL and UL
Marking QoS flow ID in both DL and UL packets
Reflective QoS flow to DRB mapping for the UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 1030 or 1065 may include some of the following functions: below. Obviously, the example given below is not limiting.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The above-mentioned reordering of the NR PDCP device 1030 or 1065 refers to a function of reordering PDCP PDUs received from a lower layer in an order based on the PDCP sequence number (SN), and may include a function of transferring data to an upper layer in the reordered sequence. Alternatively, the reordering of the NR PDCP device 1030 or 1065 may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC 1035 or 1060 may include some of the following functions: below. Obviously, the example given below is not limiting.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device 1035 or 1060 may refer to a function of successively delivering RLC SDUs, received from the lower layer, to the upper layer. The in-sequence delivery of the NR RLC device 1035 or 1060 may include a function of reassembling and delivering multiple RLC SDUs received, into which one original RLC SDU has been segmented, may include a function of reordering the received RLC PDUs with reference to the RLC sequence number (SN) or PDCP sequence number (SN), may include a function of recording RLC PDUs lost as a result of reordering, may include a function of reporting the state of the lost RLC PDUs to the transmitting side, and may include a function of requesting retransmission of the lost RLC PDUs. The in-sequence delivery function of the NR RLC device 1035 or 1060 may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device 1035 or 1060 may include a function of, if a predetermined timer has expired although there is a lost RLC SDU, successively delivering all currently received RLC SDUs to the upper layer. In addition, the in-sequence delivery of the NR RLC device 1035 or 1060 may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device 1035 or 1060 may refer to a function of directly delivering RLC SDUs, received from the lower layer, to the upper layer regardless of the sequence. The out-of-sequence delivery may include a function of, if one original RLC SDU is segmented into multiple RLC SDUs and the segmented RLC SDUs are received, reassembling the RLC SDUs and delivering the reassembled RLC SDUs, and may include a function of storing the RLC SN or PDCP SN of received RLC PDUs, and recording RLC PDUs lost as a result of reordering.

The NR MAC 1040 or 1055 may be connected to multiple NR RLC layer devices configured in one UE, and the main functions of the NR MAC may include some of functions below. Obviously, the example given below is not limiting.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 1045 or 1050 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. Obviously, the example given above is not limiting.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 1000. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 1010. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as 1020.

Referring to the above description relating to the PDCCH and beam configuration, PDCCH repetitive transmission is not supported in current Rel-15 and Rel-16 NR, and it may be thus difficult to achieve required reliability in a scenario requiring high reliability, such as URLLC. The disclosure may provide a PDCCH repetitive transmission method through multiple transmission/reception points (TRPs). According to the disclosure, the PDCCH reception reliability of a UE may be improved. Specific methods thereof will be described hereinafter through the embodiments below.

Hereinafter, embodiments of the disclosure will be described in detail in conjunction with the accompanying drawings. An embodiment of the disclosure may be applied to systems such as frequency division duplex (FDD), time division duplex (TDD), and cross division duplex (XDD), but may not be limited thereto. As used herein, upper signaling (or upper layer signaling”) may refer to a method for transferring signals from a base station to a UE by using a downlink data channel of a physical layer, or from the UE to the base station by using an uplink data channel of the physical layer, or the signals thereof. For example, the upper signaling (or upper layer signaling) may also be referred to as “RRC signaling”, “PDCP signaling”, or “medium access control (MAC) control element (MAC CE)”, but may not be limited thereto.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. In the following description, for the sake of descriptive convenience, non-coherent joint transmission (NC-JT) case may refer to a case in which the UE receives a PDSCH to which cooperative communication is applied, based on conditions similar to those described above. That is, the NC-JT case in the disclosure may include reception of a PDSCH to which cooperative communication is applied, and whether the cooperative communication is applied may be identified according to at least one of the above-described conditions/methods or at least one combination thereof.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through multiple embodiments, but they are not independent of each other, and one or more embodiments may be applied simultaneously or in combination.

In the following description of the disclosure, upper layer signaling may refer to signaling corresponding to at least one signaling among the following signaling, or a combination of one or more thereof. Obviously, the examples given below are not limiting.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof. Obviously, the examples given below are not limiting.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI(for example, DCI not used for the purpose of scheduling downlink or uplink data)
Physical uplink control channel (PUCCH)
Uplink control information (UCI)

### [Regarding MC-DCI]

In the disclosure, one DCI may be a single DCI or one DCI format. Multiple DCIs may be a multi-DCI or multiple DCI formats. In the disclosure, one DCI may be one PDCCH and/or may be transmitted and/or received through one PDCCH. Multiple DCIs may be multiple PDCCHs and/or may be transmitted and/or received through multiple PDCCHs.

The UE may receive one DIC, which may include scheduling information regarding one cell. For example, in the case of DCI format 0_0/0_1/0_2, one PUSCH may be scheduled for one uplink cell. In addition, in the case of DCI format 1_0/1_1/1_2, one PDSCH may be scheduled for one downlink cell. The scheduled cell may be indicated by the DCI format's carrier indication field (CIF).

However, if such a scheme is followed, multiple DCIs may need to be transmitted and/or received in case that a PDSCH or PUSCH is scheduled in each of multiple cells. As a result, a large amount of DCI overhead may occur. In order to reduce the DCI overhead, one DCI may schedule a PDSCH or PUSCH for each of multiple cells. The description that one DCI schedules a PDSCH or PUSCH for each of multiple cells may be referred to as a multi-cell DCI (MC-DCI) for convenience of description. In the disclosure, the MC-DCI may be one DCI which schedules a PDSCH and/or a PUSCH for each of multiple cells. In the disclosure, the DCI which schedules a PDSCH for each of multiple cells may be DCI format 1_3. In addition, the DCI which schedules a PUSCH for each of multiple cells may be DCI format 0_3.

Cells which may be scheduled by the MC-DCI may be configured by the upper layer. For example, it may be assumed that the MC-DCI may (simultaneously) schedule cell 0, cell 1, cell 2, and cell 3. Upon receiving the MC-DCI, the UE may receive scheduling information regarding the cell 0, cell 1, cell 2, and cell 3. For example, the UE may acquire scheduling information regarding cell 0, cell 1, cell 2, and cell 3 from the MC-DCI. For example, the upper layer may configure the fact that the MC-DCI may schedule cell 0, cell 1, cell 2, and cell 3. The scheduling information may include time domain resource allocation (TDRA) information and/or frequency domain resource allocation (FDRA) information by which a data channel (for example, PDSCH in the case of the downlink and PUSCH in the case of the uplink) is transmitted and/or received in each cell. Therefore, the UE may acquire each cell's scheduling information through the MC-DCI, and may transmit and/or receive a data channel to each cell.

There may be a case in which the base station cannot schedule all cells configured for the UE in a specific situation. There may occur a case in which the base station cannot schedule at least some of multiple cells configured for the UE. For example, the base station has configured four cells (for example, cell 0, cell 1, cell 2, and cell 3) scheduled by MC-DCI for the UE, but some cells may have been scheduled for another UE, or may be unable to be scheduled due to a bad channel situation or other various reasons. The base station may then indicate scheduling cells, among preconfigured cells scheduled by MC-DCI, to the UE. For example, the base station may indicate one or more cells which are (actually) scheduled, among multiple cells configured to be scheduled by MC-DCI.

The UE may acquire information indicating co-scheduled cells by MC-DCI, among preconfigured cells (for example, cell 0, cell 1, cell 2, and cell 3), from MC-DCI. For example, one or more cells (actually) co-scheduled through MC-DCI, among multiple cells configured to be scheduled by MC-DCI, may be identified based on MC-DCI. More specifically, the base station may configure a table including co-scheduled cells for the UE. For example, rows of the above-mentioned table may have unique indices. The index of each row (and/or each row) may include the index of co-scheduled cells. For example, (cell 0, cell 1) may be configured for row 0, (cell 2, cell 3) may be configured for row 1, and (cell 0, cell 1, cell 2, cell 3) may be configured for row 2. Table 18 may be referred to as an example of the table configured for the UE. Obviously, the following example is not limitative.

TABLE 18

| index | Co-scheduled cell |
|---|---|
| 0 | {0, 1} |
| 1 | {2, 3} |
| 2 | {0, 1, 2, 3} |

The UE may acquire a value indicating a row index in Table 18 from MC-DCI. Therefore, the UE may determine a scheduled cell, based on the value. For example, MC-DCI may include information regarding a row index, and the UE may identify a scheduled cell, based on the table and the row index acquired from MC-DCI. For example, in case that row 0 is indicated by MC-DCI, the UE may identify that cell 0 and cell 1 are scheduled cells. For example, in case that row 1 is indicated by MC-DCI, the UE may identify that cell 2 and cell 3 are scheduled cells. For example, in case that row 2 is indicated by MC-DCI, the UE may identify that cell 0, cell 1, cell 2, and cell 3 are scheduled cells.

In the disclosure, a table regarding the mapping relationship between a scheduled cell (or schedule cell's index) and an index indicated by DCI may be configured. In addition, a scheduled cell may be identified based on the table regarding the mapping relationship and the index indicated by DCI.

Although an embodiment in which co-scheduled cells are identified based on a row index of the table has been described in the disclosure, the disclosure is not limited thereto. For example, co-scheduled cells may be identified based on a column index of the table and, in this case, rows may be replaced with columns in the above-described embodiment.

In the second method, the UE may make a determination based on the FDRA field of MC-DCI.

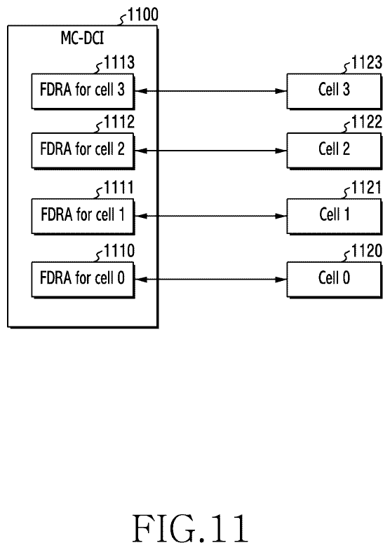

FIG. 11 illustrates an example in which MC-DCI according to an embodiment of the disclosure includes multiple FDRA fields.

Referring to FIG. 11, MC-DCI 1100 may include multiple FDRA fields. Each field may have a corresponding cell. For example, in case that cell 0 1120, cell 1 1121, cell 2 1122, and cell 3 1123 are configured as co-schedulable cells by MC-DCI 1100, MC-DCI 1100 may include a FDRA field 1110 for cell 0, a FDRA field 1111 for cell 1, a FDRA field 1112 for cell 2, and a FDRA field 1113 for cell 3. The UE may determine whether each cell has been scheduled, based on the FDRA field's value. Cells scheduled based on FDRA field values may be referred to as actually co-scheduled cells.

A FDRA field may be divided into a valid value and an invalid value. The valid value may correspond to a case in which there exists frequency domain assignment corresponding to the FDRA field's value. On the other hand, the invalid value may correspond to a case in which there exists no frequency domain assignment corresponding to the FDRA field's value.

For example, valid and invalid values may be described based on FDRA type-0. FDRA type-0 may be a method for indicating RBs (or RGBs) scheduled based on a bitmap. Respective bits may have corresponding RBs (or RGB). A bit, if “1”, may mean that corresponding RBs (or RGB) are scheduled, and a bit, if “0”, may mean that corresponding RBs (or RGB) are not scheduled. Therefore, the UE may determine, based on FDRA type-0, that, if at least one bit of a FDRA is “1”, the same indicates a valid value and, if all bits are “0”, the same indicate an invalid value.

For example, valid and invalid values may be described based on FDRA type-1. FDRA type-1 may be a method for indicating RBs scheduled based on a resource indication value (RIV). FDRA type-1 may schedule continuous RBs in the frequency domain. FDRA type-1 may indicate the index of the starting RB and the number of continuous RBs. The RIV value may be one of 0, 1, . . . , N*(N+1)/2-1. N may be the number of RBs included in the frequency domain. Therefore, the RIV value, if one of 0, 1, . . . , N*(N+1)/2-1, may be determined to be a valid value, and a value equal to or larger than N*(N+1)/2 may be determined to be an invalid value. For example, if all bits of a FDRA field configured by FDRA type-1 are “1”, the UE may confirm an invalid value.

For example, the base station may dynamically configure FDRA type-0 and FDRA type-1 for the UE. The most significant bit (MSB) of a FDRA field may indicate whether FDRA type-0 is used or FDRA type-1 is used. If all bits of a FDRA field for which a dynamic change is configured are “0” or “1”, the UE may confirm an invalid value.

For example, valid and invalid values may be described based on FDRA type-2. FDRA type-2 may be used to schedule a physical uplink shared channel (PUSCH) in an unlicensed band. FDRA type-2 may be a bitmap-based scheme or a RIV-based scheme, according to the subcarrier spacing. More specifically, if a cell's subcarrier spacing is 15 kHz, FDRA type-2 may be the RIV-based scheme. If a cell's subcarrier spacing is 30 kHz, FDRA type-2 may be the bitmap-based scheme. Therefore, if a cell's subcarrier spacing is 15 kHz, an invalid value may be confirmed in case that all bits of a FDRA field configured by FDRA type-2 are “1”. If a cell's subcarrier spacing is 30 kHz, an invalid value may be confirmed in case that all bits of a FDRA field configured by FDRA type-1 are “0”.

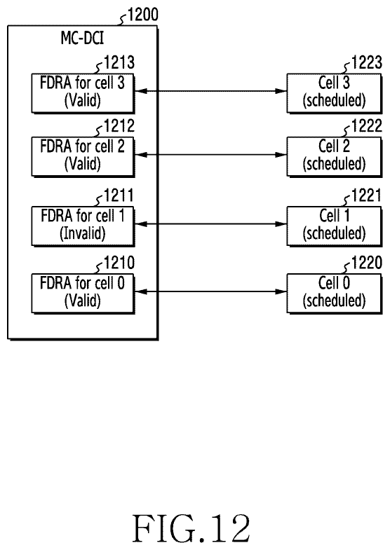

FIG. 12 illustrates an example in which actually co-scheduled cells are determined based on multiple FDRA fields included in MC-DCI according to an embodiment of the disclosure.

Referring to FIG. 12, the MC-DCI 1200 may include FDRA fields for multiple cells (for example, cell 0 1220, cell 1 1221, cell 2 1222, and cell 1223), respectively (for example, a FDRA 1210 for cell 0, a FDRA 1211 for cell 1, a FDRA 1212 for cell 2, and a FDRA 1213 for cell 3). The UE may determine the validity of each FDRA field. For example, the UE may determine that the FDRA 1210 for cell 0, the FDRA 1212 for cell 2, and the FDRA 1213 for cell 3 are valid, and may determine that the FDRA 1211 for cell 1 is invalid. Cell 1 determined to be invalid may not be scheduled, and cell 0, cell 2, and cell 3 determined to be valid may be scheduled.

The UE may acquire a scheduled cell's information from MC-DCI. MC-DCI may include the following at least two types of DCI fields.

In the first type, information of one DCI field is commonly applied to multiple scheduled cells. For example, in the case of a downlink assignment index, a TPC command for a scheduled PUCCH, a PUCCH resource indicator, a PDSCH-to-HARQ_feedback timing indicator field, or the like, information of one DCI field may be commonly applied to multiple scheduled cells.

In the second type, one DCI field may include blocks corresponding to multiple scheduled cells, respectively, and each block's information may be applied to the corresponding cell. For example, at least one of a frequency domain resource assignment (FDRA) field, a modulation and coding scheme (MCS) field, a new data indication (NDI) field, and a HARQ process number field may be of the second type. If a DCI field of the second type includes multiple blocks, the blocks may have different lengths (payload sizes). For example, if a FDRA field includes a first block for a first cell and includes a second block for a second cell, the first and second blocks may have identical or different lengths. For example, the first block may have a length corresponding to 10 bits, and the second block may have a length corresponding to 5 bits. For example, a FDRA field may be expanded to DCI field included in the second type.

The following table shows an embodiment of DCI format 0_3. Obviously, the following example is not limitative.

```
TABLE 18-1
7.3.1.1.4 Format 0_3
DCI format 0_3 is used for the scheduling of one PUSCH in one cell, or multiple PUSCHs in
multiple cells with one PUSCH per cell.
The following information is transmitted by means of the DCI format 0_3 with CRC scrambled
by C-RNTI or MCS-C-RNTI:
  - Identifier for DCI formats - 1 bit
    - The value of this bit field is always set to 0, indicating an UL DCI format
  - Scheduled cell set indicator - ┌log₂Nₛₑₜ┐ bits, where Nₛₑₜ is the number of cell sets which
    are configured by higher layer parameter MC-DCI-SetofCellsToAddModList to be
    respectively scheduled by DCI format 0_3/1_3 from the cell on which this format is
    carried by PDCCH. If present, this field is used to indicate the scheduled cell set according
    to Table 7.3.1.1.4-1; otherwise, the scheduled cell set is the cell set configured to be
    scheduled by DCI format 0_3/1_3 from the cell by higher layer parameter MC-DCI-
    SetofCellsToAddModList.
  - Scheduled cells indicator - number of bits determined by the following:
    - 0 bit if the higher layer parameter ScheduledCellCombo-ListDCI-0-3 for the scheduled
        cell set is not configured;
    - otherwise ┌log₂I_{UL}┐ bits indicating the scheduled cells in the scheduled cell set
        according to Table 7.3.1.1.4-2, where I_{UL} is the number of entries in the higher layer
        parameter ScheduledCellCombo-ListDCI-0-3. If only one entry is configured in the
        higher layer parameter ScheduledCellCombo-ListDCI-0-3, the scheduled cells are the
        cells configured by higher layer parameter ScheduledCellCombo-ListDCI-0-3.
  - Bandwidth part indicator - 0, 1 or 2 bits determined as ┌log₂n_{BWP,max}┐, where
    - n_{BWP,max} = n_{BWP,RRC}^{max} + 1 if n_{BWP,RRC}^{max} ≤ 3, n_{BWP,RRC}^{max} is the maximum number of UL
        BWPs configured by higher layers across all the cells configured by higher layer
        parameter ScheduledCell-ListDCI-0-3 in the scheduled cell set, in which case the
        bandwidth part indicator is equivalent to the ascending order of the higher layer
        parameter BWP-Id;
    - otherwise n_{BWP,max} = n_{BWP,RRC}^{max}, in which case the bandwidth part indicator is defined
        in Table 7.3.1.1.2-1;
    The field is only applicable to a scheduled cell with the number of configured UL BWPs
    larger than 1, including the initial UL bandwidth part, and is applied to the applicable
    scheduled cells in the scheduled cell set independently. If a UE does not support active
    BWP change via DCI, the UE ignores this bit field.
  - Frequency domain resource assignment - number of bits determined by the following,
    where N_{RB}^{NUL,BWP} is the size of the active UL bandwidth part:
    - block number 1, block number 2, ... , block number N_{cell}^{UL}
    If ScheduledCellCombo-ListDCI-0-3 for the scheduled cell set is configured with more
    than one entry, N_{cell}^{UL} is the number of scheduled cells indicated by Scheduled cells
    indicator field; if ScheduledCellCombo-ListDCI-0-3 for the scheduled cell set is
    configured with only one entry, N_{cell}^{UL} is the number of cells configured by higher layer
    parameter ScheduledCellCombo-ListDCI-0-3; otherwise, N_{cell}^{UL} is the number of cells
    configured by higher layer parameter ScheduledCell-ListDCI-0-3 in the scheduled cell set.
    Each block corresponds to the frequency domain resource assignment for a cell, and the
    blocks are placed according to an ascending order of a serving cell index, with block
    number 1 corresponding to the frequency domain resource assignment for the cell with
    the smallest serving cell index. Each block is defined by the following fields:
    - If higher layer parameter useInterlacePUCCH-PUSCH in BWP-UplinkDedicated is
        not configured
        - N_{RBG} bits if only resource allocation type 0 is configured, where N_{RBG} is defined in
          Clause 6.1.2.2.1 of [6, TS 38.214]
        - ┌log₂(N_{RBG,K1}(N_{RBG,K1} + 1)/2)┐ bits if only resource allocation type 1 is
          configured, or max(┌[log₂(N_{RBG,K1}(N_{RBG,K1} + 1)/2)┐, N_{RBG}) + 1 bits if
          resourceAllocationDCI-0-3 is configured as ‘dynamicSwitch’, where N_{RBG,K1} =
          ┌(N_{RB}^{UL,BWP} + (N_{UL,BWP}^{start} mod K1))/K1┐, N_{RB}^{UL,BWP} is the size of the active UL
          bandwidth part, N_{UL,BWP}^{start} is defined as in clause 4.4.4.4 of [4, TS 38.211] and K1 is
          given by higher layer parameter resourceAllocationType1GranularityDCI-0-3. If
          the higher layer parameter resourceAllocationType1GranularityDCI-0-3 is not
          configured, K1 is equal to 1.
        - If resource AllocationDCI-0-3 is configured as ‘dynamicSwitch’, the MSB bit is used
          to indicate resource allocation type 0 or resource allocation type 1, where the bit
          value of 0 indicates resource allocation type 0 and the bit value of 1 indicates
          resource allocation type 1.
        - For resource allocation type 0, the N_{RBG} LSBs provide the resource allocation as
          defined in Clause 6.1.2.2.1 of [6, TS 38.214].
        - For resource allocation type 1, the ┌log₂(N_{RBG,K1}(N_{RBG,K1} + 1)/2)┐ LSBs provide
          the resource allocation as follows:
          - For PUSCH hopping with resource allocation type 1:
            - N_{UL}_hop MSB bits are used to indicate the frequency offset according to Clause
                6.3 of [6, TS 38.214], where N_{UL}_hop = 1 if the higher layer parameter
                frequencyHoppingOffsetLists contains two offset values and N_{UL}_hop = 2 if
                the higher layer parameter frequencyHoppingOffsetLists contains four offset
                values
            - ┌log₂(N_{RBG,K1}(N_{RBG,K1} + 1)/2)┐ - N_{UL}_hop bits provide the frequency
                domain resource allocation according to Clause 6.1.2.2.2 of [6, TS 38.214]
          - For non-PUSCH hopping with resource allocation type 1:
            - ┌log₂(N_{RBG,K1}(N_{RBG,K1} + 1)/2)┐ bits provide the frequency domain resource
                allocation according to Clause 6.1.2.2.2 of [6, TS 38.214]
        If “Bandwidth part indicator” field indicates a bandwidth part other than the active
        bandwidth part and if resource AllocationDCI-0-3 is configured as ‘dynamicSwitch’ for
        the indicated bandwidth part, the UE assumes resource allocation type 0 for the
        indicated bandwidth part if the bitwidth of the “Frequency domain resource
        assignment” field of the active bandwidth part is smaller than the bitwidth of the
        “Frequency domain resource assignment” field of the indicated bandwidth part.
    - If the higher layer parameter useInterlacePUCCH-PUSCH in BWP-UplinkDedicated
        is configured
        - 5 + Y bits provide the frequency domain resource allocation according to Clause
          6.1.2.2.3 of [6, TS 38.214] if the subcarrier spacing for the active UL bandwidth part
          is 30 kHz. The 5 MSBs provide the interlace allocation and the Y LSBs provide the
          RB set allocation.
        - 6 + Y bits provide the frequency domain resource allocation according to Clause
          6.1.2.2.3 of [6, TS 38.214] if the subcarrier spacing for the active UL bandwidth part
          is 15 kHz. The 6 MSBs provide the interlace allocation and the Y LSBs provide the
          RB set allocation.
        $The value of Y is determined by ⌈ {log}_{2} ( \frac{{N}_{RB - set , UL}^{BWP} ( {N}_{RB - set , UL}^{BWP} + 1 )}{2} ) ⌉ where {N}_{RB - set , UL}^{BWP} is$
        the number of RB sets contained in the active UL BWP as defined in clause 7 of [6,
        TS38.214].
    If the higher layer parameter ScheduledCellCombo-ListDCI-0-3 for the scheduled cell set
    is not configured, each block is also used to indicate whether the corresponding cell is
    scheduled or not as follows:
        - if all bits of a block are set to 0 for resource allocation type 0 or set to 1 for resource
          allocation type 1 or set to 0 or 1 for dynamic switch resource allocation type, the cell
          corresponding to the block is not scheduled;
        - otherwise, the cell corresponding to the block is scheduled.
  - Time domain resource assignment - ┌log₂(I)┐ bits, where I is the number of entries in the
    higher layer parameter TDRA-FieldIndexListDCI-0-3. This field is used to indicate an
    entry in the higher layer parameter TDRA-FieldIndexListDCI-0-3 according to Table
    7.3.1.1.4-3. Each entry in the higher layer parameter TDRA-FieldIndexListDCI-0-3
    contains the ‘Time domain resource assignment’ index for each cell in the scheduled cell
    set, where the ‘Time domain resource assignment’ indexes for all the cells are placed
    according to an ascending order of a serving cell index.
  - Frequency hopping flag - 0 or 1 bit
    - 0 bit if the higher layer parameter frequencyHopping is not configured for any cell
        configured by higher layer parameter ScheduledCell-ListDCI-0-3 in the scheduled cell
        set;
    - 1 bit according to Table 7.3.1.1.1-3 otherwise, only applicable to resource allocation
        type 1, as defined in Clause 6.3 of [6, TS 38.214].
    The field is only applicable to a scheduled cell configured with frequencyHopping, and is
    applied to the applicable scheduled cells independently.
  - Modulation and coding scheme - number of bits determined by the following:
    - block number 1, block number 2, ... , block number N_{cell}^{UL}
    Each block corresponds to the modulation and coding scheme for a scheduled cell, and
    the blocks are placed according to an ascending order of a serving cell index, with block
    number 1 corresponding to the modulation and coding scheme for the cell with the
    smallest serving cell index. Each block is 5 bits as defined in Clause 6.1.4.1 of [6, TS
    38.214].
  - New data indicator - number of bits determined by the following:
    - block number 1, block number 2, ... , block number N_{cell}^{UL}
    Each block corresponds to the new data indicator for a scheduled cell, and the blocks are
    placed according to an ascending order of a serving cell index, with block number 1
    corresponding to the new data indicator for the cell with the smallest serving cell index.
    Each block is 1 bit.
  - Redundancy version - number of bits determined by the following:
    - block number 1, block number 2, ... , block number N_{cell}^{UL}
    Each block corresponds to the redundancy version for a scheduled cell, and the blocks are
    placed according to an ascending order of a serving cell index, with block number 1
    corresponding to the redundancy version for the cell with the smallest serving cell index.
    Each block is 0, 1 or 2 bits determined by higher layer parameter numberOfBitsForRV-
    DCI-0-3 configured for the cell correponding to the block,
    - If 0 bit is configured, rv_{id} to be applied is 0;
    - 1 bit according to Table 7.3.1.2.3-1;
    - 2 bits according to Table 7.3.1.1.1-2.
  - HARQ process number - number of bits determined by the following:
    - block number 1, block number 2, ... , block number N_{cell}^{UL}
    Each block corresponds to the HARQ process number for a scheduled cell, and the blocks
    are placed according to an ascending order of a serving cell index, with block number 1
    corresponding to the HARQ process number for the cell with the smallest serving cell
    index. Each block is 0, 1, 2, 3, 4 or 5 bits determined by higher layer parameter harq-
    ProcessNumberSizeDCI-0-3 configured for the cell correponding to the block.
  - 1^{st} downlink assignment index - 1 or 2 bits
    - 1 bit for semi-static HARQ-ACK codebook;
    - 2 bits for dynamic HARQ-ACK codebook.
    When two HARQ-ACK codebooks are configured for the same serving cell and if higher
    layer parameter priorityIndicatorDCI-0-3 is configured, if the bit width of the 1^{st} downlink
    assignment index in DCI format 0_3 for one HARQ-ACK codebook is not equal to that
    of the 1^{st} downlink assignment index in DCI format 0_3 for the other HARQ-ACK
    codebook, a number of most significant bits with value set to ‘0’ are inserted to smaller 1^{st}
    downlink assignment index until the bit width of the 1^{st} downlink assignment index in
    DCI format 0_3 for the two HARQ-ACK codebooks are the same.
  - 2^{nd} downlink assignment index - 0 or 2 bits:
    - 2 bits for dynamic HARQ-ACK codebook with two HARQ-ACK sub-codebooks;
    - 0 bit otherwise.
    When two HARQ-ACK codebooks are configured for the same serving cell and if higher
    layer parameter priorityIndicatorDCI-0-3 is configured, if the bit width of the 2^{nd}
    downlink assignment index in DCI format 0_3 for one HARQ-ACK codebook is not equal
    to that of the 2^{nd} downlink assignment index in DCI format 0_3 for the other HARQ-ACK
    codebook, a number of most significant bits with value set to ‘0’ are inserted to smaller 2^{nd}
    downlink assignment index until the bit width of the 2^{nd} downlink assignment index in
    DCI format 0_3 for the two HARQ-ACK codebooks are the same.
  - TPC command for scheduled PUSCH - number of bits determined by the following:
    - block number 1, block number 2, ... , block number N_{cell}^{UL}
    Each block corresponds to the TPC command for the scheduled PUSCH for a scheduled
    cell, and the blocks are placed according to an ascending order of a serving cell index,
    with block number 1 corresponding to the TPC command for the scheduled PUSCH for
    the cell with the smallest serving cell index. Each block is 2 bits as defined in Clause 7.1.1
    of [5, TS38.213].
  - SRS resource indicator - number of bits determined by the following:
    - If SRI-DCI0-3 = type1a is configured by higher layer,
        $‐ {max}_{r ∈ \{ 1 , 2 , … , {N}_{cell}^{UL , 2} \}} {M}_{s} ( r ) bits applying to the scheduled cells with {M}_{s} ( r ) > 0$
          independently, where N_{cell}^{UL,2} is the number of cells configured by higher layer
          parameter ScheduledCell-ListDCI-0-3 in the scheduled cell set, r is mapped to the
          cells according to an ascending order of a serving cell index with r = 1
          corresponding to the cell with the smallest serving cell index, and Mₛ(r) is defined
          below.
    - If SRI-DCI0-3 = type 2 is configured by higher layer,
        - block number 1, block number 2, ... , block number N_{cell}^{UL}
        Each block corresponds to the SRS resource indicator for a scheduled cell, and the
        blocks are placed according to an ascending order of a serving cell index, with block
        number 1 corresponding to the SRS resource indicator for the cell with the smallest
        serving cell index. Each block is defined below.
    Mₛ(r) above for the case of SRI-DCI0-3 = type1a or each block above for the case of SRI-
    DCI0-3 = type2 is defined by the following:
        $‐ ⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ bits according to Tables 7.3 \text{.1} \text{.1} \text{.2} ‐ 28 / 29 / 30 / 31 if$
          the higher layer parameter txConfig = nonCodebook, where N_{SRS} is the number of
          configured SRS resources in the first SRS resource set configured by higher layer
          parameter srs-ResourceSetToAddModList, and associated with the higher layer
          parameter usage of value ‘nonCodeBook’ and
          - if UE supports operation with maxMIMO-Layers and the higher layer parameter
              maxMIMO-Layers of PUSCH-ServingCellConfig of the serving cell is
              configured, Lₘₐₓ is given by that parameter
          - otherwise, Lₘₐₓ is given by the maximum number of layers for PUSCH supported
              by the UE for the serving cell for non-codebook based operation.
          - [log₂(N_{SRS})┐ bits according to Tables 7.3.1.1.2-32, 7.3.1.1.2-32A and 7.3.1.1.2-32B
              if the higher layer parameter txConfig = codebook, where N_{SRS} is the number of
              configured SRS resources in the first SRS resource set configured by higher layer
              parameter srs-ResourceSetToAddModList, and associated with the higher layer
              parameter usage of value ‘codeBook’.
  - Precoding information and number of layers - number of bits determined by the following:
    - If TPMI-DCI0-3 = type1a is configured by higher layer,
        $‐ {max}_{r ∈ \{ 1 , 2 , … , {N}_{cell}^{UL , 2} \}} {M}_{p} ( r ) bits applying to the scheduled cells with {M}_{p} ( r ) > 0$
              independently, where r is mapped to the cells according to an ascending order of a
              serving cell index with r = 1 corresponding to the cell with the smallest serving cell
              index, and Mₚ(r) is defined below.
    - If TPMI-DCI0-3 = type2 is configured by higher layer,
        - block number 1, block number 2, ... , block number N_{cell}^{UL}
        Each block corresponds to the precoding information and number of layers for a
        scheduled cell, and the blocks are placed according to an ascending order of a serving
        cell index, with block number 1 corresponding to the precoding information and
        number of layers for the cell with the smallest serving cell index. Each block is defined
        below.
    Mₚ(r) above for the case of TPMI-DCI0-3 = type1a or each block above for the case of
    TPMI-DCI0-3 = type2 is defined by the following:
        - 0 bits if the higher layer parameter txConfig = nonCodeBook;
        - 0 bits for 1 antenna port and if the higher layer parameter txConfig = codebook;
        - 4, 5, or 6 bits according to Table 7.3.1.1.2-2 for 4 antenna ports, if txConfig =
          codebook, ul-FullPowerTransmission is not configured or configured to
          fullpowerMode2 or configured to fullpower, transform precoder is disabled, and
          according to the values of higher layer parameters maxRank, and codebookSubset;
        - 4 or 5 bits according to Table 7.3.1.1.2-2A for 4 antenna ports, if txConfig =
          codebook, ul-FullPowerTransmission = fullpowerModel, maxRank = 2, transform
          precoder is disabled, and according to the value of higher layer parameter
          code bookSubset;
        - 4 or 6 bits according to Table 7.3.1.1.2-2B for 4 antenna ports, if txConfig =
          codebook, ul-FullPowerTransmission fullpowerModel, maxRank = 3 or 4,
          transform precoder is disabled, and according to the value of higher layer parameter
          codebookSubset;
        - 2, 4, or 5 bits according to Table 7.3.1.1.2-3 for 4 antenna ports, if txConfig =
          codebook, ul-FullPowerTransmission is not configured or configured to
          fullpowerMode2 or configured to fullpower, and according to whether transform
          precoder is enabled or disabled, and the values of higher layer parameters maxRank
          and codebookSubset;
        - 3 or 4 bits according to Table 7.3.1.1.2-3A for 4 antenna ports, if txConfig =
          codebook, ul-FullPower Transmission fullpowerModel, maxRank =1, and
          according to whether transform precoder is enabled or disabled, and the value of
          higher layer parameter codebookSubset;
        - 2 or 4 bits according to Table7.3.1.1.2-4 for 2 antenna ports, if txConfig = codebook,
          ul-FullPower Transmission is not configured or configured to fullpowerMode 2 or
          configured to fullpower, transform precoder is disabled, and according to the values
          of higher layer parameters maxRank and codebookSubset;
        - 2 bits according to Table 7.3.1.1.2-4A for 2 antenna ports, if txConfig = codebook,
          ul-FullPowerTransmission fullpowerModel, transform precoder is disabled,
          maxRank = 2, and codebookSubset = nonCoherent;
        - 1 or 3 bits according to Table7.3.1.1.2-5 for 2 antenna ports, if txConfig = codebook,
          ul-FullPower Transmission is not configured or configured to fullpowerMode 2 or
          configured to fullpower, and according to whether transform precoder is enabled or
          disabled, and the values of higher layer parameters maxRank and codebookSubset;
        - 2 bits according to Table 7.3.1.1.2-5A for 2 antenna ports, if txConfig = codebook,
          ul-FullPower Transmission = fullpowerModel, maxRank = 1, and according to
          whether transform precoder is enabled or disabled, and the value of higher layer
          parameter codebookSubset.
        For the higher layer parameter txConfig = codebook, if ul-FullPowerTransmission is
        configured to fullpowerMode2, maxRank is configured to be larger than 2, and at least
        one SRS resource with 4 antenna ports is configured in the SRS resource set indicated
        by SRS resource set indicator field if present, otherwise in an SRS resource set with
        usage set to ‘codebook’, and an SRS resource with 2 antenna ports is indicated via SRI
        in the same SRS resource set, then Table 7.3.1.1.2-4 is used.
        For the higher layer parameter txConfig = codebook, if different SRS resources with
        different number of antenna ports are configured, the bitwidth is determined according
        to the maximum number of ports in an SRS resource among the configured SRS
        resources in all SRS resource set(s) with usage set to ‘codebook’. If the number of ports
        for a configured SRS resource in the set is less than the maximum number of ports in
        an SRS resource among the configured SRS resources, a number of most significant
        bits with value set to ‘0’ are inserted to the field.
  - Antenna ports - number of bits determined by the following:
    - If AntennaPortsDCI0-3= type la is configured by higher layer,
        $‐ {max}_{r ∈ \{ 1 , 2 , … , {N}_{cell}^{UL , 2} \}} {M}_{A} ( r ) bits applying to the scheduled cells independently , where r is$
          mapped to the cells according to an ascending order of a serving cell index with r =
          1 corresponding to the cell with the smallest serving cell index, and M_{A}(r) is
          defined below.
    - If AntennaPortsDCI0-3 = type2 is configured by higher layer,
        - block number 1, block number 2, ... , block number N_{cell}^{UL}
        Each block corresponds to the Antenna ports information for a scheduled cell, and the
        blocks are placed according to an ascending order of a serving cell index, with block
        number 1 corresponding to the Antenna ports information for the cell with the smallest
        serving cell index. Each block is defined below.
    M_{A}(r) above for the case of AntennaPortsDCI0-3 = type1a or each block above for the
    case of AntennaPortsDCI0-3 = type2 is defined by the following:
        - 2 bits as defined by Tables 7.3.1.1.2-6, if transform precoder is enabled, dmrs-
          Type = 1, and maxLength = 1, except that dmrs-UplinkTransformPrecoding and tp-
          pi2BPSK are both configured and π/2 BPSK modulation is used;
        - 2 bits as defined by Tables 7.3.1.1.2-6A, if transform precoder is enabled and dmrs-
          UplinkTransformPrecoding and tp-pi2BPSK are both configured, π/2 BPSK
          modulation is used, dmrs-Type = 1, and maxLength = 1, where n_{SCID} is the scrambling
          identity for antenna ports defined in [Clause 6.4.1.1.1.2, TS38.211];
        - 4 bits as defined by Tables 7.3.1.1.2-7, if transform precoder is enabled, dmrs-
          Type = 1, and maxLength = 2, except that dmrs-UplinkTransformPrecoding and tp-
          pi2BPSK are both configured and π/2 BPSK modulation is used;
        - 4 bits as defined by Tables 7.3.1.1.2-7A, if transform precoder is enabled and dmrs-
          UplinkTransformPrecoding and tp-pi2BPSK are both configured, π/2 BPSK
          modulation is used, dmrs-Type = 1, and maxLength = 2, where nscm is the scrambling
          identity for antenna ports defined in [Clause 6.4.1.1.1.2, TS38.211];
        - 3 bits as defined by Tables 7.3.1.1.2-8/9/10/11, if transform precoder is disabled,
          dmrs-Type = 1, and maxLength = 1, and the value of rank is determined according to
          the SRS resource indicator field if the higher layer parameter txConfig =
          nonCodebook and according to the Precoding information and number of layers
          field if the higher layer parameter txConfig = codebook,
        - 4 bits as defined by Tables 7.3.1.1.2-12/13/14/15, if transform precoder is disabled,
          dmrs-Type = 1, and maxLength = 2, and the value of rank is determined according to
          the SRS resource indicator field if the higher layer parameter txConfig =
          nonCodebook and according to the Precoding information and number of layers
          field if the higher layer parameter txConfig = codebook;
        - 4 bits as defined by Tables 7.3.1.1.2-16/17/18/19, if transform precoder is disabled,
          dmrs-Type = 2, and maxLength = 1, and the value of rank is determined according to
          the SRS resource indicator field if the higher layer parameter txConfig
          nonCodebook and according to the Precoding information and number of layers
          field if the higher layer parameter txConfig = codebook;
        - 5 bits as defined by Tables 7.3.1.1.2-20/21/22/23, if transform precoder is disabled,
          dmrs-Type = 2, and maxLength = 2, and the value of rank is determined according to
          the SRS resource indicator field if the higher layer parameter txConfig =
          nonCodebook and according to the Precoding information and number of layers
          field if the higher layer parameter txConfig = codebook.
        where the number of CDM groups without data of values 1, 2, and 3 in Tables 7.3.1.1.2-
        6 to 7.3.1.1.2-23 refers to CDM groups {0}, {0, 1}, and {0, 1, 2} respectively.
        If a UE is configured with both dmrs-UplinkForPUSCH-MappingTypeA and dmrs-
        UplinkForPUSCH-MappingTypeB, the bitwidth of this field equals max{x_{A}, x_{B}},
        where x_{A} is the “Antenna ports” bitwidth derived according to dmrs-
        UplinkForPUSCH-MappingTypeA and x_{B} is the “Antenna ports” bitwidth derived
        according to dmrs-UplinkForPUSCH-MappingTypeB. A number of |x_{A} - x_{B}| zeros
        are padded in the MSB of this field, if the mapping type of the PUSCH corresponds to
        the smaller value of x_{A} and x_{B}.
  - SRS request - [log₂(I_{SRS})] bits, where I_{SRS} is the number of entries in the higher layer
    parameter srs-RequestListDCI-0-3. This field is used to indicate an entry in the higher
    layer parameter srs-RequestListDCI-0-3 according to Table 7.3.1.1.4-4. Each entry in the
    higher layer parameter srs-RequestListDCI-0-3 contains the ‘SRS request’ index for each
    cell in the scheduled cell set, where the ‘SRS request’ indexes for all the cells are placed
    according to an ascending order of a serving cell index. Each ‘SRS request’ index is
    defined by the following:
    - 2 bits as defined by Table 7.3.1.1.2-24 for UEs not configured with
        supplementaryUplink in ServingCellConfig in the cell; 3 bits for UEs configured with
        supplementaryUplink in ServingCellConfig in the cell where the first bit is the non-
        SUL/SUL indicator as defined in Table 7.3.1.1.1-1 and the second and third bits are
        defined by Table 7.3.1.1.2-24. This bit field may also indicate the associated CSI-RS
        according to Clause 6.1.1.2 of [6, TS 38.214].
  - SRS offset indicator - ┌log₂(I_{offset})┐ bits, whereI_{offset} is the number of entries in the
    higher layer parameter srs-OffsetListDCI-0-3. This field is used to indicate an entry in the
    higher layer parameter srs-OffsetListDCI-0-3 according to Table 7.3.1.1.4-5. Each entry
    in the higher layer parameter srs-OffsetListDCI-0-3 contains the ‘SRS offset indicator’
    index for each cell in the scheduled cell set, where the ‘SRS offset indicator’ indexes for
    all the cells are placed according to an ascending order of a serving cell index. Each ‘SRS
    offset indicator’ index is defined by the following:
    - 0 bit if higher layer parameter AvailableSlotOffset is not configured for any aperiodic
        SRS resource set in the scheduled cell, or if higher layer parameter AvailableSlotOffset
        is configured for at least one aperiodic SRS resource set in the scheduled cell and the
        maximum number of entries of available SlotOffsetList configured for all aperiodic SRS
        resource set(s) is 1;
    - otherwise, ┌log₂(K)┐ bits are used to indicate available slot offset according to Table
        7.3.1.1.2-37 and Clause 6.2.1 of [6, TS 38.214], where K is the maximum number of
        entries of availableSlotOffsetList configured for all aperiodic SRS resource set(s) in the
        scheduled cell;
  - CSI request - 0, 1, 2, 3, 4, 5, or 6 bits determined by higher layer parameter
    reportTriggerSize. This field is applied to the cell with the smallest serving cell index
    among the scheduled cells indicated by Scheduled cells indicator field or Frequency
    domain resource assignment field.
  - PTRS-DMRS association - number of bits determined by the following:
    - block number 1, block number 2, ... , block number N_{cell}^{UL}
    Each block corresponds to the PTRS-DMRS association information for a scheduled cell,
    and the blocks are placed according to an ascending order of a serving cell index, with
    block number 1 corresponding to the PTRS-DMRS association information for the cell
    with the smallest serving cell index. Each block is defined by the following:
    - 0 bit if PTRS-UplinkConfig is not configured in either dmrs-UplinkForPUSCH-
        MappingTypeA or dmrs-UplinkForPUSCH-MappingTypeB and transform precoder is
        disabled, or if transform precoder is enabled, or if maxRankDCI = 1;
    - 2 bits otherwise, where Table 7.3.1.1.2-25 and 7.3.1.1.2-26 are used to indicate the
        association between PTRS port(s) and DMRS port(s) when one PT-RS port and two
        PT-RS ports are configured by maxNrofPorts in PTRS-UplinkConfig respectively, and
        the DMRS ports are indicated by the Antenna ports field.
    If “Bandwidth part indicator” field indicates a bandwidth part other than the active
    bandwidth part and the “PTRS-DMRS association” field is present for the indicated
    bandwidth part but not present for the active bandwidth part, the UE assumes the “PTRS-
    DMRS association” field is not present for the indicated bandwidth part.
  - beta_offset indicator - 0 or 2 bits
    - 0 bit if betaOffsets = semiStatic is configured for all the cells configured by higher
        layer parameter ScheduledCell-ListDCI-0-3 in the scheduled cell set;
    - otherwise 2 bits as defined by Table 9.3-3 in [5, TS 38.213].
    When two HARQ-ACK codebooks are configured for the same serving cell and if higher
    layer parameter priorityIndicatorDCI-0-3 is configured, if the bit width of the beta_offset
    indicator in DCI format 0_3 for one HARQ-ACK codebook is not equal to that of the
    beta offset indicator in DCI format 0_3 for the other HARQ-ACK codebook, a number
    of most significant bits with value set to ‘0’ are inserted to smaller beta_offset indicator
    until the bit width of the beta offset indicator in DCI format 0_3 for the two HARQ-ACK
    codebooks are the same.
    The field is only applicable to a scheduled cell configured with betaOffsets = dynamic,
    and is applied to the applicable scheduled cells independently.
  - DMRS sequence initialization - 1 bit. This field is applied to all the scheduled cells
    indicated by Scheduled cells indicator field or Frequency domain resource assignment
    field independently.
  - UL-SCH indicator - 1 bit. A value of “1” indicates UL-SCH shall be transmitted on the
    PUSCH and a value of “0” indicates UL-SCH shall not be transmitted on the PUSCH. A
    UE is not expected to receive a DCI format 0_3 with UL-SCH indicator of “0” and CSI
    request of all zero(s). This field is applied to the cell with the smallest serving cell index
    among the scheduled cells indicated by Scheduled cells indicator field or Frequency
    domain resource assignment field.
  $‐ ChannelAccess ‐ CPext ‐ CAPC ‐ {max}_{r ∈ \{ 1 , 2 , … , {N}_{cell}^{2} \}} {M}_{c} ( r ) bits applying to the scheduled cells$
    with M_{c}(r) > 0 independently, where N_{cell}² is the number of cells configured by higher
    layer parameter ScheduledCell-ListDCI-0-3 in the scheduled cell set, r is mapped to the
    cells according to an ascending order of a serving cell index with r = 1 corresponding to
    the cell with the smallest serving cell index, and M_{c}(r) is defined by the following:
    - 0, 1, 2, 3, 4, 5 or 6 bits. The bitwidth for this field is determined as ┌log₂(I)┐ bits, where
        I is the number of entries in the higher layer parameter ul-AccessConfigListDCI-0-1 or
        in Table 7.3.1.1.1-4A if channelAccessMode-r16 = “semiStatic” is provided, for
        operation in a cell with shared spectrum channel access in frequency range 1, or for
        operation in frequency range 2-2 if ChannelAccessMode 2-r17 is provided; otherwise 0
        bit. One or more entries from Table 7.3.1.1.2-35 or Table 7.3.1.1.2-35A are configured
        by the higher layer parameter ul-AccessConfigListDCI-0-1.
  $‐ Open ‐ loop power control parameter set inidcation - {max}_{r ∈ \{ 1 , 2 , … , {N}_{cell}^{UL , 2} \}} {M}_{o} ( r ) bits applying to$
    the scheduled cells with Mₒ(r) > 0 independently, where r is mapped to the cells
    according to an ascending order of a serving cell index with r = 1 corresponding to the
    cell with the smallest serving cell index, and Mₒ(r) is defined by the following:
    - 0 bit if the higher layer parameter p0-PUSCH-SetList is not configured;
    - 1 or 2 bits otherwise,
        - 1 bit if SRS resource indicator is present in the DCI format 0_3;
        - 1 or 2 bits as determined by higher layer parameter olpc-ParameterSetDCI-0-1 if
          SRS resource indicator is not present in the DCI format 0 3.
  - Priority indicator - 0 bit if higher layer parameter priorityIndicatorDCI-0-3 is not
    configured; otherwise 1 bit as defined in Clause 9 in [5, TS 38.213]. This field is applied
    to all the scheduled cells indicated by Scheduled cells indicator field or Frequency domain
    resource assignment field.
  - Minimum applicable scheduling offset indicator - 0 or 1 bit
    - 0 bit if higher layer parameter minimumSchedulingOffsetKODCI-0-3 is not configured;
    - x bits otherwise.
  - SCell dormancy indication - 0 bit if higher layer parameter dormancyDCI-0-3 is not
    enabled; otherwise x bits.
  - PDCCH monitoring adaptation indication - 0, 1 or 2 bits
    - 0 bit if higher layer parameter pdcchMonAdaptDCI-0-3 is not enabled;
    - otherwise,
          - 1 or 2 bits, if searchSpaceGroupIdList-r17 is not configured and if pdcch-
            SkippingDurationList is configured
            - 1 bit if the UE is configured with only one duration by pdcch-
                SkippingDurationList;
            - 2 bits if the UE is configured with more than one duration by pdcch-
                SkippingDurationList.
          - 1 or 2 bits, if pdcch-SkippingDurationList is not configured and if
            searchSpaceGroupIdList-r17 is configured
            - 1 bit if the UE is configured by searchSpaceGroupIdList-r17 with search space
                set(s) with group index 0 and search space set(s) with group index 1, and if the
                UE is not configured by searchSpaceGroupIdList-r17 with any search space set
                with group index 2;
            - 2 bits if the UE is configured by searchSpaceGroupIdList-r17 with search space
                set(s) with group index 0, search space set(s) with group index 1 and search space
                set(s) with group index 2;
          - 2 bits, if pdcch-SkippingDurationList is configured and if searchSpaceGroupIdList-
            r17 is configured
If ScheduledCellCombo-ListDCI-0-3 for the cell set is configured, zeros shall be appended to
DCI format 0_3 if needed until the payload size equals the size of DCI format 0_3 that is
determined by the configuration of the corresponding active bandwidth part(s) of the scheduled
cells in the entry which results in the largest size among the entries in the higher layer parameter
ScheduledCellCombo-ListDCI-0-3; otherwise, zeros shall be appended to DCI format 0_3 if
needed until the payload size equals the size of DCI format 0_3 that is determined by the
configuration of the corresponding active bandwidth part(s) of all the cells within the scheduled
cell set.
```

TABLE 18-2
7.3.1.2.4 Format 1_3

```
DCI format 1_3 is used for the scheduling of one PDSCH in one cell, or multiple PDSCHs in
multiple cells with one PDSCH per cell.
The following information is transmitted by means of the DCI format 1_3 with CRC scrambled
by C-RNTI or MCS-C-RNTI:
  - Identifier for DCI formats-1 bits
    - The value of this bit field is always set to 1, indicating a DL DCI format
  - Scheduled cell set indicator-┌log₂ Nₛₑₜ┐ bits, where Nₛₑₜ is the number of cell sets which
    are configured by higher layer parameter MC-DCI-SetofCellsToAddModList to be
    respectively scheduled by DCI format 0_3/1_3 from the cell on which this format is
    carried by PDCCH. If present, this field is used to indicate the scheduled cell set according
    to Table 7.3.1.1.4-1; otherwise, the scheduled cell set is the cell set configured to be
    scheduled by DCI format 0_3/1_3 from the cell by higher layer parameter MC-DCI-
    SetofCellsToAddModList.
  - Scheduled cells indicator-number of bits determined by the following:
    - 0 bit if the higher layer parameter ScheduledCellCombo-ListDCI-1-3 for the scheduled
      cell set is not configured;
    - otherwise ┌log₂ I_{DL}┐ bits indicating the scheduled cells in the scheduled cell set
      according to Table 7.3.1.2.4-1, where I_{DL} is the number of entries in the higher layer
      parameter ScheduledCellCombo-ListDCI-1-3. If only one entry is configured in the
      higher layer parameter ScheduledCellCombo-ListDCI-1-3, the scheduled cells are the
      cells configured by higher layer parameter ScheduledCellCombo-ListDCI-1-3.
  - Bandwidth part indicator-0, 1 or 2 bits determined as ┌log2 nBwp,max┐, where
    - n_{BWP, max} = n_{BWP, RRC}^{max} + 1 if n^{max} ≤ 3, N_{BWPRRC}^{max} is the maximum number of DL
      BWPs configured by higher layers across all the cells configured by higher layer
      parameter ScheduledCell-ListDCI-1-3 in the scheduled cell set, in which case the
      bandwidth part indicator is equivalent to the ascending order of the higher layer
      parameter BWP-Id;
    - otherwise n_{BWP,max} = N_{BWP,RRC}^{max}, in which case the bandwidth part indicator is defined
      in Table 7.3.1.1.2-1;
    The field is only applicable to a scheduled cell with the number of configured DL BWPs
    larger than 1, including the initial DL bandwidth part, and is applied to the applicable
    scheduled cells in the scheduled cell set independently. If a UE does not support active
    BWP change via DCI, the UE ignores this bit field.
  - Frequency domain resource assignment-number of bits determined by the following:
    - block number 1, block number 2, . . . , block number N_{cell}^{DL}
    If ScheduledCellCombo-ListDCI-1-3 for the scheduled cell set is configured with more
    than one entry, N_{cell}^{DL} is the number of scheduled cells indicated by Scheduled cells
    indicator field; if ScheduledCellCombo-ListDCI-1-3 for the scheduled cell set is
    configured with only one entry, N_{cell}^{DL} is the number of cells configured by higher layer
    parameter ScheduledCellCombo-ListDCI-1-3; otherwise, N_{cell}^{DL} is the number of cells in
    the scheduled cell set configured by higher layer parameter ScheduledCell-ListDCI-1-3.
    Each block corresponds to the frequency domain resource assignment for a cell, and the
    blocks are placed according to an ascending order of a serving cell index, with block
    number 1 corresponding to the frequency domain resource assignment for the cell with
    the smallest serving cell index. Each block is defined by the following fields:
    - N_{RBG} bits if only resource allocation type 0 is configured, where N_{RBG} is defined in
      Clause 5.1.2.2.1 of [6, TS 38.214]
    - ┌log₂(N_{RBG,K2}(N_{RBG,K2} + 1)/2)┐ bits if only resource allocation type 1 is configured,
      or max( ┌log₂(N_{RBG,K2}(N_{RBG,K2} + 1)/2)┐, N_{RBG}) + 1 bits if resource AllocationDCI-
      1-3 is configured as 'dynamicSwitch', where N_{RBG,K2} ┌(N_{RB}^{DL,DWP} +
      (N_{DL,DWP}mod K2))/K2┐, N_{RG}^{DL,DWP} is the size of the active DL bandwidth part,
      N_{DL,BWP} is defined as in clause 4.4.4.4 of [4, TS 38.211] and K2 is given by higher
      layer parameter resourceAllocationType 1GranularityDCI-1-3. If the higher layer
      parameter resource AllocationType 1GranularityDCI-1-3 is not configured, K2 is equal
      to 1.
    - If resource AllocationDCI-1-3 is configured as 'dynamicSwitch', the MSB bit is used to
      indicate resource allocation type 0 or resource allocation type 1, where the bit value of
      0 indicates resource allocation type 0 and the bit value of 1 indicates resource allocation
      type 1.
    - For resource allocation type 0, the NRBG LSBs provide the resource allocation as
      defined in Clause 5.1.2.2.1 of [6, TS 38.214].
    - For resource allocation type 1, the ┌log₂(N_{RBG,K2}(N_{RBG,K2} + 1)/2)┐ LSBs provide the
      resource allocation as defined in Clause 5.1.2.2.2 of [6, TS 38.214].
    If ″Bandwidth part indicator″ field indicates a bandwidth part other than the active
    bandwidth part and if resourceAllocationDCI-1-3 is configured as ′dynamicSwitch′ for the
    indicated bandwidth part, the UE assumes resource allocation type 0 for the indicated
    bandwidth part if the bitwidth of the ″Frequency domain resource assignment″ field of the
    active bandwidth part is smaller than the bitwidth of the ″Frequency domain resource
    assignment″ field of the indicated bandwidth part.
    If the higher layer parameter ScheduledCellCombo-ListDCI-1-3 for the scheduled cell set
    is not configured, each block is also used to indicate whether the corresponding cell is
    scheduled or not as follows:
    - if all bits of a block are set to 0 for resource allocation type 0 or set to 1 for resource
      allocation type 1 or set to 0 or 1 for dynamic switch resource allocation type, the cell
      corresponding to the block is not scheduled;
    - otherwise, the cell corresponding to the block is scheduled.
  - Time domain resource assignment -┌log₂(I)┐ bits, where I is the number of entries in the
    higher layer parameter TDRA-FieldIndexListDCI-1-3. This field is used to indicate an
    entry in the higher layer parameter TDRA-FieldIndexListDCI-1-3 according to Table
    7.3.1.2.4-2. Each entry in the higher layer parameter TDRA-FieldIndexListDCI-1-3
    contains the ‘Time domain resource assignment’ index for each cell in the scheduled cell
    set, where the ‘Time domain resource assignment’ indexes for all the cells are placed
    according to an ascending order of a serving cell index.
  - VRB-to-PRB mapping-0 or 1 bit
    - 0 bit if the higher layer parameter vrb-ToPRB-Interleaver is not configured for any cell
      configured by higher layer parameter ScheduledCell-ListDCI-1-3 in the scheduled cell
      set;
    - 1 bit according to Table 7.3.1.2.2-5 otherwise, only applicable to resource allocation
      type 1, as defined in Clause 7.3.1.6 of [4, TS 38.211].
    The field is only applicable to a scheduled cell configured with vrb-ToPRB-Interleaver,
    and is applied to the applicable scheduled cells independently.
  - PRB bundling size indicator-0 or 1 bit
    - 0 bit if the higher layer parameter prb-BundlingType is not configured or is set to
      ′staticBundling′ for any cell configured by higher layer parameter ScheduledCell-
      ListDCI-1-3 in the scheduled cell set;
    - 1 bit according to Clause 5.1.2.3 of [6, TS 38.214] otherwise.
      The field is only applicable to a scheduled cell configured with prb-BundlingType set to
      ′dynamicBundling′, and is applied to the applicable scheduled cells independently.
  - Rate matching indicator - ┌log₂(I_{RM})┐ bits, where I_{RM} is the number of entries in the
      higher layer parameter rateMatchListDCI-1-3. This field is used to indicate an entry in the
      higher layer parameter rateMatchListDCI-1-3 according to Table 7.3.1.2.4-3. Each entry
      in the higher layer parameter rateMatchListDCI-1-3 contains the ‘Rate matching
      indicator’ index for each cell in the scheduled cell set, where the ‘Rate matching indicator’
      indexes for all the cells are placed according to an ascending order of a serving cell index.
      Each ‘Rate matching indicator’ index is defined by the following:
      - 0, 1, or 2 bits according to higher layer parameters rateMatchPatternGroupl and
        rateMatchPatternGroup2, where the MSB is used to indicate rateMatchPatternGroup1
        and the LSB is used to indicate rateMatchPatternGroup2 when there are two groups.
  - ZP CSI-RS trigger - ┌log₂(I_{CSIRS})┐ bits, where ICSIRS is the number of entries in the higher
    layer parameter zp-CSI-RSListDCI-1-3. This field is used to indicate an entry in the higher
    layer parameter zp-CSI-RSListDCI-1-3 according to Table 7.3.1.2.4-4. Each entry in the
    higher layer parameter zp-CSI-RSListDCI-1-3 contains the ‘ZP CSI-RS trigger’index for
    each cell in the scheduled cell set, where the ‘ZP CSI-RS trigger’ indexes for all the cells
    are placed according to an ascending order of a serving cell index. Each ‘ZP CSI-RS
    trigger’ index is defined by the following:
    - 0, 1, or 2 bits as defined in Clause 5.1.4.2 of [6, TS 38.214]. The bitwidth for this field
      is determined as ┌log₂(n_{ZP} + 1)┐ bits, where n_{ZP} is the number of aperiodic ZP CSI-
      RS resource sets configured by higher layer parameter aperiodicZP-CSI-RS-
      Resource Sets ToAddModList.
  For transport block 1:
    - Modulation and coding scheme-number of bits determined by the following:
      - block number 1, block number 2, . . . , block number N_{cell}^{DL}
      Each block corresponds to the modulation and coding scheme for a scheduled cell, and
      the blocks are placed according to an ascending order of a serving cell index, with block
      number 1 corresponding to the modulation and coding scheme for the cell with the
      smallest serving cell index. Each block is 5 bits as defined in Clause 6.1.4.1 of [6, TS
      38.214].
    - New data indicator-number of bits determined by the following:
      - block number 1, block number 2, . . . , block number N_{cell}^{DL}
      Each block corresponds to the new data indicator for a scheduled cell, and the blocks
      are placed according to an ascending order of a serving cell index, with block number
      1 corresponding to the new data indicator for the cell with the smallest serving cell
      index. Each block is 1 bit.
    - Redundancy version-number of bits determined by the following:
      - block number 1, block number 2, . . . , block number N_{cell}^{DL}
      Each block corresponds to the redundancy version for a scheduled cell, and the blocks
      are placed according to an ascending order of a serving cell index, with block number
      1 corresponding to the redundancy version for the cell with the smallest serving cell
      index. Each block is 0, 1 or 2 bits determined by higher layer parameter
      numberOfBitsForRV-DCI-1-3 configured for the cell correponding to the block,
      - If 0 bit is configured, rv_{id} to be applied is 0;
      - 1 bit according to Table 7.3.1.2.3-1;
      - 2 bits according to Table 7.3.1.1.1-2.
  For transport block 2:
    - Modulation and coding scheme-number of bits determined by the following:
      - block number 1, block number 2, . . . , block number N_{cell}^{DL,3}
      If ScheduledCellCombo-ListDCI-1-3 for the scheduled cell set is configured, N_{cell}^{DL,3} is
      the number of scheduled cells indicated by Scheduled cells indicator field and
      configured with maxNrofCodeWordsScheduledByDCI = 2; otherwise, N_{cell}^{DL,3} is the
      number of cells configured by higher layer parameter ScheduledCell-ListDCI-1-3 in
      the scheduled cell set and configured with maxNrofCode WordsScheduledByDCI = 2.
      Each block corresponds to the modulation and coding scheme for a scheduled cell, and
      the blocks are placed according to an ascending order of a serving cell index, with block
      number 1 corresponding to the modulation and coding scheme for the cell with the
      smallest serving cell index. Each block is 5 bits as defined in Clause 6.1.4.1 of [6, TS
      38.214].
    - New data indicator-number of bits determined by the following:
      - block number 1, block number 2, . . . , block number N_{cell}^{DL,3}
      Each block corresponds to the new data indicator for a scheduled cell, and the blocks
      are placed according to an ascending order of a serving cell index, with block number
      1 corresponding to the new data indicator for the cell with the smallest serving cell
      index. Each block is 1 bit.
    - Redundancy version-number of bits determined by the following:
      - block number 1, block number 2, . . . , block number N_{cell}^{DL,3}
      Each block corresponds to the redundancy version for a scheduled cell, and the blocks
      are placed according to an ascending order of a serving cell index, with block number
      1 corresponding to the redundancy version for the cell with the smallest serving cell
      index. Each block is 0, 1 or 2 bits determined by higher layer parameter
      numberOfBitsForRV-DCI-1-3 configured for the cell correponding to the block,
      - If 0 bit is configured, rv_{id} to be applied is 0;
      - 1 bit according to Table 7.3.1.2.3-1;
      - 2 bits according to Table 7.3.1.1.1-2.
    If ″Bandwidth part indicator″ field indicates a bandwidth part other than the active
    bandwidth part and the value of maxNrofCode WordsScheduledByDCI for the indicated
    bandwidth part equals 2 and the value of maxNrofCodeWordsScheduledByDCI for the
    active bandwidth part equals 1, the UE assumes zeros are padded when interpreting the
    ″Modulation and coding scheme″, ″New data indicator″, and ″Redundancy version″ fields
    of transport block 2 according to Clause 12 of [5, TS38.213], and the UE ignores the
    ″Modulation and coding scheme″, ″New data indicator″, and ″Redundancy version″ fields
    of transport block 2 for the indicated bandwidth part.
  - HARQ process number-number of bits determined by the following:
    - block number 1, block number 2, . . . , block number N_{cell}^{DL}
      Each block corresponds to the HARQ process number for a scheduled cell, and the blocks
      are placed according to an ascending order of a serving cell index, with block number 1
      corresponding to the HARQ process number for the cell with the smallest serving cell
      index. Each block is 0, 1, 2, 3, 4 or 5 bits determined by higher layer parameter harq-
      ProcessNumberSizeDCI-1-3 configured for the cell correponding to the block.
  - Downlink assignment index-number of bits as defined in the following
    - 4 bits if the higher layer parameter pdsch-HARQ-ACK-Codebook=dynamic, where the
      2 MSB bits are the counter DAI and the 2 LSB bits are the total DAI;
    - 0 bits otherwise.
    If the UE is configured with a PUCCH-SCell, pdsch-HARQ-ACK-Codebook is replaced
    by pdsch-HARQ-ACK-Codebook-secondaryPUCCHgroup-r16 if present for the
    secondary PUCCH group.
    If higher layer parameter priorityIndicatorDCI-1-3 is configured, if the bit width of the
    Downlink assignment index in DCI format 1_3 for one HARQ-ACK codebook is not
    equal to that of the Downlink assignment index in DCI format 1_3 for the other HARQ-
    ACK codebook, a number of most significant bits with value set to ′0′ are inserted to
    smaller Downlink assignment index until the bit width of the Downlink assignment index
    in DCI format 1 3 for the two HARQ-ACK codebooks are the same.
  - TPC command for scheduled PUCCH-2 bits as defined in Clause 7.2.1 of [5, TS 38.213]
  - PUCCH resource indicator-3 bits as defined in Clause 9.2.3 of [5, TS 38.213]
  - PDSCH-to-HARQ_feedback timing indicator-0, 1, 2, or 3 bits as defined in Clause 9.2.3
    of [5, TS 38.213]. The bitwidth for this field is determined as ┌log₂(I)┐ bits, where I is the
    number of entries in the higher layer parameter dL-DataToUL-ACK.
    If higher layer parameter priorityIndicatorDCI-1-3 is configured, if the bit width of the
    PDSCH-to-HARQ feedback timing indicator in DCI format 1_3 for one HARQ-ACK
    codebook is not equal to that of the PDSCH-to-HARQ_feedback timing indicator in DCI
    format 1 3 for the other HARQ-ACK codebook on the same cell for PUCCH
    transmission, a number of most significant bits with value set to ′0′ are inserted to smaller
    PDSCH-to-HARQ_feedback timing indicator until the bit width of the PDSCH-to-
    HARQ_feedback timing indicator in DCI format 1_3 for the two HARQ-ACK codebooks
    are the same.
    If higher layer parameter pucch-sSCellDynDCI-1-3 is configured, if the bit width of the
    PDSCH-to-HARQ_feedback timing indicator in DCI format 1_3 associated with one cell
    for PUCCH transmission is not equal to that of the PDSCH-to-HARQ_feedback timing
    indicator in DCI format 1_3 associated with the other cell for PUCCH transmission, a
    number of most significant bits with value set to ′0′ are inserted to smaller PDSCH-to-
    HARQ_feedback timing indicator until the bit width of the PDSCH-to-HARQ feedback
    timing indicator in DCI format 1_3 associated with the two cells are the same.
  - One-shot HARQ-ACK request-0 or 1 bit.
    - 1 bit if higher layer parameter pdsch-HARQ-ACK-OneShotFeedbackDCI-1-3 or pdsch-
      HARQ-ACK-enhType 3DCI-1-3 is configured;
    - 0 bit otherwise.
  - Enhanced Type 3 codebook indicator-0, 1, 2, or 3 bits.
    - 0 bit if pdsch-HARQ-ACK-enhType3DCIfieldDCI-1-3 is not configured;
    - ┌log₂(n_{CB})┐ bits otherwise, where ncp is the number of entries in the higher layer
      parameter pdsch-HARQ-ACK-EnhType3ToAddModList.
    If the UE is configured with a PUCCH-SCell, pdsch-HARQ-ACK-
    EnhType3ToAddModList is replaced by pdsch-HARQ-ACK-EnhType3SecondaryList for
    the secondary PUCCH group.
  - HARQ-ACK retransmission indicator-0 or 1 bit.
    - 1 bit if higher layer parameter pdsch-HARQ-ACK-retxDCI-1-3 is configured.
    - 0 bit otherwise.
  - Antenna ports-number of bits determined by the following:
    - If AntennaPortsDCI-1-3 = type la is configured by higher layer,
      - ${max}_{r ∈ \{ 1 , 2 , … , {N}_{cell}^{DL , 2} \}} {M}_{A} ( r ) bits applying to the scheduled cells indepently , where {N}_{cell}^{DL , 2}$
        is the number of cells configured by higher layer parameter ScheduledCell-ListDCI-
        1-3 in the scheduled cell set, r is mapped to the cells according to an ascending
        order of a serving cell index with r = 1 corresponding to the cell with the smallest
        serving cell index, and MA(r) is defined below.
  - If AntennaPortsDCI-1-3 = type2 is configured by higher layer,
      - block number 1, block number 2, . . . , block number N_{cell}^{DL}
      Each block corresponds to the Antenna ports information for a scheduled cell, and the
      blocks are placed according to an ascending order of a serving cell index, with block
      number 1 corresponding to the Antenna ports information for the cell with the smallest
      serving cell index. Each block is defined below.
  M_{A}(r) above for the case of AntennaPortsDCI-1-3 = type 1A or each block above for the
  case of AntennaPortsDCI-1-3 = type 2 is defined by the following:
      - 4, 5, or 6 bits as defined by Tables 7.3.1.2.2-1/2/3/4 and Tables 7.3.1.2.2-
        1A/2A/3A/4A, where the number of CDM groups without data of values 1, 2, and 3
        refers to CDM groups {0}, {0,1}, and {0, 1, 2} respectively. The antenna ports
        {p₀, . . . , Pᵥ₋₁} shall be determined according to the ordering of DMRS port(s) given
        by Tables 7.3.1.2.2-1/2/3/4 or Tables 7.3.1.2.2-1A/2A/3A/4A.
      If a UE is configured with both dmrs-DownlinkForPDSCH-MappingTypeA and dmrs-
      DownlinkForPDSCH-MappingTypeB, the bitwidth of this field equals max{x_{A}, x_{B}},
      where x_{A} is the ″Antenna ports″ bitwidth derived according to dmrs-
      DownlinkForPDSCH-MappingTypeA and x_{B} is the ″Antenna ports″ bitwidth derived
      according to dmrs-DownlinkForPDSCH-MappingTypeB. A number of |x_{A} − x_{B}| zeros
      are padded in the MSB of this field, if the mapping type of the PDSCH corresponds to
      the smaller value of x_{A} and x_{B}.
  - Transmission configuration indication-number of bits determined by the following:
    - 0 bit if higher layer parameter tci-PresentInDCI is not enabled;
    - otherwise ┌log₂(I_{TCI})┐ bits, where I_{TCI} is the number of entries in the higher layer
      parameter tci-ListDCI-1-3. This field is used to indicate an entry in the higher layer
      parameter tci-ListDCI-1-3 according to Table 7.3.1.2.4-5. Each entry in the higher layer
      parameter tci-ListDCI-1-3 contains the ‘Transmission configuration indication’ index
      for each cell in the scheduled cell set, where the ‘Transmission configuration indication’
      indexes for all the cells are placed according to an ascending order of a serving cell
      index. Each ‘Transmission configuration indication’ index is 3 bits as defined in Clause
      5.1.5 of [6, TS38.214].
    If ″Bandwidth part indicator″ field indicates a bandwidth part other than the active
    bandwidth part,
    - if the higher layer parameter tci-PresentInDCI is not enabled for the CORESET used
      for the PDCCH carrying the DCI format 1_3,
      - the UE assumes tci-PresentInDCI is not enabled for all CORESETs in the indicated
        bandwidth part;
    - otherwise,
      - the UE assumes tci-PresentInDCI is enabled for all CORESETs in the indicated
        bandwidth part.
  - SRS request-┌log₂(I_{SRS})┐ bits, where I_{SRS} is the number of entries in the higher layer
    parameter srs-RequestListDCI-1-3. This field is used to indicate an entry in the higher
    layer parameter srs-RequestListDCI-1-3 according to Table 7.3.1.2.4-6. Each entry in the
    higher layer parameter srs-RequestListDCI-1-3 contains the ‘SRS request’ index for each
    cell in the scheduled cell set, where the ‘SRS request’ indexes for all the cells are placed
    according to an ascending order of a serving cell index. Each ‘SRS request’ index is
    defined by the following:
    - 2 bits as defined by Table 7.3.1.1.2-24 for UEs not configured with
      supplementaryUplink in ServingCellConfig in the cell; 3 bits for UEs configured with
      supplementaryUplink in ServingCellConfig in the cell where the first bit is the non-
      SUL/SUL indicator as defined in Table 7.3.1.1.1-1 and the second and third bits are
      defined by Table 7.3.1.1.2-24. This bit field may also indicate the associated CSI-RS
      according to Clause 6.1.1.2 of [6, TS 38.214].
  - SRS offset indicator -┌log₂(I_{offset})┐bits, whereI_{offset} is the number of entries in the
    higher layer parameter srs-OffsetListDCI-1-3. This field is used to indicate an entry in the
    higher layer parameter srs-OffsetListDCI-1-3 according to Table 7.3.1.2.4-7. Each entry
    in the higher layer parameter srs-OffsetListDCI-1-3 contains the ‘SRS offset indicator’
    index for each cell in the scheduled cell set, where the ‘SRS offset indicator’ indexes for
    all the cells are placed according to an ascending order of a serving cell index. Each ‘SRS
    offset indicator’ index is defined by the following:
    - 0 bit if higher layer parameter AvailableSlotOffset is not configured for any aperiodic
      SRS resource set in the scheduled cell, or if higher layer parameter AvailableSlotOffset
      is configured for at least one aperiodic SRS resource set in the scheduled cell and the
      maximum number of entries of available SlotOffsetList configured for all aperiodic SRS
      resource set(s) is 1;
    - otherwise, ┌log₂(K)┐ bits are used to indicate available slot offset according to Table
      7.3.1.1.2-37 and Clause 6.2.1 of [6, TS 38.214], where K is the maximum number of
      entries of available SlotOffsetList configured for all aperiodic SRS resource set(s) in the
      scheduled cell;
  - DMRS sequence initialization-1 bit. This field is applied to all the scheduled cells
    indicated by Scheduled cells indicator field or Frequency domain resource assignment
    field independently.
  - Priority indicator-0 bit if higher layer parameter priorityIndicatorDCI-1-3 is not
    configured; otherwise 1 bit as defined in Clause 9 in ┌5, TS 38.213┐.
  - ChannelAccess-CPext-0, 1, 2, 3 or 4 bits. The bitwidth for this field is determined as
    ┌log₂(I)┐ bits, where I is the number of entries in the higher layer parameter ul-
    AccessConfigListDCI-1-1 or in Table 7.3.1.1.1-4A if channelAccessMode-r16 =
    ″semiStatic″ is provided, for operation in a cell with shared spectrum channel access in
    frequency range 1, or for operation in frequency range 2-2 if ChannelAccessMode 2-r17 is
    provided; otherwise 0 bit. One or more entries from Table 7.3.1.2.2-6 or Table 7.3.1.2.2-
    6A are configured by the higher layer parameter ul-AccessConfigListDCI-1-1.
  - Minimum applicable scheduling offset indicator-0 or 1 bit
    - 0 bit if higher layer parameter minimumSchedulingOffsetKODCI-1-3 is not configured;
    - x bits otherwise.
  - SCell dormancy indication-0 bit if higher layer parameter SCell-dormancy-indication-
    Present is not enabled; otherwise x bits.
  - PDCCH monitoring adaptation indication-0, 1 or 2 bits
    - 0 bit if higher layer parameter pdcchMonAdaptDCI-1-3 is not enabled;
    - otherwise,
      - 1 or 2 bits, if searchSpaceGroupIdList-r17 is not configured and if pdcch-
        SkippingDurationList is configured
        - 1 bit if the UE is configured with only one duration by pdcch-
          SkippingDurationList;
        - 2 bits if the UE is configured with more than one duration by pdcch-
          SkippingDurationList.
      - 1 or 2 bits, if pdcch-SkippingDurationList is not configured and if
        searchSpaceGroupIdList-r17 is configured
        - 1 bit if the UE is configured by searchSpaceGroupIdList-r17 with search space
          set(s) with group index 0 and search space set(s) with group index 1, and if the
          UE is not configured by searchSpaceGroupIdList-r17 with any search space set
          with group index 2;
        - 2 bits if the UE is configured by searchSpaceGroupIdList-r17 with search space
        set(s) with group index 0, search space set(s) with group index 1 and search space
        set(s) with group index 2;
      - 2 bits, if pdcch-SkippingDurationList is configured and if searchSpaceGroupIdList-
      r17 is configured
  - PUCCH Cell indicator-0 or 1 bit.
    - 1 bit if higher layer parameter pucch-sSCellDynDCI-1-3 is configured.
    - 0 bit otherwise.
If ScheduledCellCombo-ListDCI-1-3 for the cell set is configured, zeros shall be appended to
DCI format 1_3 if needed until the payload size equals the size of DCI format 1_3 that is
determined by the configuration of the corresponding active bandwidth part(s) of the scheduled
cells in the entry which results in the largest size among the entries in the higher layer parameter
ScheduledCellCombo-ListDCI-1-3; otherwise, zeros shall be appended to DCI format 1_3 if
needed until the payload size equals the size of DCI format 1_3 that is determined by the
configuration of the corresponding active bandwidth part(s) of all the cells within the scheduled
cell set.
```

### [Regarding BWP Switching]

The UE may receive a DCI format including a bandwidth part indicator field. The UE may receive the DCI format in a PDCCH monitoring occasion of the currently activated BWP. The bandwidth part indicator field may indicate a BWP to be activated in the future. Therefore, after the UE receives the DCI format, the BWP indicated by the bandwidth part indicator field may be activated. For example, after receiving the DCI format, the UE may receive a PDSCH or transmit a PUSCH in the BWP indicated by the bandwidth part indicator field. In the following embodiments of the disclosure, an indicted BWP may refer to a BWP indicated by the bandwidth part indicator field.

In an embodiment, each BWP may be endowed with a unique index. The bandwidth part indicator field may indicate the unique index.

In the following embodiments of the disclosure, in case that the currently activated BWP and the indicated BWP are different, the DCI format may be referred to as DCI which has indicated BWP switching. In addition, the process in which the currently activated BWP is switched to the indicated BWP may be referred to as BWP switching (or BWP change).

In an embodiment, in the case of MC-DCI, the bandwidth part indicator field may indicate one value with regard to multiple cells. For example, in case that the bandwidth part indicator field indicates “1”, the BWP indicated to each of the multiple cells may correspond to “1”. Therefore, in the case of MC-DCI, BWP switching may be indicated simultaneously with regard to multiple cells.

Upon receiving DCI which has indicated BWP switching, the UE may interpret information of the received DCI according to information of the indicated BWP. The process may be as follows. Obviously, the following example is not limitative.
The UE may determine the length of each DCI field and the DCI length, based on information configured in the currently activated BWP. Based on the DCI length, the UE may blind-decode the PDCCH in a PDCCH monitoring occasion of the currently activated BWP. The acquired DCI field may be referred to as a received DCI field.
The UE may determine the length of a required DCI field, based on information configured in the indicated BWP. The determined length may be referred to as a required DCI field length. The length of the received DCI field may be irrelevant to the indicated BWP. For example, the length of the received DCI field may be different from the length of the required DCI field in the indicated BWP.
In case that the length of the received DCI field is larger than the length of the required DCI field, the most significant bit (MSB) of the received DCI field may be removed to conform to the length of the required DCI field. For example, in case that the length of the required DCI field corresponds to 10 bits (for example, [b0,b1,b2,b3,b4,b5,b6,b7,b8,b9]), and in case that the length of the required DCI field corresponds to 6 bits, MSB 4 bits may be excluded, and the UE may then interpret the DCI field by using the remaining 6 bits [b4,b5,b6,b7,b8,b9]. The above-described process may be referred to as truncation.
In case that the length of the received DCI field is smaller than the length of the required DCI field, “0” may be added to the most significant bit (MSB) of the received DCI field to conform to the length of the required DCI field. For example, in case that the length of the received DCI field corresponds to 10 bits (for example, [b0,b1,b2,b3,b4,b5,b6,b7,b8,b9]), and in case that the length of the required DCI field corresponds to 2 bits, 2 bits “00” may be added to the MSB, and the UE may thus interpret the DCI field by using 12 bits [0,0,b0,b1,b2,b3,b4,b5,b6,b7,b8,b9].

The above-described process may be referred to as DCI field length adjustment.

Hereinafter, a method for adjusting the DCI field length in connection with MC-DCI may be described. More specifically, the DCI field in connection with MC-DCI may be the second type of DCI field. For example, each DCI field may include multiple blocks. Each block may correspond to each scheduled cell.

In the disclosure, DCI field length adjustment may be performed by using the following two methods:
In the first method, the UE may apply the above-described DCI field length adjustment with regard to each block. The first method may be referred to as block level length adjustment or “per block” length adjustment. More specifically,
The UE may determine the length of each DCI field and the DCI length, based on information configured in the currently activated BWP. Based on the DCI length, the UE may blind-decode the PDCCH in a PDCCH monitoring occasion of the currently activated BWP. The acquired DCI field may be referred to as a received DCI field. The received DCI field may include multiple blocks. The length of each of the multiple blocks included in the DCI field may be determined.
The UE may determine the length of a required DCI field, based on information configured in the indicated BWP. The determined length may be referred to as a required DCI field length. The length of the received DCI field may be irrelevant to the indicated BWP. For example, the length of the received DCI field may be different from the length of the required DCI field in the indicated BWP. The required DCI field may include multiple blocks. In addition, the length of each of the multiple blocks included in the required DCI field may be determined.
In case that the length of the received DCI field is larger than the block length of the required DCI field, the most significant bit (MSB) of the received DCI field may be removed to conform to the block length of the required DCI field. If the received DCI field includes multiple blocks, the length may be adjusted with regard to each block.
In case that the length of the received DCI field is smaller than the block length of the required DCI field, “0” may be added to the most significant bit (MSB) of the received DCI field to conform to the block length of the required DCI field.

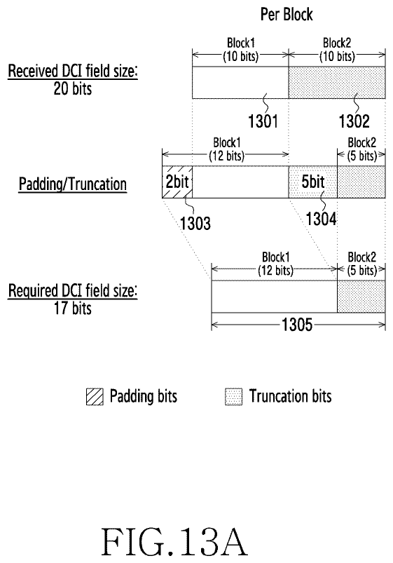

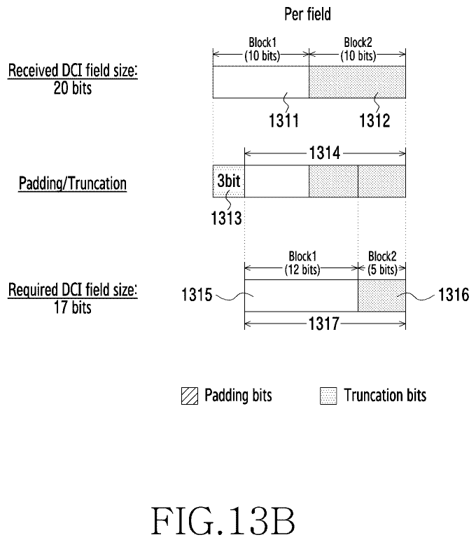

FIG. 13A and FIG. 13B illustrate an example in which a UE according to an embodiment of the disclosure performs DCI field length adjustment according to an indicated bandwidth in case that bandwidth switching is indicated thereto.

FIG. 13A illustrates an example of a DCI field length adjustment method. Referring to FIG. 13A, the received DCI field may include two blocks, and each block may be assumed to correspond to 10 bits. For example, the length of the received DCI field may correspond to 20 bits. It may be assumed that the received DCI field is [b0,b1,b2,b3,b4,b5,b6,b7,b8,b9,b10,b11,b12,b13,b14,b15,b16,b17,b18,b19]. Preceding 10 bits 1301 may correspond to the first block, and following 10 bits 1302 may correspond to the second block. The length of the first block included in the required DCI field may correspond to 12 bits, and in case that the length of the second block corresponds to 5 bits, the required DCI field may be a total of 17 bits.
The UE may adjust the length of the first block. The length of the first block of the received DCI field corresponds to 10 bits, the length of the first block of the required DCI field corresponds to 12 bits, and 2 bits “0,0” may thus be added to the MSB of the first block of the received DCI field (1303). Therefore, the first block of the required DCI field may be [0,0,b0,b1,b2,b3,b4,b5,b6,b7,b8,b9]. The UE may adjust the length of the second block. The length of the second block of the received DCI field corresponds to 10 bits, the length of the second block of the required DCI field corresponds to 5 bits, and 5 bits may thus be removed from the MSB of the second block of the received DCI field (1304). Therefore, the second block of the required DCI field may be [b15,b16,b17,b18,b19]. After the block level length adjustment, the UE may obtain a DCI field 1305, the length of which corresponds to a total of 17 bits.

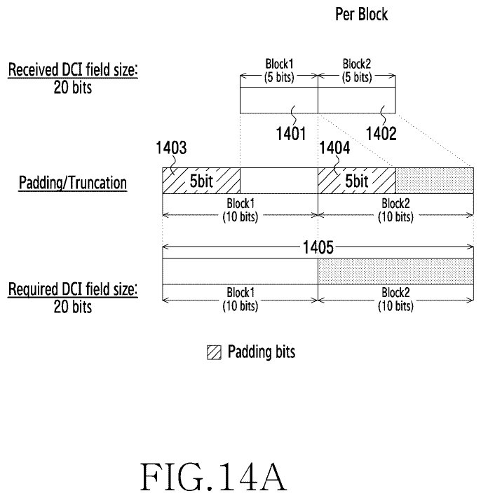

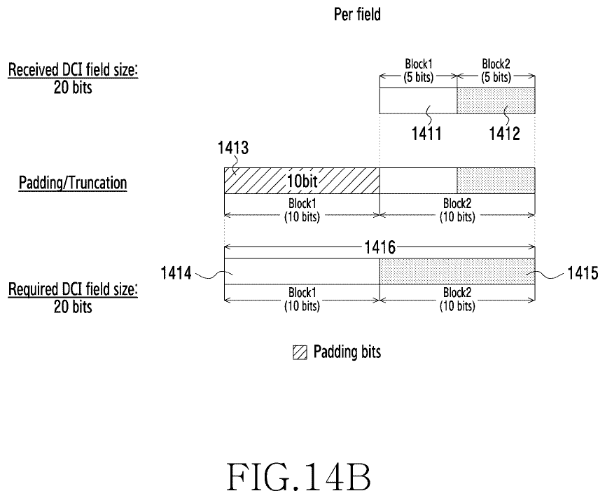

FIG. 14A and FIG. 14B illustrate an example in which a UE according to an embodiment of the disclosure performs DCI field length adjustment according to an indicated bandwidth in case that bandwidth switching is indicated thereto.

FIG. 14A illustrates an example. Referring to FIG. 14A, the received DCI field may include two blocks, and each block may be assumed to correspond to 5 bits. For example, the length of the received DCI field may correspond to 10 bits. It may be assumed that the received DCI field is [b0,b1,b2,b3,b4,b5,b6,b7,b8,b9]. Preceding 5 bits 1401 may correspond to the first block, and following 5 bits 1402 may correspond to the second block. The length of the first block included in the required DCI field may correspond to 10 bits, and in case that the length of the second block corresponds to 10 bits, the required DCI field may be a total of 20 bits.
The UE may adjust the length of the first block. The length of the first block of the received DCI field corresponds to 5 bits, the length of the first block of the required DCI field corresponds to 10 bits, and 5 bits “0,0,0,0,0” may thus be added (1403) to the MSB of the first block of the received DCI field. Therefore, the first block of the required DCI field may be [0,0,0,0,0,b0,b1,b2,b3,b4]. The UE may adjust the length of the second block. The length of the second block of the received DCI field corresponds to 5 bits, the length of the second block of the required DCI field corresponds to 10 bits, and 5 bits “0,0,0,0,0” may thus be added (1404) to the MSB of the second block of the received DCI field. Therefore, the second block of the required DCI field may be [0,0,0,0,0,b5,b6,b7,b8,b9]. After the block level length adjustment, the UE may obtain a DCI field 1405, the length of which corresponds to a total of 20 bits.

In the second method, the UE may use the above-described DCI field length adjustment. The second method may be referred to as DCI field level length adjustment or “per field” length adjustment. To be more specific,
The UE may determine the length of each DCI field and the DCI length, based on information configured in the currently activated BWP. Based on the DCI length, the UE may blind-decode the PDCCH in a PDCCH monitoring occasion of the currently activated BWP. The acquired DCI field may be referred to as a received DCI field. The received DCI field may include multiple blocks. The length of each of the multiple blocks included in the received DCI field may be determined.
The UE may determine the length of a required DCI field, based on information configured in the indicated BWP. The determined length may be referred to as a required DCI field length. The length of the received DCI field may be irrelevant to the indicated BWP. For example, the length of the received DCI field may be different from the length of the required DCI field in the indicated BWP. The required DCI field may include multiple blocks. The length of each of the multiple blocks included in the required DCI field may be determined.
In case that the length of the received DCI field is larger than the length of the required DCI field, the most significant bit (MSB) of the received DCI field may be removed to conform to the length of the required DCI field. The length of each block included in the received DCI field and the length of each block included in the required DCI field may not be considered.

FIG. 13B illustrates an example. Referring to FIG. 13B, the received DCI field may include two blocks, and each block may be assumed to correspond to 10 bits. For example, the length of the received DCI field may correspond to 20 bits. It may be assumed that the received DCI field is [b0,b1,b2,b3,b4,b5,b6,b7,b8,b9,b10,b11,b12,b13,b14,b15,b16,b17,b18,b19]. Preceding 10 bits 1311 may correspond to the first block, and following 10 bits 1312 may correspond to the second block. Assuming that the length of the first block included in the required DCI field corresponds to 12 bits, and that the length of the second block corresponds to 5 bits, the required DCI field may be a total of 17 bits. Therefore, the UE may remove MBS 3 bits of the received DCI field (1313), thereby acquiring 17 bits [b3,b4,b5,b6,b7,b8,b9,b10,b11,b12,b13,b14,b15,b16,b17,b18,b19](1314). In addition, the UE may use 12 bits [b3,b4,b5,b6,b7,b8,b9,b10,b11,b12,b13,b14] for first block interpretation (1315), and may use 5 bits [b15,b16,b17,b18,b19] for second block interpretation (1316). After the field level length adjustment, the UE may acquire a DCI field, the length of which corresponds to a total of 17 bits (1317).
In case that the length of the received DCI field is smaller than the length of the required DCI field, “0” may be added to the most significant bit (MSB) of the received DCI field so as to conform to the length of the required DCI field. The length of each block included in the received DCI field and the length of each block included in the required DCI field may not be considered.

FIG. 14B illustrates an example. Referring to FIG. 14B, the received DCI field may include two blocks, and each block may be assumed to correspond to 5 bits. For example, the length of the received DCI field may correspond to 10 bits. It may be assumed that the received DCI field is [b0,b1,b2,b3,b4,b5,b6,b7,b8,b9]. Preceding 5 bits 1411 may correspond to the first block, and following 5 bits 1412 may correspond to the second block. Assuming that the length of the first block included in the required DCI field corresponds to 10 bits, and that the length of the second block corresponds to 10 bits, the required DCI field may be a total of 20 bits. Therefore, the UE may add 10 bits “0,0,0,0,0,0,0,0,0,0” to the MSB of the received DCI field (1413), thereby acquiring 20 bits [0,0,0,0,0,0,0,0,0,0,b0,b1,b2,b3,b4,b5,b6,b7,b8,b9]. In addition, the UE may use preceding 10 bits [0,0,0,0,0,0,0,0,0,0] for first block interpretation (1414), and may use following 10 bits [b1,b2,b3,b4,b5,b6,b7,b8,b9] for second block interpretation (1415). After the field level length adjustment, the UE may acquire a DCI field, the length of which corresponds to a total of 20 bits (1416).

One of the first to second methods may be configured for the UE by the base station. For example, an upper layer signal from the base station may configure MC-DCI, and may configure one of the first to second methods. The UE may use one of the first to second methods according to the configured method. The UE may adjust the length of each DCI field, based on the configured method. The UE may interpret DCI fields. The UE may receive a PDSCH or transmit a PUSCH in an indicated BWP of multiple cells according to the interpretation.

In an embodiment, one of the first to second methods may be configured for the UE with regard to all DCI fields. In an embodiment, one of the first to second methods may be configured for the UE with regard to respective DCI fields. For example, the first method may be configured for the first DCI field, and the second method may be configured for the second DCI

### FIELD

In an embodiment, one of the first to second methods may be configured for the UE with regard to all BWP changes. In an embodiment, one of the first to second methods may be configured for the UE according to the currently activated BWP. For example, in case that the currently activated BWP is BWP #1, the first method may be configured and, in case that the currently activated BWP is BWP #2, the second method may be configured.

In an embodiment, one of the first to second methods may be configured for the UE with regard to all BWP changes. In an embodiment, one of the first to second methods may be configured for the UE according to the indicated BWP. For example, in case that the indicated BWP is BWP #1, the first method may be configured and, in case that the indicated BWP is BWP #2, the second method may be configured.

In an embodiment, one of the first to second methods may be configured for the UE with regard to all BWP changes. In an embodiment, one of the first to second methods may be configured for the UE according to a combination of the currently activated BWP and the indicated BWP. For example, in case that the currently activated BWP is BWP #1, and in case that the indicated BWP is BWP #2, the first method may be configured. In addition, in case that the currently activated BWP is BWP #2, and in case that the indicated BWP is BWP #1, the second method may be configured.

BWP #1 and BWP #2 in the above-described example is only an example, and the above-described embodiment may be identically or similarly applied in the case of other BWPs.

### [Regarding Transmission of a Maximum of Two Transport Blocks]

When receiving a PDSCH, the UE may support a maximum of 8 MIMO layers. The base station may configure, for the UE, the maximum number of transport blocks included in a PDSCH scheduled by DCI. The maximum number of transport blocks may be configured by parameter maxNrofCodeWordsScheduledByDCI of an upper layer signal (for example, RRC signal). If maxNrofCodeWordsScheduledByDCI is 1, the PDSCH may include one transport block and, if maxNrfCodeWordsScheduledByDCI is 2, the PDSCH may include a maximum of two transport blocks. It may be assumed in the following embodiment of the disclosure that maxNrofCodeWordsScheduledByDCI is configured for the UE.

More specifically, when a PDSCH is scheduled through DCI format 11 (for example, dynamic grant PDSCH or DG PDSCH), the DCI may indicate the HARQ process number corresponding to the PDSCH to the UE. A maximum of two transport blocks may correspond to the HARQ process number. Through DCI format 1_1, the UE may determine whether one transport block has been scheduled or two transport blocks have been scheduled. More specifically, the DCI may include a modulation and coding scheme (MCS) field and a redundancy value (RV) field corresponding to each transport block, and in case that the MCS field and the RV field have specific values, the UE may determine to disable the corresponding transport block.

When a PDSCH is scheduled through DCI format 1_0 or DCI format 12 (for example, DG PDSCH), the DCI may indicate the HARQ process number corresponding to the PDSCH to the UE. One transport block may correspond to the HARQ process number. DCI format 1_0 or DCI format 1_2 may have an MCS field and an RV field corresponding to one transport block included in the DCI.

In the case of a semi-persistent scheduled PDSCH (SPS PDSCH) in which the PDSCH is configured by the upper layer or activated by a DCI format, the base station may configure the HARQ process number corresponding to SPS PUSCH for the UE. A maximum of one transport block may correspond to the HARQ process number. For example, a maximum of two transport blocks may correspond to the HARQ process number corresponding to the DG PDSCH, but a maximum of one transport block may correspond to the HARQ process number corresponding to the SPS PDSCH.

When transmitting a PUSCH, the UE may support a maximum of 4 MIMO layers and may support a maximum of 4 ranks. In this case, the PUSCH transmitted by the UE may include one transport block. When a PUSCH is scheduled through DCI, the DCI may indicate the HARQ process number corresponding to the PUSCH to the UE. One transport block may correspond to the HARQ process number.

In case that the maximum number of MIMO layers or the maximum number of ranks supported by the UE during PUSCH transmission exceeds 4, the UE may report the maximum number of MIMO layers or the maximum number of ranks supported by the UE to the base station. The maximum number of MIMO layers or the maximum number of ranks supported by the UE may be included in the UE's capability report. The base station may configure a value, which exceeds 4, as the maximum number of MIMO layers or the maximum number of ranks, based on the UE's capability report. In this case, the PUSCH transmitted by the UE may include a maximum of two transport blocks.

More specifically, when a PUSCH is scheduled through DCI format 0_1 (for example, DG PUSCH), the DCI may indicate the HARQ process number corresponding to the PUSCH to the UE. A maximum of two transport blocks may correspond to the HARQ process number. Through DCI format 0_1, the UE may determine whether one transport block has been scheduled or two transport blocks have been scheduled. More specifically, the DCI may include a modulation and coding scheme (MCS) field and a redundancy value (RV) field corresponding to each transport block, and in case that the MCS field and the RV field have specific values, the UE may determine to disable the corresponding transport block.

When a PUSCH is scheduled through DCI format 0_0 or DCI format 02 (for example, DG PUSCH), the DCI may indicate the HARQ process number corresponding to the PUSCH to the UE. One transport block may correspond to the HARQ process number. DCI format 0_0 or DCI format 0_2 may have an MCS field and an RV field corresponding to one transport block included in the DCI.

In the case of a CG PUSCH in which the PUSCH is configured by the upper layer or activated by a DCI format, the base station may configure the HARQ process number corresponding to CG PUSCH for the UE. A maximum of one transport block may correspond to the HARQ process number. For example, a maximum of two transport blocks may correspond to the HARQ process number corresponding to the DG PUSCH, but a maximum of one transport block may correspond to the HARQ process number corresponding to the CG PUSCH.

DCI format 1_0, 1_1, or 1_2 or DCI format 0_0, 0_1, or 0_2 may include a MCS field corresponding to 5 bits. The 5-bit MCS field may indicate a value corresponding to one of 0, 1, . . . ,31. The indicated value may have a corresponding modulation or code rate defined therefor.

DCI format 1_0, 1_1, or 1_2 or DCI format 0_0, 0_1, or 0_2 may include an RV field corresponding to 2 bits. For example, DCI format 1_0 and DCI format 0_0 may always include a 2-bit RV field. DCI format 1_1 and DCI format 0_1 may include a 2-bit RV field if one PDSCH and one PUSCH are scheduled thereby, and may include a 1-bit RV field if two or more PDSCHs and PUSCHs are scheduled thereby. DCI format 1_2 and DCI format 0_2 may include an RV field according to the base station's configuration, and the RV field may correspond to 0 bit, 1 bit, or 2 bits.

If the RV field corresponds to 0 bit, the UE may always use 0 value as a redundancy version identifier (rv_{id}).

If the RV field corresponds to 1 bit, a value corresponding to one of 0 and 1 may be indicated. The redundancy version identifier (rv_{id}) corresponding to the indicated value may be given in Table 19 or Table 20. Table 20 may be used for DCI format 1_2 or DCI format 0_2, and Table 19 may be used for DCI format 1_1 or DCI format 0_1. Obviously, the following example is not limitative.

TABLE 19

| Value of the Redundancy version field | Value of rv_{id} to be applied |
|---|---|
| 0 | 0 |
| 1 | 2 |

TABLE 20

| Value of the Redundancy version field | Value of rv_{id} to be applied |
|---|---|
| 0 | 0 |
| 1 | 3 |

The 2-bit RV field may indicate a value corresponding to one of 0,1,2,3 (for example, 00, 01, 10, 11 in the binary number system). The redundancy version identifier (rv_{id}) corresponding to the indicated value may be given in Table 21. Obviously, the following example is not limitative.

TABLE 21

| Value of the Redundancy version field | Value of rv_{id} to be applied |
|---|---|
| 00 | 0 |
| 01 | 1 |
| 10 | 2 |
| 11 | 3 |

The 5-bit MCS field and 2-bit RV field may have the following specific values. Obviously, the following example is not limitative.

If the UE receives a DCI format in which the value indicated by the 5-bit MCS field corresponding to one transport block is 26, and the redundancy version identifier (rv_{id}) indicated by the 2-bit RV field is 1, the UE may determine that the transport block is disabled.

In one embodiment, a transport block is disabled in DCI format 1_3 or DCI format 0_3.

This embodiment may be related to DCI format 1_3 which may schedule cell(s) including a cell for which maxNrofCodeWordsScheduledByDCI=2 is configured. For example, maxNrofCodeWordsScheduledByDCI=2 may be configured for at least one of cells which DCI format 1_3 may schedule. A method wherein, upon receiving DCI format 1_3, the UE determines transport block disabling with reference to values indicated by MCS and RV fields in the DCI format, may be presented.

According to the disclosure, the RV field of DCI format 1_3 monitored by the UE may include multiple RV blocks. Each RV block may have a scheduled cell corresponding thereto. For example, the first RV block may indicate the redundancy version of a PDSCH scheduled for the first cell, and the second RV block may indicate the redundancy version of a PDSCH scheduled for the second cell. The length of the RV block of each scheduled cell of DCI format 1_3 may be determined to correspond to 0, 1, or 2 bits according to upper layer parameter numberOfBitsForRV-DCI-1-3 corresponding to the scheduled cell. According to the disclosure, different RV blocks corresponding to different cells may have identical or different lengths. In case that one RV block has a length configured by 2 bits, the redundancy version identifier (rv_{id}) indicated by the RV block may correspond to 0, 1, 2, or 3 according to Table 21. In case that one RV block has a length configured by 1 bit, the redundancy version identifier (rv_{id}) indicated by the RV block may be 0 or 2 according to Table 19, or may be 0 or 3 according to Table 20. In case that one RV block has a length configured by 0 bit, the redundancy version identifier (rv_{id}) indicated by the RV block may be 0.

Hereinafter, in the disclosure, in case that one RV block has a length configured by 1 bit, the UE's operations may be described based on Table 20. However, the UE's operations are not to be limited by Table 20. In case that one RV block has a length configured by 1 bit, and in case that the UE uses Table 19, the redundancy version identifier (rv_{id}) may be interpreted by replacing 3 in Table 20 with 2 in Table 19.

Hereinafter, in the disclosure, in case that one RV block is configured to have a 1-bit length, the UE's operations may be described based on Table 20. In case that one RV block has a length configured by 1 bit, the base station may configure one of Table 19 or Table 20 for the UE. The UE may acquire the redundancy version identifier (rv_{id}), based on the configured table. In case that the base station configures one RV block having a 1-bit length for the UE, and in case that the UE is configured to use Table 19, the UE may acquire the redundancy version identifier (rv_{id}) by using Table 20 in connection with DCI format 1_2, and may acquire redundancy version identifier (rv_{id}) by using Table 19 in connection with DCI format 1_3. For example, the redundancy version identifier (rv_{id}) may be acquired by using different tables in connection with different DCI formats. In case that the base station configures one RV block having a 1-bit length for the UE, and in case that the UE is configured to use Table 20, the UE may acquire the redundancy version identifier (rv_{id}) by using Table 20 in connection with DCI format 1_2 and DCI format 1_3 alike.

Hereinafter, in the disclosure, in case that one RV block is configured to have a 1-bit length, the UE's operations may be described based on Table 20. In case that there is no special instruction from the base station, and in case that one RV block is configured to have a 1-bit length, the UE may acquire the redundancy version identifier (rv_{id}) based on Table 20. In case that one RV block is configured to have a 1-bit length, the redundancy version identifier (rv_{id}) may be acquired by using Table 20 in connection with DCI format 1_2, and the redundancy version identifier (rv_{id}) may be acquired by using Table 19 in connection with DCI format 1_3. For example, the redundancy version identifier (rv_{id}) may be acquired by using different tables in connection with different DCI formats.

According to the disclosure, the UE may acquire the redundancy version identifier (rv_{id}) by using identical or different tables with regard to RV blocks belonging to the RV field of received DCI format 1_3. More specifically, in case that the RV field includes a first RV block and a second RV block, and in case that the first RV block is configured to have a 2-bit length, the UE may use Table 21 to interpret the first RV block. In addition, in case that the second RV block is configured to have a 1-bit length, the UE may use Table 20 to interpret the second RV block. In this case, the first RV block may indicate one of 0, 1, 2, or 3 as the redundancy version identifier (rv_{id}), and the second RV block may indicate one of 0, 3 as the redundancy version identifier (rv_{id}).

In an embodiment of the disclosure, the UE may disable a transport block, based on the length of each RV block belonging to the RV field. Specifically, in case that the UE receives DCI format 1_3, an RV block in the RV field is configured to have a 2-bit length, the indication value of the MCS field regarding the same transport block as the 2-bit-configured RV block is 26, and the rvid indicated by the 2-bit RV field is 1, the UE may determine that the same transport block as the 2-bit-configured RV block has been disabled.

In case that the UE receives DCI format 1_3, an RV block in the RV field is configured to have a 1-bit length, the indication value of the MCS field regarding the same transport block as the 1-bit-configured RV block is 26, and the rvid indicated by the 1-bit RV field is 3, the UE may determine that the same transport block as the 1-bit-configured RV block has been disabled.

In case that the UE receives DCI format 1_3, an RV block in the RV field is configured to have a 0-bit length, and the indication value of the MCS field regarding the same transport block as the 0-bit-configured RV block is 26, the UE may determine that the same transport block as the 0-bit-configured RV block has been disabled. In an embodiment of the disclosure, another may be presented in one of the following embodiments described below in case that an RV block is configured to have a 0-bit length. For example, it has been described in an embodiment of the disclosure that, in case that an RV block is configured to have a 0-bit length, the 0-bit RV block is included in DCI format 1_3, but DCI format 1_3 actually received by the UE may include no 0-bit RV block.

In the above-described embodiment, the UE may not identify the above-described transport block disabling operation with regard to cells which may include a maximum of one transport block (for example, cells for which maxNrofCodeWordsScheduledByDCI=1 is configured, or cells for which maxNrofCodeWordsScheduledByDCI is not configured) among cells which DCI format 1_3 may schedule. In the above-described embodiment, the UE may identify the above-described transport block disabling operation with regard to cells which may include a maximum of two transport blocks (for example, cells for which maxNrofCodeWordsScheduledByDCI=2 is configured) among cells which DCI format 1_3 may schedule.

Table 22 may represent the above-described embodiment. Obviously, the following example is not limitative.

TABLE 22
In case the higher layer parameter maxNrofCodeWordsScheduledByDCI in PDSCH-config indicates
that two codeword transmission is enabled, then

| | |
|---|---|
| - | one of the two transport blocks is disabled by DCI format 1_1 if I_{MCS} = 26 and if rv_{id} = 1 |
| | for the corresponding transport block. |
| - | one of the two transport blocks is disabled by DCI format 1_3 with |
| | numberOfBitsForRV-DCI-1-3 indicating 2bits if I_{MCS} = 26 and if rv_{id} = 1 for the |
| | corresponding transport block. |
| - | one of the two transport blocks is disabled by DCI format 1_3 with |
| | numberOfBitsForRV-DCI-1-3 indicating 1bit if I_{MCS} = 26 and if rv_{id} = 3 for the |
| | corresponding transport block. |
| - | one of the two transport blocks is disabled by DCI format 1_3 with |
| | numberOfBitsForRV-DCI-1-3 indicating 0bit if I_{MCS} = 26 for the corresponding |
| | transport block. |

In case the higher layer parameter maxNrofCodeWordsScheduledByDCI in pdsch-ConfigMulticast
indicates that two codeword transmission is enabled, then one of the two transport blocks is disabled
by DCI format 4_2 if I_{MCS} = 26 and if rv_{id} = 1 for the corresponding transport block. When the UE is
configured with higher layer parameter pdsch-TimeDomainAllocationListForMultiPDSCH, either the
first or the second transport block of all scheduled PDSCHs is disabled by the DCI format 1_1 if I_{MCS}
= 26 and if rv_{id} = 2 for the corresponding transport block of all scheduled PDSCHs. If both transport
blocks are enabled, transport block 1 and 2 are mapped to codeword 0 and 1 respectively. If only one
transport block is enabled, then the enabled transport block is always mapped to the first codeword.

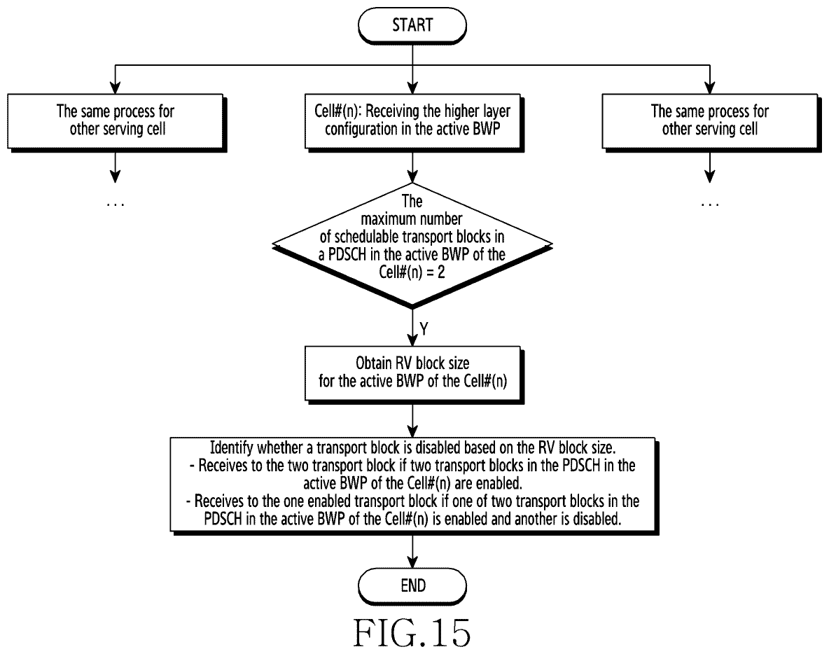

FIG. 15 illustrates a flow of operations in which a UE according to an embodiment of the disclosure determines an enabled transport block according to the number of bits of an RV block configured therefor.

More particularly, FIG. 15 is a flowchart illustrating the UE's operations with regard to at least one embodiment described above. In case that two or more (multiple) cells are configured for the UE, the UE may operate independently with regard to each cell. In an embodiment of the disclosure, although the UE's operations have been schematically illustrated with regard to an arbitrary n^{th} cell (Cell #n) for convenience of description, the operations in FIG. 15 may be equally applied to other cells configured for the UE. In case that, among cells configured for the UE, there is a cell designated in a state in which the same cannot be scheduled, the UE may not perform the schematically illustrated operations with regard to cells designated in a state in which the same cannot be scheduled. The UE may first receive upper layer configuration information corresponding to an activated bandwidth with regard to Cell #n. The upper layer configuration information may include information regarding a parameter for determining the maximum number of transport blocks which can be scheduled for one data transmission channel. The UE may determine the maximum number of transport blocks which can be scheduled for one data channel with regard to the bandwidth activated in Cell #n, based on the upper layer configuration information. In case that the maximum number of transport blocks is 2, the UE may determine whether there is a disabled transport block among the two transport blocks according to the RV block size of the bandwidth activated in Cell #n. The upper layer configuration information may include information regarding the RV block size. For example, the UE may identify whether there is a disabled transport block among the two transport blocks by using a condition determined according to the RV block size. In case that the UE determines that one of the transport blocks has been indicated in a disabled state, the transport block indicated in the enabled state may solely be received. In case that the UE determines that all transport blocks are in the enabled state, the two transport blocks may all be received.

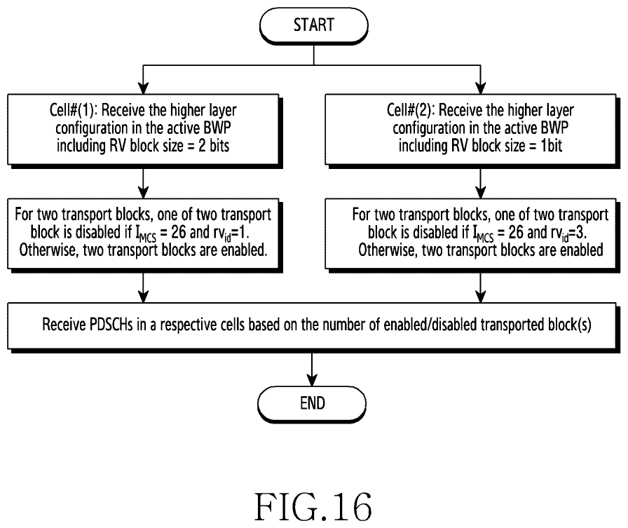

FIG. 16 illustrates a flow of operations in which a UE according to an embodiment of the disclosure determines an enabled transport block according to the number of bits of an RV block configured therefor.

More particularly, FIG. 16 is a flowchart illustrating the UE's operations to help understanding of at least one embodiment described above. Specifically, FIG. 16 may illustrate an exemplary case in which two cells Cell #1 and Cell #2 are configured for the UE, Cell #1 has a 2-bit RV block size configured therefor, and Cell #2 has a 1-bit RV block size configured therefor. Configuration values are considered for convenience of description, and the cell number and the configured RV block size may differ. Referring to at least one embodiment described above, with regard to Cell #1 having a 2-bit RV block size, in case that there is a transport block having an IMCS indication value of 26 and having an RV block indication value of 1, the UE may determine that the transport block is in a disabled state. Referring to at least one embodiment described above, with regard to Cell #2 having a 1-bit RV block size, in case that there is a transport block having an IMCS indication value of 26 and having an RV block indication value of 3, the UE may determine that the transport block is in a disabled state. The UE may identify information regarding a transport block in an enabled state independently with regard to configured cell, and may then receive the identified information.

Another embodiment involves disabling a transport block in case that an RV field corresponding to a cell is 0 bit.

This embodiment may present a method wherein, in case that an RV block corresponding to a cell in the RV field of DCI format 1_3 has a 0-bit length configured according to numberOfBitsForRV-DCI-1-3, disabling of the transport block of the cell is determined. More specifically, as in at least one embodiment described above, the UE may determine whether a transport block is disabled with reference to the MCS field's indication value only. For example, in case that a PDSCH scheduled in one cell by DCI format 1_3 includes a maximum of two transport blocks, and in case that the indication value of the MCS field corresponding to one of the two transport blocks is 26, the UE may determine that the transport block having a corresponding MCS field indication value of 26 has been disabled. For example, in case that a PDSCH scheduled in one cell by DCI format 1_3 includes one transport block, and in case that the indication value of the MCS field corresponding to the transport block included in the PDSCH is 26, the UE may receive the PDSCH according to the modulation order and code rate corresponding to the MCS field indication value of 26.

In an embodiment, in case that the base station wants to use a transport block disabling operation in one cell, the base station may configure numberOfBitsForRV-DCI-1-3 which corresponds to a bit number larger than 0 bit in the cell for the UE. For example, numberOfBitsForRV-DCI-1-3 may be a value configured for each cell. If the value of numberOfBitsForRV-DCI-1-3 is 0, the length of respective RV blocks regarding two transport blocks of the corresponding cell may be 0 bit (for example, the RV block corresponding to transport block 1 may be 0 bit, and the RV block corresponding to transport block 2 may be 0 bit). If the value of numberOfBitsForRV-DCI-1-3 is 1, the length of respective RV blocks regarding two transport blocks of the corresponding cell may be 1 bit (for example, the RV block corresponding to transport block 1 may be 1 bit, and the RV block corresponding to transport block 2 may be 1 bit). If the value of numberOfBitsForRV-DCI-1-3 is 2, the length of respective RV blocks regarding two transport blocks of the corresponding cell may be 1 bit (for example, the RV block corresponding to transport block 1 may be 2 bits, and the RV block corresponding to transport block 2 may be 2 bits).

In this embodiment, for a transport block disabling operation in a cell, the UE may receive an RV block larger than 0 bit corresponding to each of two transport blocks of the PDSCH of the cell in DCI format 1_3. Therefore, the UE may determine whether a transport block is disabled, based on an RV block larger than 0 bit and an MCS field corresponding to each of two transport blocks of the PDSCH of the cell. According to this embodiment, in case that the UE is configured to include a maximum of two transport blocks in one cell's PDSCH (for example, maxNrofCodeWordsScheduledByDCI=2 is configured for the cell), and in case that numberOfBitsForRV-DCI-1-3 is configured to have the value of 0 in the cell configured to include a maximum of two transport blocks in the PDSCH, the UE may not perform the transport block disabling operation in the cell. For example, the UE may receive a PDSCH by assuming that a PDSCH scheduled for a cell always includes two transport blocks. The UE's operations may be as represented in Table 23. Obviously, the following example is not limitative.

TABLE 23
In case the higher layer parameter maxNrofCodeWordsScheduledByDCI in PDSCH-config indicates
that two codeword transmission is enabled, then

| | |
|---|---|
| - | one of the two transport blocks is disabled by DCI format 1_1 if I_{MCS} = 26 and if rv_{id} = 1 |
| | for the corresponding transport block. |
| - | one of the two transport blocks in a cell is disabled by DCI format 1_3 if |
| | numberOfBitsForRV-DCI-1-3 is provided 2bits for the cell and if I_{MCS} = 26 and if rv_{id} |
| | = 1 for the corresponding transport block. |
| - | one of the two transport blocks is disabled by DCI format 1_3 if numberOfBitsForRV- |
| | DCI-1-3 is provided 1bit for the cell and if I_{MCS} = 26 and if rv_{id} = 3 for the |
| | corresponding transport block. |
| - | the two transport blocks is enabled by DCI format 1_3 if numberOfBitsForRV-DCI-1-3 |
| | is provided 0bit. |

In case the higher layer parameter maxNrofCodeWordsScheduledByDCI in pdsch-ConfigMulticast
indicates that two codeword transmission is enabled, then one of the two transport blocks is disabled
by DCI format 4_2 if I_{MCS} = 26 and if rv_{id} = 1 for the corresponding transport block. When the UE is
configured with higher layer parameter pdsch-TimeDomainAllocationListForMultiPDSCH, either the
first or the second transport block of all scheduled PDSCHs is disabled by the DCI format 1_1 if I_{MCS}
= 26 and if rv_{id} = 2 for the corresponding transport block of all scheduled PDSCHs. If both transport
blocks are enabled, transport block 1 and 2 are mapped to codeword 0 and 1 respectively. If only one
transport block is enabled, then the enabled transport block is always mapped to the first codeword.

According to an embodiment of the disclosure, for a transport block disabling operation in a cell, the UE may receive an RV block larger than 0 bit corresponding to each of two transport blocks of the PDSCH of the cell in DCI format 1_3. Therefore, the UE may determine whether a transport block is disabled, based on an RV block larger than 0 bit and an MCS field corresponding to each of two transport blocks of the PDSCH of the cell. According to this embodiment, even if the UE is configured to include a maximum of two transport blocks in one cell's PDSCH (for example, maxNrofCodeWordsScheduledByDCI=2 is configured for the cell), a PDSCH including a maximum of one transport block may be scheduled for the cell according to DCI format 1_3 in case that numberOfBitsForRV-DCI-1-3 is configured to have the value of 0 in the cell. For example, even if one cell's PDSCH is configured to include a maximum of two transport blocks (for example, maxNrofCodeWordsScheduledByDCI=2 is configured for the cell), DCI format 1_3 may not include fields for transport block 2 (for example, may include only fields for transport block 1), and DCI format 1_3 may schedule only one transport block for the cell. For example, one cell's PDSCH may be configured to include a maximum of two transport blocks in (for example, maxNrofCodeWordsScheduledByDCI=2 is configured for the cell) such that, when DCI format 1_1 schedules a PDSCH for the cell, the PDSCH may include a maximum of two transport blocks. For example, DCI format 1_1 may include fields for a maximum of two transport blocks. The above-described UE's operations may be as represented in Table 24. Obviously, the following example is not limitative.

TABLE 24
In case the higher layer parameter maxNrofCodeWordsScheduledByDCI in PDSCH-config indicates
that two codeword transmission is enabled, then one of the two transport blocks is disabled by DCI
format 1_1 if I_{MCS} = 26 and if rv_{id} = 1 for the corresponding transport block.
In case the higher layer parameter maxNrofCode WordsScheduledByDCI in PDSCH-config indicates
that two codeword transmission is enabled and numberOfBitsForRV-DCI-1-3 is provided more
than 0 bits, then

| | |
|---|---|
| - | one of the two transport blocks in a cell is disabled by DCI format 1_3 if |
| | numberOfBitsForRV-DCI-1-3 is provided 2bits for the cell and if I_{MCS} = 26 and if rv_{id} |
| | = 1 for the corresponding transport block. |
| - | one of the two transport blocks is disabled by DCI format 1_3 if numberOfBitsForRV- |
| | DCI-1-3 is provided 1bit for the cell and if I_{MCS} = 26 and if rv_{id} = 3 for the |
| | corresponding transport block. |

In case the higher layer parameter maxNrofCodeWordsScheduledByDCI in PDSCH-config indicates
that two codeword transmission is enabled and numberOfBitsForRV-DCI-1-3 is provided 0 bit, one
transport blocks is scheduled by DCI format 1_3.
In case the higher layer parameter maxNrofCodeWordsScheduledByDCI in pdsch-ConfigMulticast
indicates that two codeword transmission is enabled, then one of the two transport blocks is disabled
by DCI format 4_2 if I_{MCS} = 26 and if rv_{id} = 1 for the corresponding transport block. When the UE is
configured with higher layer parameter pdsch-TimeDomainAllocationListForMultiPDSCH, either the
first or the second transport block of all scheduled PDSCHs is disabled by the DCI format 1_1 if IMCS
= 26 and if rv_{id} = 2 for the corresponding transport block of all scheduled PDSCHs. If both transport
blocks are enabled, transport block 1 and 2 are mapped to codeword 0 and 1 respectively. If only one
transport block is enabled, then the enabled transport block is always mapped to the first codeword.

In an embodiment, in case that the value of numberOfBitsForRV-DCI-1-3 is configured to be 0 in one cell for the UE, the UE may determine whether a transport block is disabled with reference to a field other than the RV field in DCI format 1_3. In an embodiment, the UE may determine whether a transport block is disabled with reference to “new data indicator (NDI)” field in DCI format 1_3 instead of the RV field. More specifically, in case that a PDSCH scheduled for one cell by DCI format 1_3 is configured to include a maximum of two transport blocks (for example, maxNrofCodeWordsScheduledByDCI=2 is configured for the cell), DCI format 1_3 may include a 1-bit NDI bit corresponding to transport block 1 and a 1-bit NDI bit corresponding to transport block 2 with regard to the cell. The UE may determine, with regard to one transport block, whether the transport block is disabled, based on an MCS field value and an NDI bit value.

The MCS field value may be 26. The NDI bit value may be 0. Alternatively, the NDI bit value may be 1. For example, if the MCS field value is 26, and if the NDI bit value is 0 (or 1), the UE may determine that the transport block is disabled. Table 26 may represent UE operations according to this embodiment.

The MCS field value may be 26. The NDI bit value may be the same value as the transport block scheduled immediately before. The transport block corresponding to the NDI bit may be transport blocks corresponding to the same HARQ process number. According to an embodiment of the disclosure, in the case of retransmission of a previous transport block, based on the NDI bit, the retransmitted transport block may be disabled. According to an embodiment of the disclosure, in the case of a new initial transport block, based on the NDI bit, the new initial transport block may be enabled. According to an embodiment of the disclosure, DCI format 1_3 may be limited such that, when a PDSCH is retransmitted, only one transport block is included.

The MCS field value may be 26. The NDI bit value may be a value (toggled value) different from the transport block scheduled immediately before. The transport block corresponding to the NDI bit may be transport blocks corresponding to the same HARQ process number. According to an embodiment of the disclosure, in the case of transmission of a new transport block, based on the NDI bit, the transport block corresponding to the NDI bit may be disabled. Obviously, the following example is not limitative.

TABLE 25
In case the higher layer parameter maxNrofCodeWordsScheduledByDCI in PDSCH-config indicates
that two codeword transmission is enabled, then

| | |
|---|---|
| - | one of the two transport blocks is disabled by DCI format 1_1 if I_{MCS} = 26 and if rv_{id} = 1 |
| | for the corresponding transport block. |
| - | one of the two transport blocks in a cell is disabled by DCI format 1_3 if |
| | numberOfBitsForRV-DCI-1-3 is provided 2bits for the cell and if I_{MCS} = 26 and if rv_{id} |
| | = 1 for the corresponding transport block. |
| - | one of the two transport blocks is disabled by DCI format 1_3 if numberOfBitsForRV- |
| | DCI-1-3 is provided 1bit for the cell and if I_{MCS} = 26 and if rv_{id} = 3 for the |
| | corresponding transport block. |
| - | one of the two transport blocks is disabled by DCI format 1_3 if numberOfBitsForRV- |
| | DCI-1-3 is provided Obit for the cell and if I_{MCS} = 26 and if NDI=0 for the |
| | corresponding transport block. |

In case the higher layer parameter maxNrofCodeWordsScheduledByDCI in pdsch-ConfigMulticast
indicates that two codeword transmission is enabled, then one of the two transport blocks is disabled
by DCI format 4_2 if I_{MCS} = 26 and if rv_{id} = 1 for the corresponding transport block. When the UE is
configured with higher layer parameter pdsch-TimeDomainAllocationListForMultiPDSCH, either the
first or the second transport block of all scheduled PDSCHs is disabled by the DCI format 1_1 if I_{MCS}
= 26 and if rv_{id} = 2 for the corresponding transport block of all scheduled PDSCHs. If both transport
blocks are enabled, transport block 1 and 2 are mapped to codeword 0 and 1 respectively. If only one
transport block is enabled, then the enabled transport block is always mapped to the first codeword.

For example, in case that the value of numberOfBitsForRV-DCI-1-3 is configured to be 0 in one cell for the UE, the UE may determine whether a transport block is disabled with reference to a field other than the RV field in DCI format 1_3. An embodiment of the disclosure may also be applied to a case in which the value of numberOfBitsForRV-DCI-1-3 is configured to be a value other than 0 (for example, 1 or 2) in one cell for the UE. More specifically, the UE may determine whether a transport block is disabled with reference to the RV field and a field other than the RV field in DCI format 1_3. The UE may determine whether a transport block is disabled with reference to the RV field and “new data indicator (NDI)” field in DCI format 1_3. More specifically, in case that a PDSCH scheduled for one cell by DCI format 1_3 is configured to include a maximum of two transport blocks (for example, maxNrofCodeWordsScheduledByDCI=2 is configured for the cell), DCI format 1_3 may include a 1-bit NDI bit corresponding to transport block 1 and a 1-bit NDI bit corresponding to transport block 2 with regard to the cell. The UE may determine, with regard to one transport block, whether the transport block is disabled, based on the MCS field value, the RV field value (the value of an RV block in the RV field), and the NDI bit value.

The MCS field value may be 26. In case that the RV block corresponds to 2 bits (for example, in case that the value of numberOfBitsForRV-DCI-1-3 is configured to be 2), the redundancy version identifier (rv_{id}) may have a value of 1. The NDI bit value may be 0. Alternatively, the NDI bit value may be 1.

The MCS field value may be 26. In case that the RV block corresponds to 1 bit (for example, in case that the value of numberOfBitsForRV-DCI-1-3 is configured to be 1), the redundancy version identifier (rv_{id}) may have a value of 3. The NDI bit value may be 0. Alternatively, the NDI bit value may be 1.

In an embodiment, if the RV block corresponds to 0 or 1 bit (for example, in case that the value of numberOfBitsForRV-DCI-1-3 is configured to be 0 or 1), the UE may check transport block disabling by additionally considering the NDI bit value. In addition, if the RV block corresponds to 2 bits (for example, in case that the value of numberOfBitsForRV-DCI-1-3 is configured to be 2), the UE may check transport block disabling without considering the NDI bit value (by considering the MCS field and the RV field (RV block therein) only). The above-described UE's operations may be as represented in Table 26. Obviously, the following example is not limitative.

TABLE 26
In case the higher layer parameter maxNrofCodeWordsScheduledByDCI in PDSCH-config indicates
that two codeword transmission is enabled, then

| | |
|---|---|
| - | one of the two transport blocks is disabled by DCI format 1_1 if I_{MCS} = 26 and if rv_{id} = 1 |
| | for the corresponding transport block. |
| - | one of the two transport blocks in a cell is disabled by DCI format 1_3 if |
| | numberOfBitsForRV-DCI-1-3 is provided 2bits for the cell and if I_{MCS} = 26 and if rv_{id} |
| | = 1 for the corresponding transport block. |
| - | one of the two transport blocks is disabled by DCI format 1_3 if numberOfBitsForRV- |
| | DCI-1-3 is provided 1bit for the cell and if I_{MCS} = 26 and if rv_{id} = 3 and if NDI=0 for |
| | the corresponding transport block. |
| - | one of the two transport blocks is disabled by DCI format 1_3 if numberOfBitsForRV- |
| | DCI-1-3 is provided Obit for the cell and if I_{MCS} = 26 and if NDI=0 for the |
| | corresponding transport block. |

In case the higher layer parameter maxNrofCodeWordsScheduledByDCI in pdsch-ConfigMulticast
indicates that two codeword transmission is enabled, then one of the two transport blocks is disabled
by DCI format 4_2 if I_{MCS} = 26 and if rv_{id} = 1 for the corresponding transport block. When the UE is
configured with higher layer parameter pdsch-TimeDomainAllocationListForMultiPDSCH, either the
first or the second transport block of all scheduled PDSCHs is disabled by the DCI format 1_1 if I_{MCS}
= 26 and if rv_{id} = 2 for the corresponding transport block of all scheduled PDSCHs. If both transport
blocks are enabled, transport block 1 and 2 are mapped to codeword 0 and 1 respectively. If only one
transport block is enabled, then the enabled transport block is always mapped to the first codeword.

In an embodiment, DCI format 1_3 may include a new DCI field (for example, 2^{nd} TB presence indicator field). The new DCI field may be included in case that the RV block in the RV field of DCI format 1_3 is configured to have a 0-bit length according to numberOfBitsForRV-DCI-1-3. The new DCI field may correspond to 1 bit. The 1-bit new DCI field may be interpreted as follow. Obviously, the following example is not limitative.
If the value of the 1-bit 2^{nd} TB presence indicator field of DCI format 1_3 is 0, the UE may determine that transport block 2 is disabled in connection with the PDSCH of cells scheduled by DCI format 1_3. If the value of the 1-bit 2^{nd} TB presence indicator field of DCI format 1_3 is 1, the UE may determine that transport block 2 is enabled in connection with the PDSCH of cells scheduled by DCI format 1_3.
If the value of the 1-bit 2nd TB presence indicator field of DCI format 1_3 is 0, the UE may determine that transport block 2 is disabled in connection with the PDSCH of cells configured to have a 0-bit RV block length (for example, cells for which the value of numberOfBitsForRV-DCI-1-3 is 0) among cells scheduled by DCI format 1_3. If the value of the 1-bit 2nd TB presence indicator field of DCI format 1_3 is 1, the UE may determine that transport block 2 is enabled in connection with the PDSCH of cells configured to have a 0-bit RV block length (for example, cells for which the value of numberOfBitsForRV-DCI-1-3 is 0) among cells scheduled by DCI format 1_3. In the case of a cell having an RV block length configured to be a bit number larger than 0 (for example, a cell for which the value of numberOfBitsForRV-DCI-1-3 is 1 or 2), transport block disabling may be determined according to the preceding embodiment.

The new DCI field may correspond to multiple bits. Each of the multiple bits may have a corresponding cell. The corresponding cell may have an RV block configured to have a 0-bit length (for example, the value of numberOfBitsForRV-DCI-1-3 is to be 0 for the cell). If each bit is “0”, transport block 2 may be disabled for the corresponding cell, and if each bit is “1”, transport block 2 may be enabled for the corresponding cell.

In an embodiment, the base station may individually configure the RV field length with regard to each transport block. For example, with regard to a cell for which maxNrofCodeWordsScheduledByDCI=2 is configured, the base station may transmit numberOfBitsForRV-DCI-1-3_TB-1 for configuring the RV block length of transport block 1 and numberOfBitsForRV-DCI-1-3_TB-2 for configuring the RV block length of transport block 2 to the UE. The UE may determine the RV block length of transport block 1 of the corresponding cell, based on numberOfBitsForRV-DCI-1-3_TB-1, and may determine the RV block length of transport block 2 of the corresponding cell, based on numberOfBitsForRV-DCI-1-3_TB-2. The value of numberOfBitsForRV-DCI-1-3_TB-1 may be one of 0, 1, or 2, and the value of numberOfBitsForRV-DCI-1-3_TB-2 may be one of 0, 1, or 2.

In case that all RV blocks have a 0-bit length with regard to two transport blocks of one cell, the UE may not expect a transport block disabling operation with regard to one cell. In case that the RV field does not have a 0-bit length with regard to at least one transport block, the UE may perform transport block disabling according to the above-described embodiment with regard to the transport block, the RV field length of which is not 0 bit.

In case that the base station wants to use a transport block disabling operation for one cell, the base station may configure, for the UE, numberOfBitsForRV-DCI-1-3_TB-1 or numberOfBitsForRV-DCI-1-3_TB-2, which corresponds to a bit number larger than 0 bit, for transport block 1 or transport block 2 of the cell. For example, the UE may receive RV blocks, the number of which is larger than 0 bit, with regard to at least one transport block. The UE may determine transport block disabling, based on RV blocks, the number of which is larger than 0 bit.

Another embodiment involves disabling a transport block during BWP switching in DCI format 1_3 or DCI format 0_3.

An embodiment of the disclosure may relate to DCI format 1_3 which schedules a PDSCH for cells, including a cell having maxNrofCodeWordsScheduledByDCI=2 configured therefor. The UE may receive DCI format 1_3 in the currently activated BWP In addition, a method wherein, in case that the UE is instructed to switch the BWP from the currently activated BWP to an indicated BWP, the UE determines transport block disabling, is presented. In case that the length of each DCI field of DCI format 1_3 received by the UE is smaller than the length of the DCI field necessary for interpretation in the BWP to be switched to, the UE may add “0” to the MSB so as to conform to the necessary DCI field length. The above-described process may be referred to as zero padding.

A problem to be solved in the disclosure may be related to a case in which the UE cannot receive transport block disabling indication through zero padding of a DCI field. More specifically, the UE may determine transport block disabling, based on an MCS field and an RV field corresponding to one transport block. All BWPs have the same MCS field of 5 bits, and zero padding may not be performed accordingly. However, the RV field may have a configured length ofnumberOfBitsForRV-DCI-1-3. The value ofnumberOfBitsForRV-DCI-1-3 may be individually configured for each BWP. Therefore, in each BWP, the value of numberOfBitsForRV-DCI-1-3 in the currently activated BWP and the same in the indicted BWP may differ from each other. The configured value of numberOfBitsForRV-DCI-1-3 may be 0 in the currently activated BWP, and the configured value of numberOfBitsForRV-DCI-1-3 may be 1 or 2 in the indicated BWP. The UE may apply zero padding to the RV field so as to interpret 1-bit “0” or 2-bit “00”, thereby acquiring the redundancy version identifier (rv_{id}). According to the interpretation of 1-bit “0” or 2-bit “00”, the redundancy version identifier (rv_{id}) may not indicate transport block disabling according to the preceding embodiment. Therefore, in case that the base station indicates BWP switching to DCI format 1_3 including a 0-bit RV block, the base station may be unable to indicate transport block disabling to the 0-bit RV block. In case that the base station receives accurate channel information reported by the UE, or transmits a PDSCH before conducting measurement, it may be preferred to include only one transport block in the indicated BWP. This may be because it is difficult to perform an accurate MIMO operation before the base station receives accurate channel information reported by the UE or conducts measurement. Therefore, during BWP switching, the PDSCH may preferably include only one transport block (for example, one transport block is disabled). Obviously, the following example is not limitative.

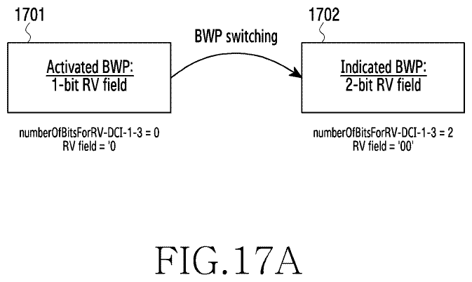

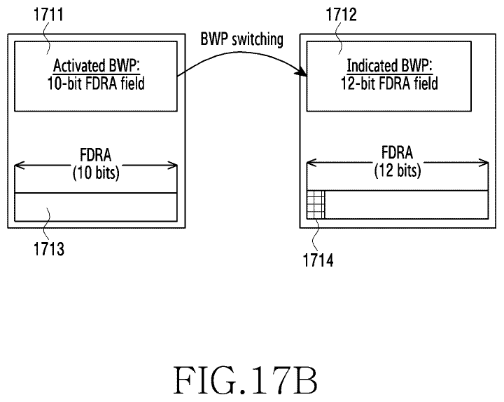

FIG. 17A and FIG. 17B illustrate an example in which, in case that BWP switching is indicated, DCI field length adjustment is performed according to the indicated BWP, according to an embodiment of the disclosure.

FIG. 17A illustrates an example. It may be assumed that the activated BWP 1701 has 0 configured as the numberOfBitsForRV-DCI-1-3 value, and the indicated BWP 1702 has 2 configured as the numberOfBitsForRV-DCI-1-3 value. The UE may then apply zero padding to an RV field so as to interpret an RV field corresponding to 2-bit “00”. The UE may then perform a transport block disabling operation.

The UE may determine transport block disabling by using the following scheme. Firstly, in case that BWP switching is indicated, the UE may always assume disabling of the second transport block, and may assume transmission regarding only one transport block. For example, the UE may ignore the DCI field value regarding the second transport block.

The above-described scheme may be limitedly applied only to a PDSCH corresponding to a 0-bit RV block in case that DCI format 1_3 received in the currently activated BWP includes a 0-bit RV block. For example, in case that DCI format 1_3 includes a 1-bit RV block or 2-bit RV block in the currently activated BWP, transport block disabling may be determined, based on the 1-bit RV block or 2-bit RV block, in connection with the PDSCH corresponding to the 1-bit RV block or 2-bit RV block. Obviously, the following example is not limitative.

The above-described scheme may be limitedly applied only to a PDSCH corresponding to an RV block corresponding to a case in which DCI format 1_3 includes an N-bit RV block in the currently activated BWP and, assuming that the RV block necessary in the indicated BWP has an M-bit length, M>N. For example, the above-described scheme may be limitedly applied only to a PDSCH corresponding to an RV block corresponding to a case in which M>N when zero padding is performed in the RV block. Obviously, the following example is not limitative.

The above-described scheme may be limitedly applied only to a PDSCH corresponding to an RV block corresponding to a case in which DCI format 1_3 includes a 0-bit RV block in the currently activated BWP and, assuming that the RV block necessary in the indicated BWP has an M-bit length, M>0. For example, the above-described scheme may be limitedly applied only to a PDSCH corresponding to a 0-bit RV block when zero padding is performed in the 0-bit RV block. Obviously, the following example is not limitative.

In an embodiment, in case that BWP switching to DCI format 1_3 is indicated, the UE may add “1” (not “0”) to the MSB with regard to an RV block, thereby adjusting the necessary DCI field length. In case that the length of a received RV block is smaller than the length of an RV block necessary for information interpretation in the indicated BWP, the UE may add “1” to the MSB to adjust the length, and may then interpret information indicated by the RV block. Therefore, the UE may determine transport block disabling with reference to the RV block and MCS field indication values with regard to respective transport blocks.

In an embodiment, the UE may adjust the necessary DCI field length with reference to only the RV block indication value of DCI format 1_3 in which transport block disabling/no disabling is indicated. More specifically, in case that the RV block length of received DCI format 1_3 is smaller than the bit length necessary in the indicated BWP, the UE may check transport block disabling/no disabling by first referring to the indication value of an RV field received prior to zero padding. The UE may add “0” to the received RV field such that the length is adjusted to the bit length necessary in the indicated BWP.

In case that the base station instructs the UE to transmit a PUSCH through DCI which schedules PUSCH transmission for each of multiple cells, the maximum number of transport blocks that the UE may include during each PUSCH transmission may be configured to be 2. The DCI may be DCI format 0_3. In case that maxMIMO_Layer>4 or maxRank>4 holds with regard to an upper layer parameter configured for the UE (for example, maxMIMO_Layer or maxRank), the UE may include a maximum of two transport blocks during one PUSCH transmission. In case that the UE schedules a PUSCH with regard to each of multiple cells, and in case that each PUSCH may include a maximum of two transport blocks, the base station may indicate disabling of two transport blocks that the UE may transmit. For example, the base station may identify I_{MCS} and RV block indication value with regard to each transport block in DCI, thereby determining transport block disabling/no disabling with regard to each cell. In an embodiment, in case that I_{MCS} and RV block indication value satisfy a specific condition, the UE may determine that a transport block having information of DCI satisfying the specific condition is in a disabled state. The bit length of each EV block included in DCI format 1_3 may be determined according to numberOfBitsForRV-DCI-0-3. Therefore, the condition that indicates transport block disabling may be configured differently according to the RV block's bit length. According to each RV block's bit length, the UE may determine whether a multi-transmission block in each cell is disabled. Specifically, it may be assumed that two cells Cell #1 and Cell #2 are configured for the UE, Cell #1 has a configured 2-bit RV block size, and Cell #2 has a configured 1-bit RV block size. Configuration values are considered for convenience of description, and the cell number and configured RV block size may be different from the above examples. In case that, with regard to Cell #1 having a 2-bit RV block size, there is a transport block having an I_{MCS} indication value of 26 and an RV block indication value of 1, the UE may determine that the transport block is in a disabled state. Referring to at least one embodiment described above, in case that with regard to Cell #2 having a 1-bit RV block size, there is a transport block having an I_{MCS} indication value of 26 and an RV block indication value of 3, the UE may determine that the transport block is in a disabled state. The above-described method may be an example in which the UE determines an RV block indication value by referring to Table 21 if the RV block size is 2 and referring to Table 20 if the RV block size is 1. The UE may identify information regarding a transport block in an enabled state independently with regard to configured cells, and may then receive the identified information. The UE may receive scheduling information regarding a transport block which is not disabled with regard to each cell and may then perform PUSCH transmission. In an embodiment, in case that the configured block size is 0 bit, the UE may determine a transport block's disabled state, based on at least one embodiment described above. Obviously, the above examples are not limitative.

With regard to the above example, when the UE receives DCI that indicates PUSCH transmission regarding multiple cells, BWP switching may be indicated together (or respectively). In this case, the problem mentioned in at least one embodiment described above may occur similarly. Specifically, when BWP switching is indicated to the UE, the length necessary for DCI field interpretation may be larger in the indicated BWP than in the activated BWP. The UE may then add “0” with regard to the DCI field received to interpret the DCI field so as to conform to the length necessary in the indicated BWP. The UE may have difficulty in performing a transport block disabling operation regarding a multi-transmission block as in at least one embodiment described above. In order to solve the above problem, the method presented in at least one embodiment described above may be applied to DCI that indicates PUSCH transmission regarding multiple cells. The DCI may be DCI format 0_3. Obviously, the above example is not limitative.

At least one embodiment of the disclosure may be expanded and applied to a case in which multiple PDSCHs or multiple PUSCHs are scheduled for one cell, as follow. The following embodiment may be described in a situation in which multiple PDSCHs are scheduled for one cell, but may also be expanded and applied to a situation in which multiple PUSCHs are scheduled for one cell.

More specifically, the UE may have multiple PDSCHs scheduled for one cell by a DCI format. The DCI format received by the UE may have an RV block corresponding to each of the multiple PDSCHs. The bit number of the RV block corresponding to each of the multiple PDSCHs may be 1 bit. The number of RV blocks (for example, the RV field's length in the case of 1 bit per RV block) included in the DCI format received by the UE may be identical to the maximum number of PDSCHs that the DCI format may schedule. For example, if the maximum number of PDSCHs that the DCI format may schedule is 4, the number of RV blocks included in the DCI format may be 4 (for example, the RV field's length may be 4 bits in the case of 1 bit per RV block). If the number of PDSCHs scheduled by the DCI format is larger than the maximum number of PDSCHs, RV blocks of the number of scheduled PDSCHs, among RV blocks, may be used to indicate the redundancy version (rv_{id}) of each scheduled PDSCH, and remaining RV blocks have no corresponding PDSCH and may thus not indicate the redundancy version.

Similarly to at least one embodiment of the disclosure, the UE may have a PDSCH scheduled therefor but may not have a corresponding RV block indicated through a DCI format, in the following case. The UE may receive a DCI format in the currently activated downlink BWP of one cell. The UE may receive a DCI format which schedules a maximum of X=4 PDSCHs in the activated downlink BWP of one cell. In other words, the UE may be configured by the base station such that a maximum of 4 PDSCHs can be scheduled in the activated downlink BWP of one cell. Therefore, the DCI format may include X=4 RV blocks. The DCI format received by the UE may be used to receive a PDSCH in a different downlink BWP (for example, a newly activated BWP) other than the currently activated downlink BWP. More than four PDSCHs may be scheduled for the newly activated BWP. For example, in case that Y=6 PDSCHs may be scheduled, the UE may need X=6 RV blocks to determine the redundancy version (rv_{id}) of Y=6 PDSCHs. However, the UE can acquire only X=4 RV blocks from the DCI format, and two (Y−X=6−4=2) PDSCHs may have no RV block. If there is no RV block, the UE may assume that the RV block's value is “0”.

The DCI format which schedules multiple PDSCHs for one cell may indicate the number of transport blocks equally included in all scheduled PDSCHs. For example, in case that the DCI format which schedules four PDSCHs, each of the four scheduled PDSCHs may include one transport block or two transport blocks. Therefore, some of the four PDSCHs may include one transport block, and the remaining PDSCHs may be scheduled to include two transport blocks.

The DCI format which schedules multiple PDSCHs for one cell may indicate whether each of the scheduled PDSCHs includes a transport block (for example, whether the transport block is disabled) by using the transport block's MCS field and RV field's value. In an embodiment, in case that the value indicated by MCS field corresponding to all PDSCHs scheduled by the DCI format is 26, and in case that the redundancy version (rv_{id}) indicated by RV blocks (for example, 1 bit of the RV field) included in the RV field indicates 2, the UE may determine that the transport block of all PDSCHs scheduled by the DCI format is not included (disabled).

As previously mentioned, when the DCI format indicates BWP switching, the UE cannot acquire the RV block of some PDSCHs scheduled by the DCI format. Therefore, the UE cannot have the redundancy version (rv_{id}) of some PDSCHs indicated by the DCI format. The redundancy version may then be determined to be 0. Therefore, one transport block cannot be disabled.

The UE may determine transport block disabling by using the following scheme. Firstly, in case that BWP switching is indicated, the UE may always assume disabling of the second transport block, and may assume transmission regarding only one transport block. For example, the UE may ignore the DCI field value regarding the second transport block.

In an embodiment, the scheme may be limitedly applied to a case in which the number (X) of RV blocks included in the DCI format received in the currently activated BWP is smaller than the number (Y) of necessary RV blocks. For example, in case that the number (X) of RV blocks included in the DCI format received in the currently activated BWP is smaller than the number (Y) of necessary RV blocks, the UE may assume that the second transport block of PDSCHs scheduled by DCI is disabled. The UE may receive a PDSCH according to the above assumption. Obviously, the above example is not limitative.

In case that the number (X) of RV blocks included in the DCI format received in the currently activated BWP is smaller than the number (Y) of necessary RV blocks, the UE may assume that only X PDSCHs among Y PDSCHs have been scheduled. In addition, the UE may acquire the redundancy version (rv_{id}) value of X PDSCHs, based on X RV blocks acquired from the DCI format. In addition, the UE may determine whether the transport block of X PDSCHs is disabled, based on the redundancy version (rv_{id}) value. In this case, the X PDSCHs deemed to have been scheduled, among the Y PDSCHs, may be as follows. Obviously, the following example is not limitative.
X PDSCHs scheduled for a temporally preceding symbol among Y PDSCHs
X PDSCHs scheduled for a temporally following symbol among Y PDSCHs
X PDSCHs configured to precede in the order of an upper layer signal among Y PDSCHs
X PDSCHs configured to follow in the order of an upper layer signal among Y PDSCHs

The upper layer signal may configure the starting and length indicator value (SLIV) of symbols of PDSCHs.

Obviously, the above example is not limitative.

In case that the number (X) of RV blocks included in the DCI format received in the currently activated BWP is smaller than the number (Y) of necessary RV blocks, the UE may assume that only one PDSCH among Y PDSCHs has been scheduled. In addition, the UE may acquire the redundancy version (rv_{id}) value of one PDSCH, based on one RV block acquired from the DCI format. In addition, the UE may determine whether the transport block of one PDSCH is disabled, based on the redundancy version (rv_{id}) value. Obviously, the above example is not limitative.

In this case, the one PDSCH deemed to have been scheduled, among the Y PDSCHs, may be as follows:
A PDSCH scheduled for temporally the foremost symbol among Y PDSCHs
A PDSCH scheduled for temporally the rearmost symbol among Y PDSCHs
A PDSCH configured the foremost in the order of an upper layer signal among Y PDSCHs
A PDSCH configured the rearmost in the order of an upper layer signal among Y PDSCHs

The upper layer signal may configure the starting and length indicator value (SLIV) of symbols of PDSCHs.

Obviously, the above example is not limitative.

In case that BWP switching is indicated to the UE by a DCI format, and in case that the UE cannot acquire the RV block corresponding to the scheduled PDSCH from the DCI format, the UE may interpret after adding “1” (not “0”) to the RV block. Thereafter, the UE may determine, with regard to each transport block, transport block disabling with reference to the RV block to which “1” is added, and the MCS field's indication value.

Yet another embodiment involves disabling a scheduled cell during BWP switching in DCI format 1_3 or DCI format 03 (invalid FDRA determination).

An embodiment of the disclosure presents a method wherein, in case that DCI format 1_3 or DCI format 0_3 is received in the currently activated BWP, and in case that BWP switching from the currently activated BWP to an indicated BWP is indicated, the UE determines whether a cell is scheduled with reference to a frequency domain resource assignment (FDRA) field in DCI of each serving cell.

In case that the UE has multiple serving cells, the base station may indicate an FDRA field regarding each serving cell to the UE, and the UE may determine whether each cell is actually scheduled through the FDRA field regarding each serving cell. In an embodiment, in case that resource allocation type-0 (RA type-0) is followed, and in case that 0 is assigned to all bits in the FDRA field of one cell, the UE may determine that the cell in which 0 is assigned to all bits in the FDRA field has not been scheduled. In an embodiment, in case that resource allocation type-1 (RA type-1) is followed, and in case that 1 is assigned to all bits in the FDRA field of one cell, the UE may determine that the cell in which 1 is assigned to all bits in the FDRA field has not been scheduled. In an embodiment, in case that resource allocation type-2 (RA type-2) is followed, in case that a subcarrier spacing of 15 kHz is used in the FDRA field of one cell, and in case that 1 is assigned to all bits, or in case that a subcarrier spacing of 30 kHz is used in the FDRA field of one cell, and in case that 0 is assigned to all bits, the UE may determine that the corresponding cell has not been scheduled. In an embodiment, in case that dynamic switching is configured between RA type-0 and RA type-1, and in case that 0 or 1 is assigned to all bits in the FDRA field of one cell, the UE may determine that the cell in which 0 or 1 is assigned to all bits in the FDRA field has not been scheduled. The UE may not receive a PDSCH or transmit a PUSCH to the cell deemed not scheduled, and may not apply relevant information to a cell deemed not scheduled by the DCI format. For example, in case that closed-loop power control is configured according to a transmit power control (TPC) command in an accumulative manner, the UE may not apply relevant information to a cell deemed not scheduled even if DCI format 0_3 has indicated a TPC value for PUSCH transmission.

In case that the length of a DCI field received by the UE after a BWP switching indication is smaller than the length of the DCI field necessary for interpretation in the indicated BWP, the UE may add “0” to the MSB so as to conform to the necessary DCI field length. The above-described operation may be referred to as zero-padding of the DCI field. A problem to be solved in the disclosure may be related to a case in which, when performing zero-padding in the FDRA field of one cell, the UE cannot receive an indication whether the zero-padded cell is scheduled through the FDRA field.

More specifically, in case that the length of the FDRA field regarding one cell in DCI format 1_3 or 0_3 received in the currently activated BWP corresponds to N bits, in case that the length of the FDRA field necessary for the cell in the indicated BWP corresponds to M bits, and in case that M>N, “0” of M-N bits may be added to the MSB of the N-bit FDRA field. FIG. 17B illustrates an example. It may be assumed that the length of the FDRA field in the activated BWP 1711 is N=10 bits, and the length of the FDRA field in the indicated BWP 1712 is M=12 bits. Since M>N is satisfied, “0” of M−N=2 bits may be added to the MSB of the 10-bit FDRA field 1713 (1714).

The UE may assume that resource allocation type-1 or resource allocation type-2 (for example, 15 kHz subcarrier spacing) is configured in the indicated BWP of one cell. In case that the FDRA field corresponding to the indicated BWP of the cell is all “1”, the UE may determine that the cell has not been scheduled. However, in case that the UE interprets M bits obtained by zero-padding in the N-bit FDRA field as the FDRA field of the indicated BWP, the FDRA field includes “0”, and the cell may thus always be deemed scheduled. Therefore, the base station cannot flexibly schedule a cell during BWP switching.

In case that the length of the FDRA field regarding one cell in DCI format 1_3 or 0_3 received in the currently activated BWP corresponds to N bits, in case that the length of the FDRA field necessary for the cell in the indicated BWP corresponds to M bits, and in case that M≤N, the UE may use the remainder obtained by excluding MSB M-N bits from the N-bit FDRA field regarding the cell so as to interpret the same as the FDRA field of the indicated BWP. Therefore, whether a cell is indicated may be indicated by FDRA field interpretation.

The UE may determine whether a serving cell is scheduled in the following method. Obviously, the following example is not limitative.

In an embodiment, the UE may select “0” or “1” according to the resource allocation type of FDRA so as to conform to the necessary DCI field length. For example, the UE may perform zero-padding or one-padding according to the RA type instead of always performing zero-padding. As used herein, one-padding may refer to adding “1” to the MSB when adjusting the length.

For example, in case that the first type of resource allocation is configured in the indicated BWP, the UE may adjust the DCI field length by using “0” (for example, perform zero-padding) and, in case that the second type of resource allocation is configured therein, the UE may adjust the DCI field length by using “1”. According to the first type of resource allocation, if all bits of the FDRA field are “0”, no scheduling may be confirmed. For example, the first type of resource allocation may include RA-type 0 or RA-type 2, the subcarrier spacing of which is 30 kHz. According to the second type of resource allocation, if all bits of the FDRA field are “1”, no scheduling may be confirmed. For example, the first type of resource allocation may include RA-type 1 or RA-type 2, the subcarrier spacing of which is 15 kHz. In case that dynamic switching is configured between RA type-0 and RA type-1, the same may be one of the first type of resource allocation or the second type of resource allocation.

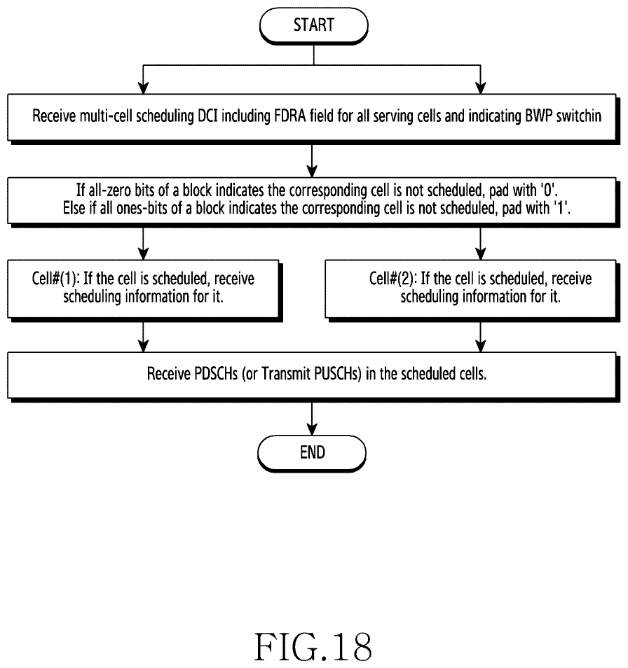

FIG. 18 illustrates a flow of operations for determining co-scheduled cells, based on multiple FDRA fields included in MC-DCI according to an embodiment of the disclosure.

More particularly, FIG. 18 illustrates a flow of operations of the UE according to the above-described embodiment. It may be assumed, for convenience of description, that the number of cells configured for the UE is 2. In case that the UE receives MC-DCI including scheduling information regarding two cells, in case that BWP switching is indicated by the DCI, and in case that the length of each DCI field of the DCI format received by the UE is smaller than the length of the DCI field necessary for interpretation in the switching-indicated BWP, the UE may adjust the DCI field length for the indicated BWP. According to the above-described embodiment, in case that the first type of resource allocation is used, the UE may adjust the DCI field length by using “0” (zero-padding). According to the above-described embodiment, in case that the second type of resource allocation is used, the UE may adjust the DCI field length by using “1” (one-padding). After performing the DCI field length adjustment operation, the UE may identify the FDRA field with regard to each cell, thereby determining whether the corresponding cell is scheduled. In case that Cell #(1) and Cell #(2) configured for the UE are both scheduled, the UE may perform PDSCH reception or PUSCH transmission by using both cells. In case of determining that, among the two cells configured for the UE, Cell #(1), for example, is not scheduled, the UE may perform PDSCH reception or PUSCH transmission by using Cell #(2) only.

In an embodiment, in case that the length of the FDRA field of one cell received in the currently activated BWP is smaller than the length of the FDRA field needed by the cell in the indicated BWP, the UE may determine that the corresponding serving cell is not scheduled. For example, the UE may determine whether a cell is scheduled, based on the length of the FDRA field received in the currently activated BWP and the length of the FDRA field of the indicated BWP. The above scheme may be applied only to a case in which the second type of resource allocation is configured for the indicated BWP. Obviously, the above example is not limitative.

In an embodiment, in case that after BWP switching is indicated to the UE, the length of an FDRA field necessary for information interpretation is larger in the indicated BWP than in the BWP used to receive DCI, it may be determined, based on the FDRA field before adding the DCI field length (for example, before adding “0” to the MSB), whether each serving is scheduled. After determining whether serving cells are scheduled, the UE may determine the length of the FDRA field by adding “0” according to the necessary length of the indicated BWP. Obviously, the above example is not limitative.

In an embodiment, in case that BWP switching to DCI format 1_3 or DCI format 0_3 is indicated, the UE may assume that, among all serving cells, only one specific cell is scheduled. More specifically, in case that BWP switching is indicated, the UE may assume that only the serving cell having the lowest cell index is scheduled, and may not identify whether serving cells are scheduled by using the FDRA field. Obviously, the above example is not limitative.

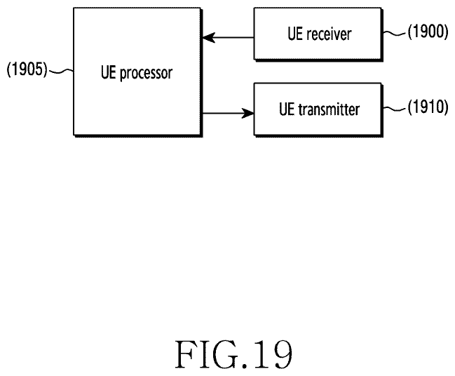

FIG. 19 illustrates a structure of a UE in a wireless communication system according to an embodiment of the disclosure.

Referring to FIG. 19, the UE may include a transceiver, which refers to a UE receiver 1900 and a UE transmitter 1910 as a whole, a memory (not illustrated), and a UE processor 1905 (or UE controller or processor). The UE transceiver 1900 and 1910, the memory, and the UE processor 1905 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The transceiver 1900 and 1910 may transmit/receive signals with the base station. The signals may include control information and data. To this end, the transceiver 1900 and 1910 may include an RF transmitter configured to up-convert and amplify the frequency of transmitted signals, an RF receiver configured to low-noise-amplify received signals and down-convert the frequency thereof, and the like. However, this is only an embodiment of the transceiver 1900 and 1910, and the components of the transceiver 1900 and 1910 are not limited to the RF transmitter and the RF receiver.

In addition, the transceiver 1900 and 1910 may receive signals through a radio channel, output the same to the UE processor 1905, and transmit signals output from the UE processor 1905 through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories, and the memory may store instructions for performing the above-described communication methods.

Furthermore, the UE processor 1905 may control a series of processes such that the UE can operate according to the above-described embodiments. For example, the UE processor 1905 may control components of the UE to receive DCI configured in two layers so as to simultaneously receive multiple PDSCHs. The UE processor 1905 may include multiple processors, and the UE processor 1905 may perform operations of controlling the components of the UE by executing programs stored in the memory.

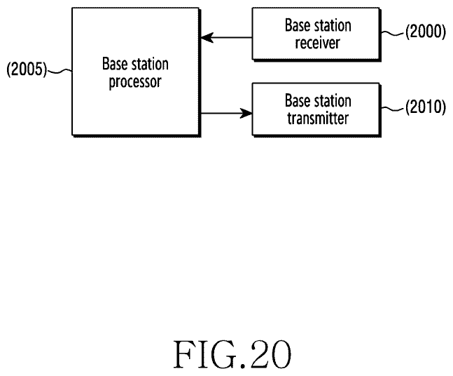

FIG. 20 illustrates a structure of a base station in a wireless communication system according to an embodiment of the disclosure.

Referring to FIG. 20, the base station may include a transceiver, which refers to a base station receiver 2000 and a base station transmitter 2010 as a whole, a memory (not illustrated), and a base station processor 2005 (or base station controller or processor). The base station transceiver 2000 and 2010, the memory, and the base station processor 2005 may operate according to the above-described communication methods of the base station. However, components of the base station are not limited to the above-described example. For example, the base station may include a larger or smaller number of components than the above-described components. Furthermore, the transceiver 2000 and 2010, the memory, and the base station processor 2005 may be implemented in the form of a single chip.

The transceiver 2000 and 2010 may transmit/receive signals with the base station. The signals may include control information and data. To this end, the transceiver 2000 and 2010 may include an RF transmitter configured to up-convert and amplify the frequency of transmitted signals, an RF receiver configured to low-noise-amplify received signals and down-convert the frequency thereof, and the like. However, this is only an embodiment of the transceiver 2000 and 2010, and the components of the transceiver 2000 and 2010 are not limited to the RF transmitter and the RF receiver.

In addition, the transceiver 2000 and 2010 may receive signals through a radio channel, output the same to the base station processor 2005, and transmit signals output from the base station processor 2005 through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories, and the memory may store instructions for performing the above-described communication methods.

The base station processor 2005 may control a series of processes such that the base station can operate according to the above-described embodiments of the disclosure. For example, the base station processor 2005 may control components of the base station to configure DCI configured in two layers including allocation information regarding multiple PDSCHs and to transmit the same. The base station processor 2005 may include multiple processors, and the base station processor 2005 may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, configuration information on a maximum number of transport blocks (TBs) included in a physical downlink shared channel (PDSCH);
receiving, from the base station, downlink control information (DCI) including a redundancy version (RV) field;
identifying at least one disabled TB among the TBs included in the PDSCH based on a size of the RV field; and
receiving, from the base station, the at least one disabled TB on the PDSCH.

2. The method of claim 1,
wherein the configuration information further includes information on the size of the RV field.

3. The method of claim 1,
wherein the RV field includes a plurality of RV blocks corresponding to each of the TBs included in the PDSCH, and
wherein the at least one disabled TB is identified based on an identifier (ID) of an RV block of the plurality of RV blocks.

4. The method of claim 2,
wherein the information on the size of the RV field is numberOfBitsForRV-DCI-1-3 which includes at most 2 bits.

5. The method of claim 1,
wherein the DCI further includes a modulation and coding scheme (MCS) field, and
wherein a value of an MCS field corresponding to the at least one disabled TB is 26.

6. A method performed by a base station in a wireless communication system, the method comprising:
transmitting, to a terminal, configuration information on a maximum number of transport blocks (TBs) included in a physical downlink shared channel (PDSCH);
transmitting, to the terminal, downlink control information (DCI) including a redundancy version (RV) field; and
transmitting, to the terminal, the TBs included in the PDSCH,
wherein at least one disabled TB among the TBs included in the PDSCH is identified based on a size of the RV field.

7. The method of claim 6,
wherein the configuration information further includes information on the size of the RV field.

8. The method of claim 6,
wherein the RV field includes a plurality of RV blocks corresponding to each of the TBs included in the PDSCH, and
wherein the at least one disabled TB is based on an identifier (ID) of an RV block of the plurality of RV blocks.

9. The method of claim 7,
wherein the information on the size of the RV field is numberOfBitsForRV-DCI-1-3 which includes at most 2 bits.

10. The method of claim 6,
wherein the DCI further includes a modulation and coding scheme (MCS) field, and
wherein a value of an MCS field corresponding to the at least one disabled TB is 26.

11. A terminal in a wireless communication system, the terminal comprising:
a transceiver; and
at least one processor coupled with the transceiver and configured to:
receive, from a base station, configuration information on a maximum number of transport blocks (TBs) included in a physical downlink shared channel (PDSCH),
receive, from the base station, downlink control information (DCI) including a redundancy version (RV) field,
identify at least one disabled TB among the TBs included in the PDSCH based on a size of the RV field, and
receive, from the base station, the at least one disabled TB on the PDSCH.

12. The terminal of claim 11,
wherein the configuration information further includes information on the size of the RV field.

13. The terminal of claim 11,
wherein the RV field includes a plurality of RV blocks corresponding to each of the TBs included in the PDSCH, and
wherein the at least one disabled TB is identified based on an identifier (ID) of an RV block of the plurality of RV blocks.

14. The terminal of claim 12,
wherein the information on the size of the RV field is numberOfBitsForRV-DCI-1-3 which includes at most 2 bits.

15. The terminal of claim 11, aspiration
wherein the DCI further includes a modulation and coding scheme (MCS) field, and
wherein a value of an MCS field corresponding to the at least one disabled TB is 26.

16. A base station in a wireless communication system, the base station comprising:
a transceiver; and
at least one processor coupled with the transceiver and configured to:
transmit, to a terminal, configuration information on a maximum number of transport blocks (TBs) included in a physical downlink shared channel (PDSCH),
transmit, to the terminal, downlink control information (DCI) including a redundancy version (RV) field, and
transmit, to the terminal, the TBs included in the PDSCH,
wherein at least one disabled TB among the TBs included in the PDSCH is identified based on a size of the RV field.

17. The base station of claim 16,
wherein the configuration information further includes information on the size of the RV field.

18. The base station of claim 16,
wherein the RV field includes a plurality of RV blocks corresponding to each of the TBs included in the PDSCH, and
wherein the at least one disabled TB is based on an identifier (ID) of a RV block of the plurality of RV blocks.

19. The base station of claim 17,
wherein the information on the size of the RV field is numberOfBitsForRV-DCI-1-3 which includes at most 2 bits.

20. The base station of claim 16,
wherein the DCI further includes a modulation and coding scheme (MCS) field, and
wherein a value of an MCS field corresponding to the at least one disabled TB is 26.
